(19) United States
(12) Patent Application Publication
(10) Pub. No.: US 2025/0307527 A1
(43) Pub. Date: Oct. 2, 2025

(54) METHOD, APPARATUS, DEVICE AND STORAGE MEDIUM FOR DOCUMENT PRESENTATION

(71) Applicant: Beijing Zitiao Network Technology Co., Ltd., Beijing (CN)

(72) Inventors: Hongyun Wang, Beijing (CN); Juncong Li, Beijing (CN); Ziqing Xu, Beijing (CN); Xiaohui Wang, Beijing (CN); Hao Chang, Beijing (CN)

(21) Appl. No.: 18/864,499

(22) PCT Filed: Sep. 21, 2023
(86) PCT No.: PCT/CN2023/120499

§ 371 Date: Nov. 8, 2024

(30) Foreign Application Priority Data
Oct. 31, 2022 (CN) 202211345566.9
Oct. 31, 2022 (CN) 202211351337.8
Oct. 31, 2022 (CN) 202211351629.1
Oct. 31, 2022 (CN) 202211351678.5

(51) Int. Cl. G06F 40/106; G06F 40/117; G06F 40/166

(52) U.S. Cl. CPC G06F 40/106; G06F 40/117; G06F 40/166

(57) ABSTRACT

Embodiments of the disclosure provides a method and device for presenting a document, equipment and a storage medium. The method includes presenting a first view of a document, the document including at least one content block, and the at least one content block having presentation attributes. The method further includes adjusting a presentation attribute of the at least one content block in response to receiving an indication of presenting the second view of the document. Further, the method includes presenting at least one piece of content in the second view based on the adjusted presentation attribute. In this way, the user experience of the document can be improved, and the application scenario of the document can be expanded.

The present application claims priority to the following applications: Chinese invention patent application Ser. No. 20/221,1351337.8, entitled “Method, Apparatus, Device and Storage Medium for Document Presentation”; Chinese invention patent application Ser. No. 20/221,1351629.1, entitled “Method, Apparatus, Device and Storage Medium for Document demonstration”; Chinese invention patent application Ser. No. 20/221,1345566.9, entitled “Method, Apparatus, Device and Storage Medium for Document Interaction”; and Chinese invention patent application Ser. No. 20/221,1351678.5, entitled “Method, Apparatus, Device and Storage Medium for Document Content Displaying”, filed on Oct. 31, 2022, the entireties of which are incorporated herein by reference.

### FIELD

Embodiments of the present disclosure generally relate to the field of computers, and in particular, to a method, apparatus, device and computer-readable storage medium for document presenting, a method, apparatus, device and computer-readable storage medium for document demonstration, a method, apparatus, device and computer-readable storage medium for document interaction, and a method, apparatus, device and computer-readable storage medium for document content displaying.

### BACKGROUND

With the increasing popularity of computers, it is becoming more and more common for people to work on computers. Currently, documents are widely used in daily office work. People often create documents in a particular document format and edit and use the documents in this document format. However, different usage scenarios of a document may have different requirements for a presentation manner of the document. For example, people may use a document editing tool to edit a document for recording information and use a demonstration tool to compose a document for demonstration, etc. People have to convert between document formats of multiple tools for different use scenarios. At this point, it is desirable to adapt the same document to different usage scenarios, and to present the document in a variety of different views.

The use of documents, including demonstration of documents, may be involved in many aspects of people's life, work, and social networking. For example, in scenarios such as conference reporting, enterprise propaganda, product recommendation, and activity display, various contents of documents often need to be demonstrated. However, traditional document demonstration does not support the interaction between viewers and documents.

During the process of document demonstration, some documents have contents that were input or inserted, and these contents can supplement the content of the document. How to present these input contents in a better way during the demonstration of the document is a matter of concern.

In addition, in different application scenarios, contents of a document that need to be demonstrated may be different. How to provide document content displaying in a more diverse and flexible way is also a matter of concern.

### SUMMARY

According to a first aspect of the present disclosure, a method for document presentation is provided. In the method, a first view of a document is presented, the document includes at least one content block, and the at least one content block has a presentation attribute. In response to receiving an indication of presenting a second view of the document, the presentation attribute of the at least one content block is adjusted. Further, the at least one content block is presented in the second view based on the adjusted presentation attribute.

According to a second aspect of the present disclosure, an apparatus for document presentation is provided. The apparatus includes an original presentation module. The original presentation module is configured to present a first view of a document, the document comprising at least one content block, the at least one content block having a presentation attribute; The apparatus further includes an adjustment module configured to adjust the presentation attribute of the at least one content block in response to receiving an indication of presenting a second view of the document. In addition, the apparatus further includes a target presentation module configured to present the at least one content block in the second view based on the adjusted presentation attribute.

According to a third aspect of the present disclosure, an electronic device is provided. The device includes at least one processing unit; and at least one memory coupled to the at least one processing unit and storing instructions for execution by the at least one processing unit. The instructions, when executed by the at least one processing unit, cause the device to perform the method according to the first aspect of the present disclosure.

According to a fourth aspect of the present disclosure, a computer-readable storage medium is provided. The computer readable storage medium stores a computer program, and the computer program is executable by a processor to perform the method according to the first aspect of the present disclosure.

In a first aspect of the present disclosure, a method of document demonstration is provided. The method includes, in response to receiving a switch indication in an edit page of a document, presenting a demonstration page of the document, the demonstration page including a view of a content item input in the document. The method also includes presenting the content item within the demonstration page in response to detecting a trigger indication for the view.

In a second aspect of the present disclosure, a method of document demonstration is provided. The method includes determining a current page type of a document in response to receiving a trigger indication for a view of a content item in the document. The method further includes, in response to the page type being an edit page, jumping to a page other than the edit page to present the content item. The method also includes presenting the content item within a demonstration page in response to the page type being the demonstration page.

In a third aspect of the present disclosure, an apparatus for document demonstration is provided. The apparatus includes a demonstration page presenting module configured to present, in response to receiving a switch indication in an edit page of a document, a demonstration page of the document, the demonstration page including a view of a content item input in the document. The apparatus further includes a content item presenting module configured to present the content item within the demonstration page in response to detecting a trigger indication for the view.

In a fourth aspect of the present disclosure, an apparatus for document demonstration is provided. The apparatus includes a page type determining module configured to determine a current page type of a document in response to receiving a trigger indication for a view of a content item in the document. The apparatus further includes a page jumping module configured to jump to a page other than an edit page to present the content item in response to the page type being the edit page. The apparatus further includes a demonstration page presenting module configured to present the content item within a demonstration page in response to the page type being the demonstration page.

In a fifth aspect of the present disclosure, an electronic device is provided. The device includes at least one processing unit; and at least one memory coupled to the at least one processing unit and storing instructions for execution by the at least one processing unit. The instructions, when executed by the at least one processing unit, cause the device to perform the method according to the first aspect or the second aspect.

In a sixth aspect of the present disclosure, a computer-readable storage medium is provided. A computer program is stored on the medium, and the computer program is executable by the processor to implement the method according to the first aspect or the second aspect.

In a first aspect of the present disclosure, a method for document interaction is provided. The method includes: presenting, at a first terminal device, access path information of a document in a demonstration view of the document with the document being presented; and providing the demonstration view of the document to at least one second terminal device based on an access request including the access path information initiated by the at least one second terminal device.

In a second aspect of the present disclosure, a method for document interaction is provided. The method includes: obtaining, at a second terminal device, access path information of a document, the document being demonstrated at a first terminal device; sending an access request for the document, the access request including the access path information; receiving a demonstration view of the document; and presenting the demonstration view of the document in a demonstration mode.

In a third aspect of the present disclosure, a first apparatus for document interaction is provided. The apparatus includes: an access path presenting module configured to present access path information of a document in a demonstration view of the document with the document being demonstrated; and a view providing module configured to send the document to at least one second apparatus based on an access request including the access path information initiated by the at least one second apparatus.

In a fifth aspect of the present disclosure, a second apparatus for document interaction is provided. The apparatus includes: an access obtaining module configured to obtain access path information of a document, the document being demonstrated at a first apparatus; a request initiating module configured to send an access request for the document, the access request including the access path information; a view receiving module configured to receive a demonstration view of the document; and a view presenting module configured to present the demonstration view of the document in a demonstration mode.

In a sixth aspect of the present disclosure, an electronic device is provided. The electronic device includes at least one processing unit; and at least one memory coupled to the at least one processing unit and storing instructions for execution by the at least one processing unit. The instructions, when executed by the at least one processing unit, cause the electronic device to perform the method of the first aspect or the second aspect.

In a seventh aspect of the present disclosure, a computer-readable storage medium is provided. The computer readable storage medium stores a computer program, and the computer program is executable by a processor to implement the method according to the first aspect or the second aspect.

In a first aspect of the present disclosure, a method for document content displaying is provided. The method includes receiving, in a current view of a document, a selection operation on a target content block of content blocks in the document to determine the target content block. The method also includes receiving a content demonstration indication for the target content block in response to the target content block being determined. The method also includes generating a target view including at least one content page based on the target content block. Content of the target content block is displayed in the at least one content page.

In a second aspect of the present disclosure, there is provided an apparatus for displaying document content. The apparatus includes a target content block determining module configured to receive a selection operation on a target content block of content blocks in a document under a current view of the document, and determine the target content block. The apparatus further includes a content demonstration indication receiving module configured to receive a content demonstration indication for the target content block in response to the target content block being determined. The apparatus further includes a target view generating module configured to generate, based on the target content block, a target view including at least one content page. Content of the target content block is displayed in the at least one content page.

In a third aspect of the present disclosure, an electronic device is provided. The device includes at least one processing unit; and at least one memory coupled to the at least one processing unit and storing instructions for execution by the at least one processing unit. The instructions, when executed by the at least one processing unit, cause the device to perform the method according to the first aspect.

In a fourth aspect of the present disclosure, a computer-readable storage medium is provided. A computer program is stored on the medium, and the computer program is executable by the processor to implement the method according to the first aspect.

It should be understood that content described in this section is not intended to limit key features or important features of embodiments of the present disclosure, nor is it intended to limit the scope of the present disclosure. Other features of the present disclosure will be readily understood from the following description.

### BRIEF DESCRIPTION OF DRAWINGS

The above and other features, advantages and aspects of embodiments of the present disclosure will become more apparent with reference to the following detailed description and the accompanying drawings. In the drawings, the same or similar reference numerals denote the same or similar elements, wherein:

FIG. 1A illustrates a schematic diagram of an example environment in which embodiments of the present disclosure can be implemented;

FIG. 1B illustrates a flowchart of a method for document presentation according to some embodiments of the present disclosure;

FIG. 1C illustrates a schematic diagram of a document view of a document according to some embodiments of the present disclosure;

FIG. 1D illustrates a schematic diagram of a demonstration view of a document according to some embodiments of the present disclosure;

FIG. 1E illustrates a schematic diagram of another demonstration view of a document according to some embodiments of the present disclosure;

FIG. 1F illustrates a schematic diagram of a mindmap view of a document according to some embodiments of the present disclosure;

FIGS. 1GA and 1GB respectively illustrate schematic diagrams of editing a mindmap according to some embodiments of the present disclosure;

FIGS. 1HA and 1HB respectively illustrate schematic diagrams of editing a mindmap according to some embodiments of the present disclosure;

FIGS. 1IA and 1IB respectively illustrate schematic diagrams of editing a mindmap according to some embodiments of the present disclosure;

FIGS. 1JA and 1JB respectively illustrate schematic diagrams of editing a mindmap according to some embodiments of the present disclosure;

FIGS. 1KA and 1KB respectively illustrate schematic diagrams of editing a mindmap according to some embodiments of the present disclosure;

FIGS. 1OA and 1OB respectively illustrate schematic diagrams of a document view and a mindmap view of a document according to some embodiments of the present disclosure;

FIG. 1P illustrates a block diagram of an example apparatus for document presentation according to some embodiments of the present disclosure;

FIG. 2A illustrates a schematic diagram of an example environment in which embodiments of the present disclosure can be implemented;

FIG. 2B illustrates a flowchart of a process for document demonstration according to some embodiments of the present disclosure;

FIG. 2C illustrates a schematic diagram of an example of presenting a content item in a browsing window according to some embodiments of the present disclosure;

FIGS. 2DA to 2DB illustrate schematic diagrams of interaction examples for a demonstration page according to embodiments of the present disclosure;

FIGS. 2EA to 2EF illustrate schematic diagrams of examples of a demonstration page for document demonstration according to some embodiments of the present disclosure;

FIGS. 2FA to 2FC illustrate schematic diagrams of interaction examples of a view for editing a content item according to embodiments of the present disclosure;

FIG. 2G illustrates a schematic diagram of yet another interaction example of a view for editing a content item according to some embodiments of the present disclosure;

FIG. 2H illustrates a flowchart of another process for document demonstration according to some embodiments of the present disclosure;

FIG. 2I illustrates a block diagram of an apparatus for document demonstration according to some embodiments of the present disclosure;

FIG. 2J illustrates a block diagram of another apparatus for document demonstration according to some embodiments of the present disclosure;

FIG. 3A illustrates a schematic diagram of an example environment in which embodiments of the present disclosure can be implemented;

FIG. 3B illustrates a flowchart of signaling flow for document interaction according to some embodiments of the present disclosure;

FIGS. 3CA to 3CD illustrate schematic diagrams of interaction examples of a page for document interaction according to some embodiments of the present disclosure;

FIGS. 3DA to 3DH illustrate schematic diagrams of interaction examples of a page for document interaction according to other embodiments of the present disclosure;

FIG. 3E illustrates a flowchart of a process for document interaction according to some embodiments of the present disclosure;

FIG. 3F illustrates a flowchart of a process for document interaction according to some other embodiments of the present disclosure;

FIG. 3G illustrates a block diagram of a first apparatus for document interaction according to some embodiments of the present disclosure;

FIG. 3H illustrates a block diagram of a second apparatus for document interaction according to some embodiments of the present disclosure;

FIG. 4A illustrates a schematic diagram of an example environment in which embodiments of the present disclosure can be implemented;

FIG. 4B illustrates a flowchart of a process for document content displaying according to some embodiments of the present disclosure;

FIGS. 4CA to 4CF illustrate schematic diagrams of an example of selecting a target content block of a document according to some embodiments of the present disclosure;

FIGS. 4DA to 4DE illustrate schematic diagrams of interaction examples for filtering for a target content block of a document according to embodiments of the present disclosure;

FIG. 4E illustrates a schematic diagram of an example of interacting with a selected target content block of a document according to embodiments of the present disclosure;

FIGS. 4FA to 4FB illustrate schematic diagrams of examples of a demonstration interface for document content displaying according to some embodiments of the present disclosure;

FIG. 4G illustrates a block diagram of an apparatus for document content displaying according to some embodiments of the present disclosure; and

FIG. 4H illustrates a block diagram of an electronic device capable of implementing various embodiments of the present disclosure.

### DETAILED DESCRIPTION

Embodiments of the present disclosure will be described in more detail below with reference to the accompanying drawings. Although certain embodiments of the disclosure are illustrated in the drawings, it would be appreciated that the disclosure may be embodied in various forms and should not be construed as limited to the embodiments set forth herein. These embodiments are provided to provide a more thorough and complete understanding of the disclosure. It would be appreciated that the accompanying drawings and embodiments of the present disclosure are only for the purpose of illustration and are not intended to limit the scope of protection of the present disclosure.

In the description of the embodiments of the present disclosure, the term “comprising” and similar terms thereof should be understood as open-ended inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below.

The term “in response to” as used herein refers to a state in which a corresponding event occurs or a condition is satisfied. It will be understood that the timing of execution of subsequent actions performed in response to the event or condition and the time at which the event occurs or the condition holds are not necessarily strongly associated. For example, in some cases, a subsequent action may be performed immediately when an event occurs or a condition holds; while in other cases, a subsequent action may be performed for a period of time after an event occurs or a condition holds.

It would be appreciated that the data involved in the technical solution (including but not limited to the data itself, data acquisition or use) should comply with the requirements of the corresponding laws, regulations and relevant provisions.

It would be appreciated that before the technical solutions disclosed in the embodiments of the present disclosure are used, users should be notified of the type, use range, use scenario, and the like of the personal information involved in the present disclosure and provide authorization in an appropriate manner according to corresponding laws, regulations and relevant provisions.

For example, when an active request of a user is received, prompt information is sent to the user to explicitly prompt the user, and an operation requested to be performed by the user needs to obtain and use personal information of the user, so that the user can autonomously select, according to the prompt information, whether to provide the personal information to software or hardware such as an electronic device, an application program, a server, or a storage medium that performs the operation of the technical solution of the present disclosure.

As an optional but non-limiting implementation, in response to the active request being received from the user, the prompt information may be sent to the user via, for example, a pop-up window in which the prompt information may be presented in text. In addition, the pop-up window may also contain selection controls configured for the user to choose “agree” or “disagree” to provide the personal information to the electronic device.

It may be understood that the foregoing process of notifying and acquiring user authorization is merely illustrative, and does not constitute a limitation on the implementations of the present disclosure, and other manners that meet related laws and regulations may also be applied to the implementations of the present disclosure.

As described above, documents are widely used in daily office work, and different use scenarios often have different requirements for presenting the documents. For example, in a scenario of report presenting, it is usually desirable to present document content in a form of a paginated layout, and there is some requirement on style and typesetting of the document content. For another example, in a scenario of organizing thoughts, it is usually desirable to present document content in a hierarchical structure such as a tree structure. Conventional document formats usually only meet specific scenario requirements. For example, in the scenario of report presenting, it is suitable to use the demonstration deck format in which the document is presented in slides. In the scenario of organizing thoughts, it is suitable to use the mindmap format to present the document. In addition, converting documents between different formats is often time-consuming and inefficient, and the quality of the obtained documents is not generally satisfactory, for example in terms of the layout, typesetting, and style of the documents.

At present, a technical solution for generating a directory for a document has been proposed. However, a directory structure is not suitable for users to organize ideas and then adjust the document content. In addition, it has been proposed to page the document based on the page segmentation identifier in the document or a plurality of predetermined cells, so as to switch the document from the edit view to the demonstration view. However, the demonstration view obtained in this solution only enlarges and focuses on the document, without considering factors such as layout, typesetting, and style in the demonstration mode, and cannot well meet the requirement of users for the demonstration scenario. Therefore, it is desirable to enable high-quality switching of the same document between multiple different views.

According to the embodiments of the present disclosure, a solution of improved document presentation is provided. Specifically, rather than management of the document content in a streaming manner, in the present disclosure documents may be managed in the form of content blocks. In this solution, a document includes a plurality of content blocks having respective presentation attributes. After an indication of view switching is received, presentation attributes of related content blocks may be adjusted, and the content blocks are presented based on the adjusted presentation attributes, such that view switching of the document can be implemented.

It will be understood from the following description that, compared to the existing solutions, in the embodiments according to the present disclosure, with the content in the document being managed and presented by means of at least one content block respectively having a presentation attribute, switching of the document among a plurality of different views can be implemented at a finer granularity, so that the requirements of the users for corresponding scenarios can be better satisfied. In this way, the conversion of the document among multiple document formats can be avoided, so that the users can switch the presentation mode of the document by triggering the corresponding views. Thus, the user experience for the document is improved and the application scenarios of the document are expanded.

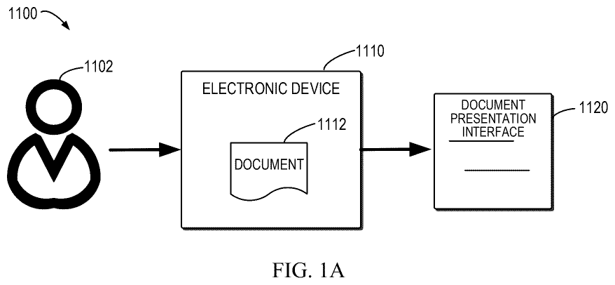

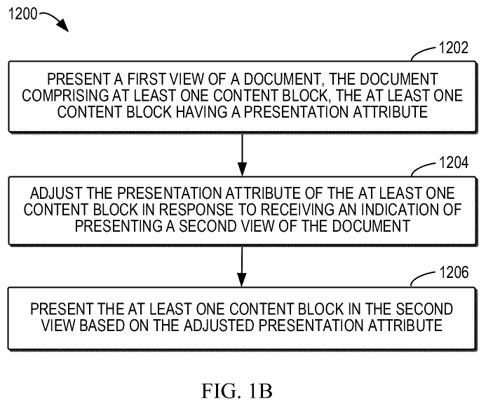

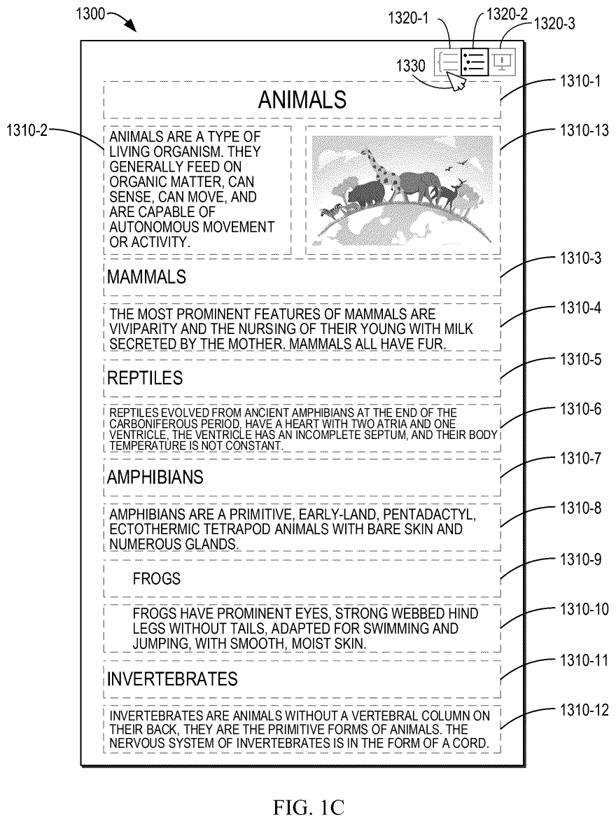

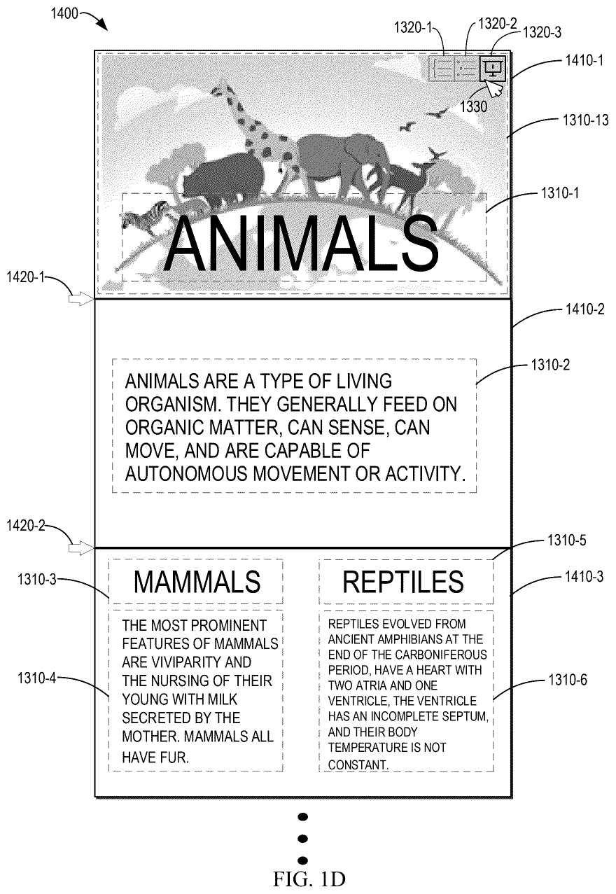

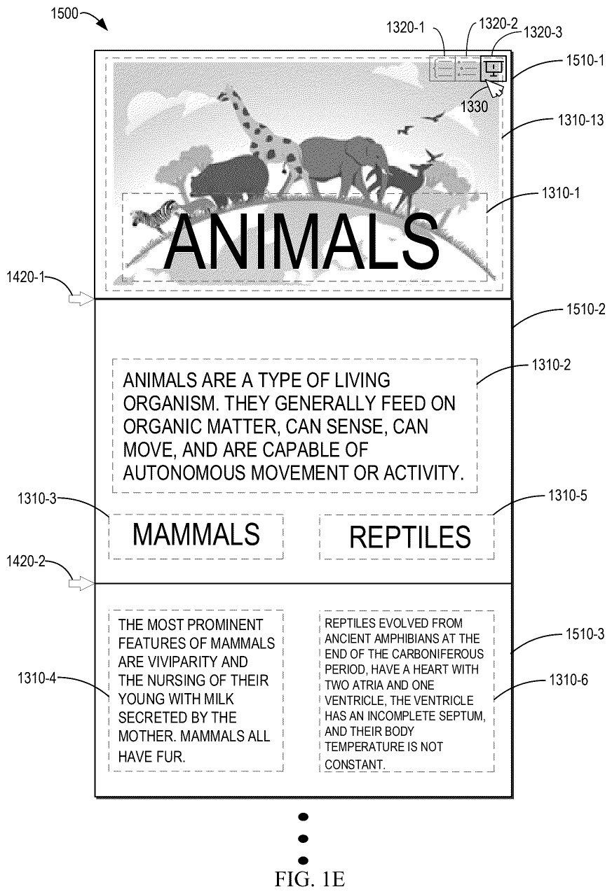

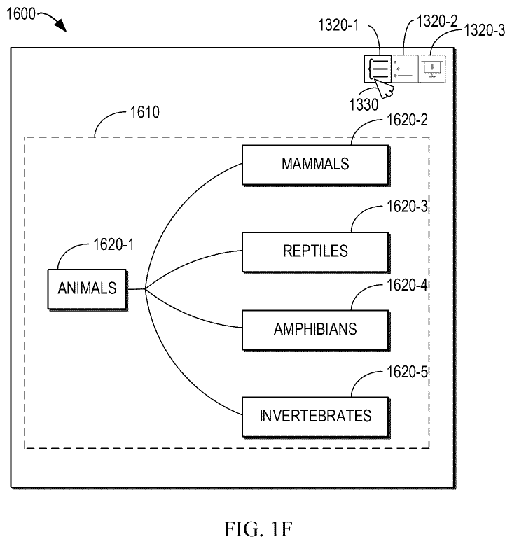

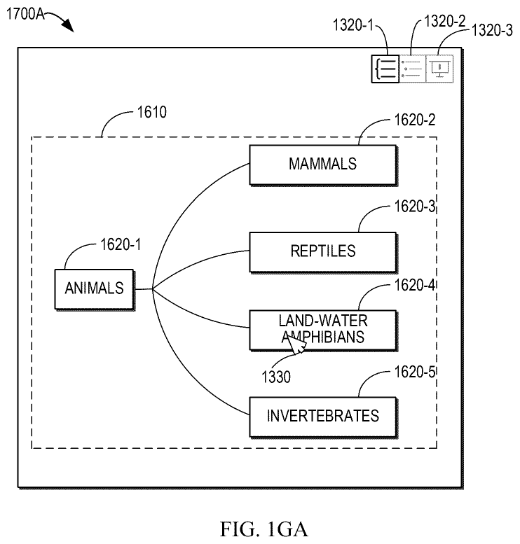

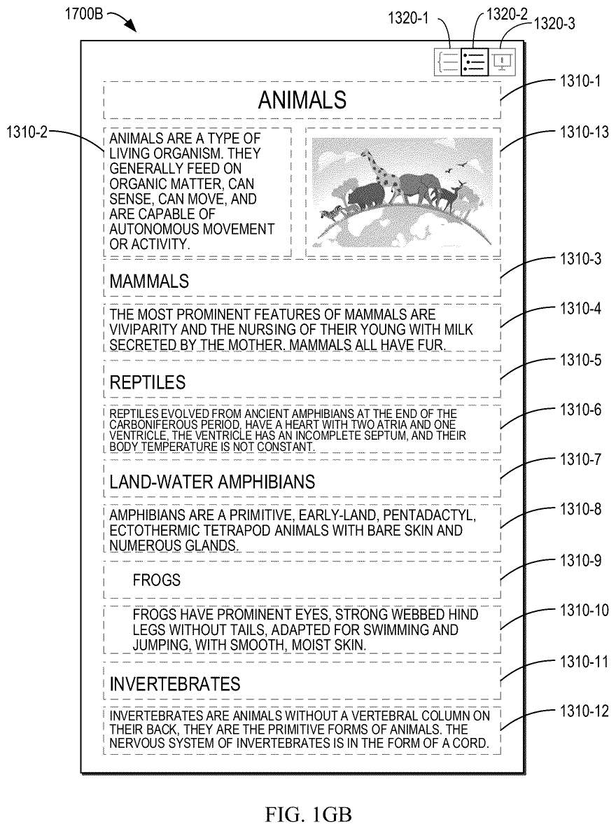

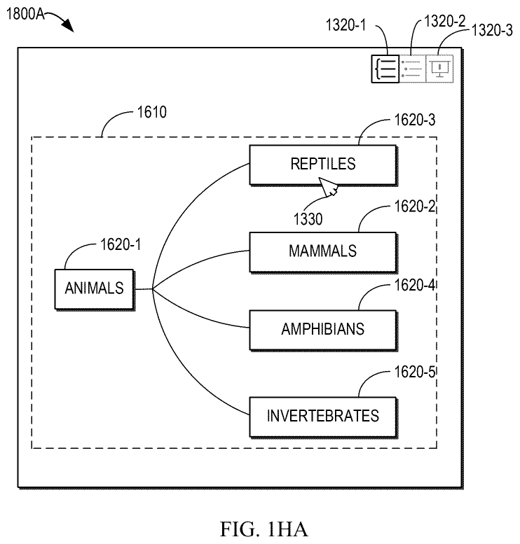

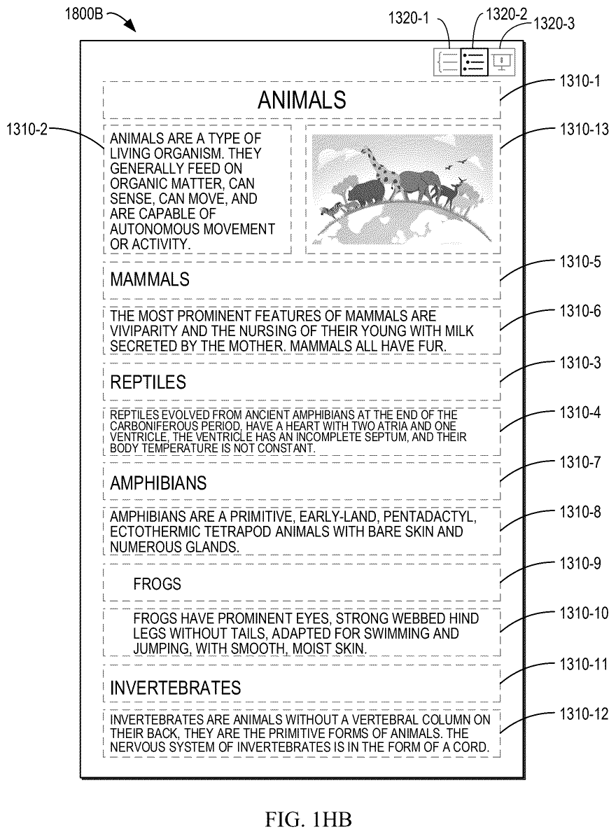

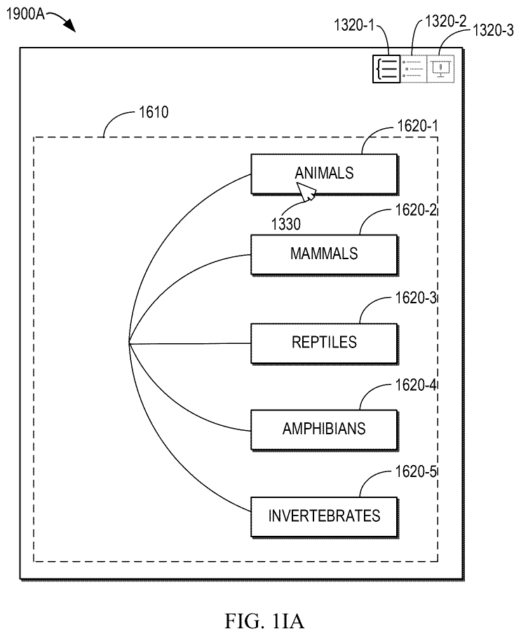

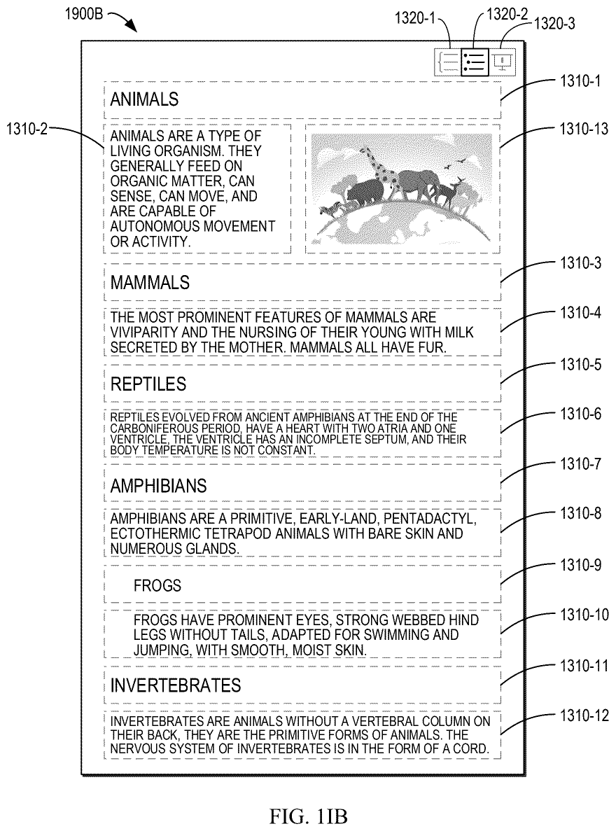

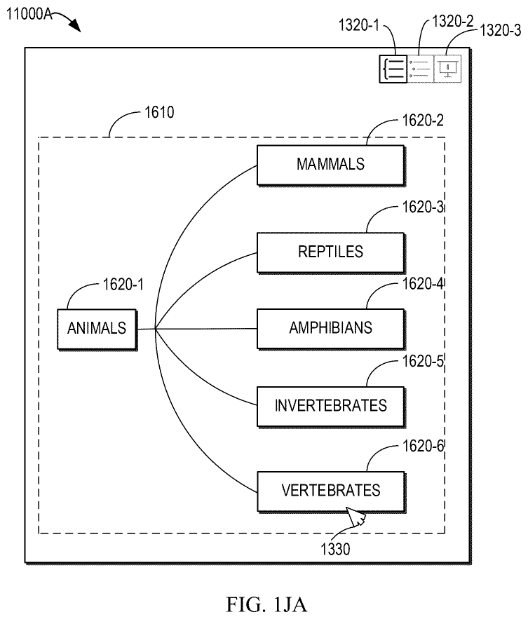

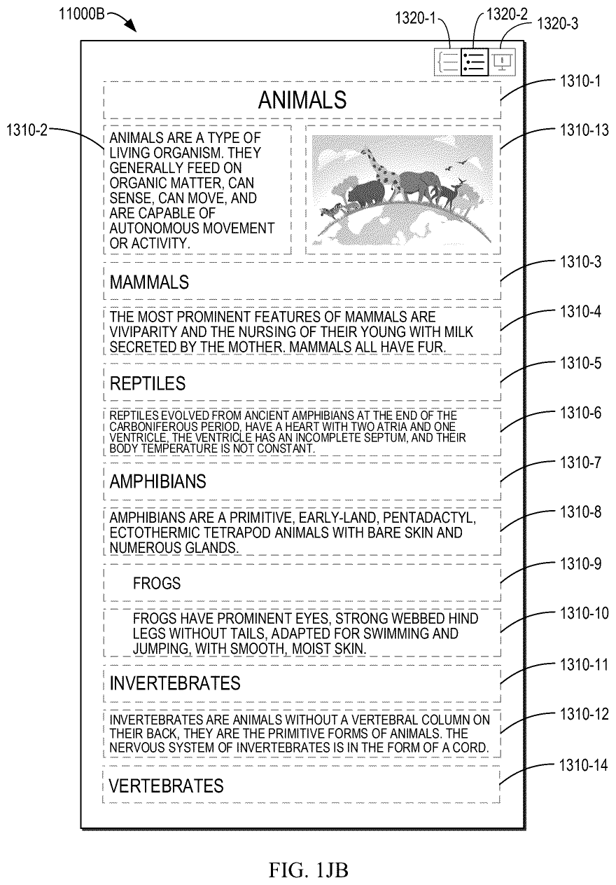

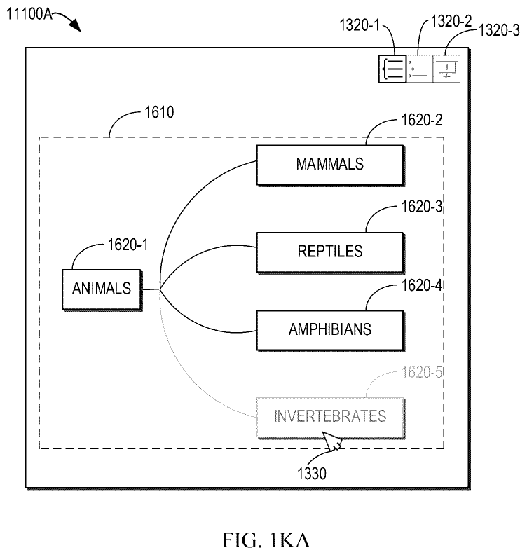

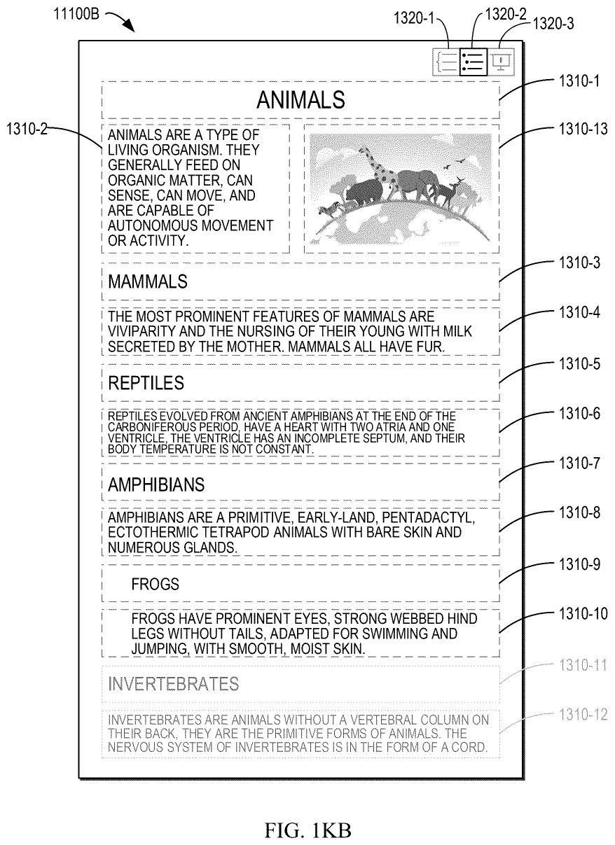

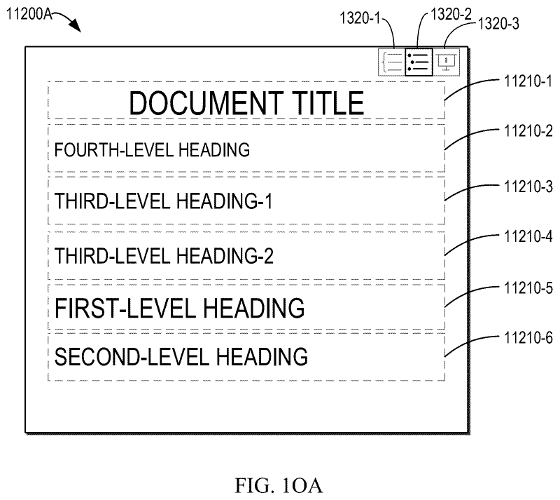

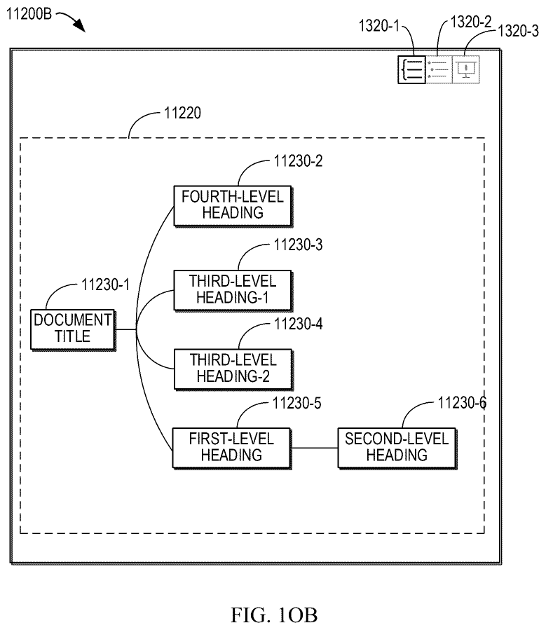

Some example embodiments of the present disclosure will be described below with reference to the accompanying drawings. FIG. 1A illustrates a schematic diagram of an example environment 1100 in which embodiments of the present disclosure can be implemented. In this example environment 1100, the electronic device 1110 may present a document 1112 to a user 1102, for example, through a document presentation interface 1120. In some embodiments, the document 1112 may be stored in a storage of the electronic device 1110. In other embodiments, the document 1112 may be an online document and may be stored in another electronic device communicatively connected with the electronic device 1110, such as in cloud storage. The scope of the present disclosure is not limited in this regard.

In some embodiments, the document presentation interface 1120 may be provided, for example, by a document editing application in the electronic device 1110. The document presentation interface 1120 may have a display area suitable for the display area size of the electronic device 1110, or any other suitable predetermined or specified display area by the user 1102.

In some embodiments, the user 1102 may interact with the electronic device 1110. For example, the user 1102 may perform operations such as editing and presenting on the document 1112 in the document presentation interface 1120 by interacting with the electronic device 1110. Various interaction processes between the user 1102 and the electronic device 1110 will be described in detail below.

The electronic device 1110 may be any type of mobile terminal, fixed terminal, or portable terminal, including a mobile handset, desktop computer, laptop computer, notebook computer, netbook computer, tablet computer, media computer, multimedia tablet, personal communication systems (PCS) device, personal navigation device, personal digital assistant (PDA), audio/video player, digital camera/camcorder, positioning device, television receiver, radio broadcast receiver, electronic book device, gaming device, or any combination of the foregoing, including accessories and peripherals of these devices, or any combination thereof. In some embodiments, the electronic device 1110 can also support any type of interface for the user 1102 (such as “wearable” circuitry, etc.). It should be understood that the structure and function of the environment 1100 are described for exemplary purposes only and do not imply any limitation on the scope of the present disclosure.

FIG. 1B illustrates a flowchart of a method 1200 for presenting the document 1112 according to some embodiments of the present disclosure. In some embodiments, the method 1200 may be performed by the electronic device 1110 as shown in FIG. 1A. It should be understood that the method 1200 may further include additional blocks not shown and/or may omit some block(s) shown, and the scope of the present disclosure is not limited in this regard.

At block 1202, a first view of the document 1112 is presented. Here, the document 1112 includes at least one content block, and the at least one content block respectively has a presentation attribute. For example, electronic device 1110 may present a document view of the document 1112 as a first view in document presentation interface 1120. In the context of the present disclosure, the term “content block” represents an entity in the document 1112, the entity includes, but is not limited to, at least one of the following: text, an image, a video, a table, a graph, a link, an annotation, a symbol, a formula, or the like, and the entity has a presentation attribute. For example, the presentation attribute of the content block may be used to control whether the content block is presented in the view of the document 1112, and control in which manner the content block is presented in the view of the document 1112. The presentation attribute of the content block may include, but is not limited to, at least one of the following: level, width, height, font, font size, border, line, padding, and alignment. It should be understood that the presentation attribute may further include any other suitable attribute, and the scope of the present disclosure is not limited in this regard.

The first view presented in the document view manner is described below in conjunction with FIG. 1C, which illustrates a schematic diagram of a document view 1300 of the document 1112 according to some embodiments of the present disclosure. It should be understood that the page shown in FIG. 1C and the pages in other figures described below are merely examples, and various page designs may actually be present. Various graphical elements in the page may have different arrangements and different visual representations, one or more of which may be omitted or replaced, and one or more other elements may also be present. The embodiments of the present disclosure are not limited in this regard.

In FIG. 1C, the document 1112 illustratively includes thirteen content blocks, namely content blocks 1310-1 to 1310-13 (individually referred to as content block 1310 or collectively referred to as content blocks 1310), wherein content blocks 1310-1 to 1310-12 are content blocks of a document type and content block 1310-13 is a content block of an image type. For purposes of explanation, only thirteen content blocks 1310 in the document 1112 are shown in FIG. 1C. It should be understood that the document 1112 may have fewer or more content blocks 1310. Although in the example of FIG. 1C, the type of the content block 1310 of the document 1112 is text or an image, in other embodiments, the type of the content block 1310 may also be a table, a graph, a link, an annotation, a symbol, a formula, or the like. In addition, although specific text is presented in the drawings, such text does not constitute any limitation on the embodiments of the present disclosure.

Exemplarily, the presentation attributes of the content blocks 1310-1 in FIG. 1C and their configurations are: a font of black body, a font size of three, and a level of document title. The presentation attributes of the content block 1310-3, the content block 1310-5, the content block 1310-7, and the content block 1310-11 and their configurations are as follows: a font of black body, a font size of three, and a level of a first-level heading. The presentation attributes of the content blocks 1310-9 and their configuration are a font of black body, a font size of four, and a level of a second-level heading. The presentation attributes of the content block 1310-2, the content block 1310-4, the content block 1310-6, the content block 1310-8, the content block 1310-10, and the content block 1310-12 and their configurations are a font of Kaiti, a font size of four, and a level of a body.

In FIG. 1C, three view controls 1320 for controlling view switching, namely view control 1320-1, view control 1320-2 and view control 1320-3 (individually referred to as view control 1320 or collectively referred to as view controls 1320), are exemplarily shown in the upper right corner of document view 1300. The view control 1320-1 corresponds to a view of a mindmap type, the view control 1320-2 corresponds to a view of a streaming type, and the view control 1320-3 corresponds to a view of a demonstration type. In the context of the present disclosure, views of the mindmap type may also be referred to as mindmap views, views of the streaming type may also be referred to as document views, and views of the demonstration type may also be referred to as demonstration views. In the example of FIG. 1C, the document view 1300 is presented, so the view control 1320-2 presents an active state, while the view control 1320-1 and view control 1320-3 present an inactive state. It should be understood that the view controls 1320 shown in FIG. 1C are merely illustrative, and the view switching may also be controlled in any other suitable manner (for example, a user may press a predetermined shortcut key or perform a predetermined gesture), and the scope of the present disclosure is not limited in this regard.

In some embodiments, the presentation manner of the document may be switched between a first view and a second view. It should be understood that the first view may be any one of a document view, a demonstration view, or a mindmap view, and the second view may be another one of the document view, the demonstration view, or the mindmap view that is different from the first view. For illustrative purposes, the embodiments of the present disclosure will be described below by taking the first view as the document view and the second view as the demonstration view or the mindmap view as an example. In addition, aspects according to embodiments of the present disclosure may also be applied to any other suitable type of view, and the scope of the present disclosure is not limited in this regard.

Returning to FIG. 1B, at block 1204, in response to an indication of presenting a second view of the document 1112 being received, the presentation attribute of the at least one content block is adjusted. In some embodiments, the indication may be a particular operation of the user 1102 on the view control 1320, such as a mouse click, a mouse double click, a mouse box selection, a mouse hover, a finger or stylus touch, a finger or stylus press, or the like. Continuing to describe more details regarding the indication with reference to FIG. 1C, in the example shown in FIG. 1C, the user 1102 may indicate switching to the demonstration view by controlling the mouse arrow 1330 to click the view control 1320-3.

In some embodiments, the electronic device 1110 may determine a type of the second view based on the indication of presenting the second view of the document 1112, and adjust the presentation attribute of the at least one content block 1310 based on the type of the second view. Referring to FIG. 1C, if a trigger indication of the user 1102 for the view control 1320-3 is received, the electronic device 1110 may determine, based on the indication, that the user 1102 clicks the view control 1320-3, and determine, based on that the view control 1320-3 corresponds to the demonstration view, that the second view type to be presented indicates the demonstration type.

In some embodiments, if it is determined that the type of the second view is the demonstration type, the electronic device 1110 may adjust the position, size, and/or display content of the at least one content block 1310 in the second view. FIG. 1D illustrates a schematic diagram of a demonstration view 1400 of the document 1112 according to some embodiments of the present disclosure. For ease of illustration, FIG. 1D shows only the first three pages of document 1112 in the demonstration view, namely page 1410-1, page 1410-2, and page 1410-3. Referring to FIG. 1D, the position of content block 1310-1 is adjusted in the demonstration view to be centered at the bottom of first page 1410-1. The electronic device 1110 also adjusts the font of the content block 1310-1 to be Lishu, and adjusts the font size to be Size One according to the window size, and so on.

In addition, the electronic device 1110 may increase the size of the content block 1310-13 of the picture type to serve as the background of the first page 1410-1. Although not shown, in another example, the electronic device 1110 may further generate an English expression “Animal” corresponding to the title “Animal” in Chinese by means of machine translation, and adjust the display content of the content block 1310-1 in the demonstration view to be “Animal” in Chinese and English. In this way, each content block 1310 in the document 1112 can be effectively adapted to the presentation form of the demonstration view, and a more aesthetic design of the demonstration view is automatically provided, so that the workload of designing the demonstration document by the user 1102 can be reduced, and the user experience is improved.

In some alternative or additional embodiments, if it is determined that the type of the second view includes the demonstration type, the electronic device 1110 may further adjust the combined layout pattern of the at least one content block 1310. In one example, if it is determined that the at least one content block 1310 includes a first type of content block and a second type of content block, the electronic device 1110 may lay out the first type of content block in combination with the second type of content block. In FIG. 1D, the electronic device 1110 may set the picture-type content block 1310-13 to serve as the background of the text-type content block 1310-1 by adjusting the position and size of the picture-type content block 1310-13. In the example of FIG. ID, content block 1310-1 may correspond to a first type of content block, for example, and content block 1310-13 may correspond to a second type of content block, for example. It should be understood that the foregoing correspondence is merely illustrative, and does not constitute any limitation on the embodiments of the present disclosure. With this combined layout pattern, the generated demonstration view can be beautified by means of collocation of different types of content blocks 1310 in the document 1112. Thus the aesthetics of the demonstration document can be improved.

In another example, if it is determined that at least one content block 1310 includes a plurality of content blocks 1310 belonging to the same parent content block, the electronic device 1110 may lay out the plurality of content blocks 1310 in a combined manner. Referring back to FIG. 1C, since the content block 1310-3 and the content block 1310-5 have the same parent content block 1310-1, the electronic device 1110 may lay out the two content blocks in a combined manner. Referring to FIG. 1D, the electronic device 1110 presents the content block 1310-3 and the content block 1310-5 in a left-right combined layout in the third page 1410-3. With this combined layout pattern, the generated demonstration view can be beautified by fully mining and using the hierarchical relationship among the content blocks 1310 in the document 1112, such that the aesthetics of the demonstration document can be improved.

In yet another example, if it is determined that the at least one content block 1310 includes a plurality of content blocks 1310 of the same type, the electronic device 1110 may lay out the plurality of content blocks 1310 of the same type in a combined manner. In the third page 1410-3 of FIG. 1D, the electronic device 1110, in addition to presenting the content block 1310-3 and the content block 1310-5 in a left-right layout, combines the content blocks 1310-4 and 1310-6 of the same text type and presents the content block 1310-3 and the content block 1310-5 in combination. With this combined layout pattern, content blocks 1310 of the same type in the document 1112 may be fully utilized to construct the generated demonstration view, such that the aesthetics of the demonstration document can be improved.

In yet another example, if it is determined that the at least one content block 1310 includes a plurality of content blocks 1310 of the same type, and content of the plurality of content blocks 1310 of the same type satisfies a predetermined condition, the electronic device 1110 may lay out the plurality of content blocks 1310 of the same type in a combined manner. Examples of the predetermined condition include, but are not limited to, the content semantics of the plurality of content blocks 1310 are similar, or the spaces of the plurality of content blocks 1310 are similar, and the scope of the present disclosure is not limited in this regard. In FIG. 1D, since the difference between the length of the content block 1310-4 and the length of the content block 1310-6 of the document 1112 type is less than a predetermined threshold, that is, the lengths are similar, the electronic device 1110 may present the content block 1310-4 and the content block 1310-6 in a left-right layout. With this combined layout pattern, the correlation between content blocks 1310 of the same type in the document 1112 can be fully utilized to design the generated demonstration view, so as to improve the aesthetics of the demonstration document.

In some embodiments, in a case that the second view to be presented is a demonstration view, the electronic device 1110 may further present a paging control element for adjusting paging in the demonstration view. Two paging control elements 1420-1 and 1420-2 (individually referred to as paging control element 1420 or collectively referred to as paging control elements 1420) are exemplarily shown in FIG. 1D in the form of arrows. It should be understood that the paging control element 1420 may also be presented in any other suitable form, and the scope of the present disclosure is not limited in this regard.

If an adjustment to the paging control element 1420 presented in the demonstration view is received, the electronic device 1110 may adjust the paging of the demonstration view. Illustratively, in FIG. 1D, user 1102 may move paging control element 1420-2 down to a horizontal position between content block 1310-3 and content block 1310-4. In response to receiving the aforementioned adjustment to the paging control element 1420-2, the electronic device 1110 may adjust the paging layout shown in FIG. 1D. The resulting new demonstration view is shown in FIG. 1E. As shown in FIG. 1E, the content block 1310-3 and content block 1310-5 are presented in a second page 1510-2 of a demonstration view 1500, while the content block 1310-4 and content block 1310-6 are presented in a third page 1510-3 of the demonstration view 1500. In this way, the user 1102 can conveniently adjust the paging layout in the demonstration view, so that the user can conveniently adjust the paging layout at a finer granularity at any time, and thus user experience can be improved.

In some embodiments, the electronic device 1110 may also present a visibility control element in the demonstration view. For example, the visibility control element may be presented while the mouse hovers over the content block (not shown). If an adjustment to the visibility control element presented in the demonstration view is received, the electronic device 1110 may adjust the visibility of the at least one content block 1310. For example, the electronic device 1110 may adjust the visibility by changing the transparency of the content block 1310. In this way, the user 1102 can conveniently hide or fade one or more content blocks 1310 in the demonstration view, and thus the simplicity and aesthetics of the demonstration document can be improved.

In some embodiments, the electronic device 1110 may also present a comment control element in the demonstration view. For example, the comment control element may be presented while the mouse hovers over the content block (not shown). If an adjustment to the comment control element presented in the demonstration view is received, the electronic device 1110 may adjust the comment for the at least one content block 1310. For example, the electronic device 1110 may present all comments obtained in the comment control element for one content block 1310 in the user interface of the author of the demonstration document. In this way, multiple viewers of the demonstration document can simultaneously comment on the demonstration document, and all the comments can be fed back to the author of the demonstration document in time, thereby improving user experience.

In some embodiments, the electronic device 1110 may also present a color control element in the demonstration view. For example, the color control element may be presented while the mouse hovers over the content block (not shown). If an adjustment to the color control element presented in the demonstration view is received, the electronic device 1110 may adjust the color for the at least one content block 1310. For example, the user 1102 may change the color of the textual content “Animal” in the content block 1310-1 by adjusting the color control element. In this way, the user 1102 can conveniently change the color of each content block 1310 in the demonstration view, thereby improving the aesthetics of the demonstration document.

In some embodiments, the electronic device 1110 may further assign an icon to the at least one content block 1310 based on the text content of the at least one content block 1310, and present the icon at a position associated with the at least one content block 1310. Illustratively, for the content block 1310-3, the electronic device 1110 may present an icon of a mammal such as a lion or tiger next to the text “mammal”; for the content block 1310-5, the electronic device 1110 may present an icon of a crawl such as a crocodile next to the text “crawl”; etc. For another example, in the document introducing the work progress, if it is determined that the text content of the content block 1310 is “schedule”, the electronic device 1110 may present a clock icon next to the content block 1310 in the demonstration view. For another example, if it is determined that the text content of the content block 1310 is “safety”, the electronic device 1110 may present a shield icon next to the content block 1310 in the demonstration view. In this way, a graphical visual presentation effect may be intelligently provided, so that the user 1102 does not need to manually select an icon in the process of generating the demonstration document, thereby further enriching content diversity of the demonstration document and improving user experience.

It can be seen from the above description in conjunction with FIGS. 1C to 1E that the method for presenting the document 1112 according to embodiments of the present disclosure can automatically select the layout, typesetting and style in the demonstration view, and can adjust the display mode of the content in the document 1112 with finer granularity based on the content blocks 1310, thereby improving the aesthetic degree of the document 1112 in the demonstration view and improving the user experience.

Referring back to FIG. 1C, in the example shown in FIG. 1C, the user 1102 may indicate switching to the mindmap view by controlling the mouse arrow 1330 to click the view control 1320-1. It should be understood that the form of indication employed herein is not limited in this regard.

In some embodiments, if it is determined that the type of the second view is the mindmap type, the electronic device 1110 may determine a heading level of the at least one content block 1310 in the document view. For brevity and convenience of description, a “heading level” may also be referred to herein simply as a “level”. For example, the electronic device 1110 may determine, according to the presentation attribute of each content block 1310, that: the level of the content block 1310-1 is a document title; the level of each of the content block 1310-3, the content block 1310-5, the content block 1310-7, and the content block 1310-11 is a first-level heading; the level of the content block 1310-9 is a second-level heading; and the level of each of the content block 1310-2, the content block 1310-4, the content block 1310-6, the content block 1310-8, the content block 1310-10, the content block 1310-12, and the content block 1310-13 is a body.

The electronic device 1110 may adjust the presentation attribute of the at least one content block based on the heading level, and display the at least one content block in the mindmap view with the adjusted presentation attribute. In some embodiments, the electronic device may present a content block 1310 that satisfies a predetermined level condition in the created mindmap. For example, the presentation attribute may further include a mindmap display attribute indicating whether the content block 1310 is to be presented in the mindmap. The electronic device 1110 may set the mindmap display attribute of the content block 1310 based on whether the level of the content block 1310 satisfies the predetermined level condition.

For ease of description, the following uses an example in which the predetermined level condition is that the level is not lower than the first-level heading. Since the document title is hierarchically higher than the first-level heading, and the second-level heading and the body are hierarchically lower than the first-level heading, the electronic device 1110 may determine, based on the predetermined level condition, that the content block 1310 with the level of the document title and the content block 1310 with the level of the first-level heading need to be presented in the mindmap. In the example of FIG. 1C, the electronic device 1110 may set the mindmap display attributes of the content block 1310-1, the content block 1310-3, the content block 1310-5, the content block 1310-7, and the content block 1310-11 to be presenting the respective content block 1310 in the mindmap. In addition, the electronic device 1110 may set the mindmap display attributes of the content block 1310-2, the content block 1310-4, the content block 1310-6, the content block 1310-8, the content block 1310-9, the content block 1310-10, the content block 1310-12, and the content block 1310-13 to be refraining from presenting the content block 1310 in the mindmap.

It should be understood that the above solution based on the mindmap display attribute is merely exemplary, the electronic device 1110 may also adjust any other suitable presentation attribute of the content block 1310, and the scope of the present disclosure is not limited in this regard.

Referring back to FIG. 1B, at block 1206, at least one content block is presented in the second view based on the adjusted presentation attribute. In the case where the second view is a mindmap view, the electronic device 1110 may generate a node corresponding to the content block 1310 based on the content block 1310 to be presented in the mindmap, and determine a hierarchy of a respective node in the mindmap based on the heading levels of the content blocks 1310, so as to present each node in the mindmap based on the hierarchy. In this way, the display mode of the document 1112 can be switched without changing the document content itself, and the document format does not need to be converted. Therefore, it is convenient for the user to organize thoughts in the mindmap view, thereby improving the efficiency of editing the document structure.

In the following, more relevant details are described by taking the mindmap view as an example of the second view. FIG. 1F illustrates a schematic diagram of a mindmap view 1600 of the document 1112 according to some embodiments of the present disclosure. A mindmap 1610 in FIG. 1F includes five nodes, namely nodes 1620-1 to 1620-5 (individually referred to as node 1620 or collectively referred to as nodes 1620). The following will be described in comparison with FIGS. 1C and 1F.

The electronic device 1110 may determine from the mindmap display attributes in the presentation attributes of the content blocks 1310-1 to 1310-13 that the content block 1310-1, the content block 1310-3, the content block 1310-5, the content block 1310-7, and the content block 1310-11 are to be presented in the mindmap 1610. The electronic device 1110 may generate corresponding nodes 1620 based on the content blocks 1310. For example, node 1620-1 in FIG. IF corresponds to content block 1310-1, node 1620-2 corresponds to content block 1310-3, node 1620-3 corresponds to content block 1310-5, node 1620-4 corresponds to content block 1310-7, and node 1620-5 corresponds to content block 1310-1.

The electronic device 1110 may determine a hierarchy of the each of the nodes 1620 in the mindmap 1610 based on the levels of the content blocks 1310. In some embodiments, the electronic device 1110 may set the document title as the root node of the mindmap 1610, set the first-level heading as the first-level node, set the second-level heading as the second-level node, and so on. Referring to the example of FIG. 1C and FIG. 1F, based on the level of the content block 1310-1 being the document title, the electronic device 1110 may determine the corresponding node 1620-1 as the root node. Based on the level of the content block 1310-3 being the first-level heading, the electronic device 1110 may determine that the corresponding node 1620-2 is a first-level node. Similarly, the electronic device 1110 may determine that the node 1620-3, the node 1620-4, and the node 1620-5 are first-level nodes. Since the above-mentioned predetermined level condition is that the level is not lower than the first-level heading, the mindmap 1610 of FIG. 1F includes one root node and four first-level nodes.

The electronic device 1110 may present each node 1620 in the mindmap 1610 based on the determined hierarchy of the node 1620. For example, nodes 1620-1 to 1620-5 are presented in a tree layout in FIG. 1F. Although FIG. 1F only shows a two-layer tree-like layout, when the document 1112 includes more levels, the tree-like layout may also have more levels based on a suitable predetermined level condition. For example, more categories of mammals may also be included below the node 1620-2, and so on. It should be understood that the electronic device 1110 may also present various nodes 1620 in any other suitable layout, and the scope of the present disclosure is not limited in this regard.

In some embodiments, mindmap 1610 presents a hierarchy of the document 1112 in a separate page and allows user 1102 to organize the thoughts of editing the document 1112 based on the mindmap 1610. For example, the user 1102 may adjust the level, content, and order of the respective content blocks in the mindmap 1610, and so on. With the mindmap 1610 being presented in a separate page, the user 1102 can focus on organizing the structure and composition of the document 1112 without being distracted by other temporarily unimportant detail content (e.g., content at a lower level). Compared to existing solutions in which a document catalog is presented within a partial area in a particular view of the document 1112, the user 1102 can be provided with the possibility of immersive focusing on organizing thoughts. As such, the user experience can be improved and the efficiency of editing the document 1112 by the user 1102 can be improved.

Specifically, in response to detecting an editing operation for the node 1620 in the mindmap view, the electronic device 1110 may update the content block 1310 corresponding to the node 1620 in the mindmap view accordingly. In an example, if it is determined that the editing operation adjusts the content of the node, the electronic device 1110 may adjust the content of the content block corresponding to the node. FIGS. 1GA and 1GB respectively show a schematic diagram of editing the mindmap 1610 according to some embodiments of the present disclosure. As shown in the mindmap view 1700A of FIG. 1GA, the user 1102 may adjust the content of the node 1620-4, such as by adding text “land-water” in the node 1620-4 so as to edit the content of the node 620-4 to be “land-water amphibians”. In response to determining the editing operation, the electronic device 1110 may adjust the content of the content block 1310-7 corresponding to the node 1620-4 accordingly. As shown in the document view 1700B of FIG. 1GB, the electronic device 1110 may synchronously adjust the content of the content block 1310-7 to “land-water amphibians”. In the examples of FIG. 1GA and FIG. 1GB, only the node 1620-4 in FIG. 1GA is taken as an example of the adjusted node, and the content block 1310-7 in FIG. 1GB may be the content block corresponding to the adjusted node. It should be understood that the foregoing correspondence is merely illustrative, and does not constitute any limitation on the embodiments of the present disclosure.

In this way, the user 1102 can organize thoughts for the document 1112 in the mindmap 1610, and the editing operation of the user 1102 can be synchronized to the content in the corresponding content block 1310 of the document 1112, so that the user 1102 can subsequently directly switch to a further view of the document 1112 to further enrich the details of the document 1112. Therefore, the efficiency of editing the document 1112 by the user 1102 can be improved, and the user experience can be improved.

In yet another example, if it is determined that the editing operation adjusts the order of two nodes in the mindmap 1610, the electronic device 1110 may adjust the order of the two content blocks corresponding to the two nodes in the document 1112. FIGS. 1HA and 1HB respectively show a schematic diagram of editing the mindmap 1610 according to some embodiments of the present disclosure. As shown in mindmap view 1800A of FIG. 1HA, the user 1102 may adjust the order of node 1620-2 and node 1620-3, e.g., interchange the order of node 1620-2 and node 1620-3 such that node 1620-3 precedes node 1620-2. In response to determining the editing operation on the order of nodes, the electronic device 1110 may adjust the order of the content block 1310-3 corresponding to the node 1620-2 and the content block 1310-5 corresponding to the node 1620-3 accordingly.

Additionally, the positions of the subordinate content blocks of the adjusted node may be changed accordingly. For example, the electronic device 1110 may also adjust the order of the content block 1310-4 associated with the content block 1310-3 and the content block 1310-6 associated with the content block 1310-5 accordingly. As shown in the document view 1800B of FIG. 1HB, the electronic device 1110 may move content blocks 1310-5 and 1310-6 before content blocks 1310-3 and 1310-4. In the examples of FIGS. 1HA and 1HB, node 1620-2 and node 1620-3 in FIG. 1HA may correspond to two adjusted nodes, respectively, for example, and content block 1310-3 and content block 1310-5 in FIG. 1HB may correspond to the two content blocks corresponding to two adjusted nodes, respectively, for example. It should be understood that the foregoing correspondence is merely illustrative, and does not constitute any limitation on the embodiments of the present disclosure.

In this way, the user 1102 can organize thoughts for the document 1112 in the mindmap 1610, and the editing operation of the user 1102 may be synchronized to the corresponding content in the corresponding content block 1310 of the document 1112, so that the adjustment of the thoughts of the user 1102 for the document 1112 in the mindmap 1610 is synchronized to another view of the document 1112. Therefore, the efficiency of editing the document 1112 by the user 1102 can be improved, and the user experience can be improved.

In yet another example, if it is determined that the editing operation adjusts the level of the node in the mindmap 1610, the electronic device 1110 may adjust the level of the content block in the document 1112. FIGS. 1IA and 1IB respectively show a schematic diagram of editing the mindmap 1610 according to some embodiments of the present disclosure. As shown in mindmap view 1900A of FIG. 1IA, the user 1102 may adjust the level of node 1620-1, e.g., change it from the root node to the first-level node. In response to determining the editing operation on the node level, the electronic device 1110 may adjust the level of the content block 1310-1 corresponding to the node 1620-1 accordingly. As shown in document view 1900B of FIG. 1IB, electronic device 1110 may adjust the level of content block 1310-1 to a first-level heading. Additionally, the electronic device 1110 may adjust other presentation attribute of the content block 1310-1, such as font and font size, to be the configuration corresponding to the first-level heading accordingly. In the example of FIGS. 1IA and 1IB, node 1620-1 in FIG. 1IA may, for example, correspond to an adjusted node, and content block 1310-1 in FIG. 1IB and its level attribute may, for example, correspond to a respective content block and a respective level of the adjusted node. It should be understood that the foregoing correspondence is merely illustrative, and does not constitute any limitation on the embodiments of the present disclosure.

In this way, the user 1102 can organize thoughts for the document 1112 in the mindmap 1610, and synchronize the editing operation of the user 1102 to the corresponding content in the corresponding content block 1310 of the document 1112, so that the adjustment of the thoughts of the user 1102 for the document 1112 in the mindmap 1610 is synchronized to other views of the document 1112. Therefore, the efficiency of editing the document 1112 by the user 1102 can be improved, and the user experience can be improved.

In yet another example, if it is determined that the editing operation inserts a new node into the mindmap 1610, the electronic device 1110 may insert a new content block corresponding to the new node into the document 1112. In some embodiments, the electronic device 1110 may determine the level of the new content block based on the level of the insertion node. FIGS. 1JA and 1JB respectively show a schematic diagram of editing the mindmap 1610 according to some embodiments of the present disclosure. As shown in the mindmap view 11000A of FIG. 1JA, the user 1102 inserts a node 1620-6 in the mindmap 1610. The node 1620-6 is a child node of the root node 1620-1.

In response to determining the insertion operation, the electronic device 1110 may insert the content block corresponding to the node in the document 1112 accordingly. Based on the node 1620-6 being a child node of root node 1620-1, the electronic device 1110 may determine that the level of the new content block is lower than the level of content block 1310-1 corresponding to the root node 1620-1. As shown in the document view 11000B of FIG. 1JB, the electronic device 1110 may insert a content block 1310-14 in the document 1112 and the level of the content block 1310-14 is the first-level heading. In the example of FIGS. 1JA and 1JB, node 1620-6 in FIG. 1JA, for example, may correspond to a new node being inserted, and content block 1310-14 in FIG. 1JB, for example, may correspond to the corresponding content block of the new node. It should be understood that the foregoing correspondence is merely illustrative, and does not constitute any limitation on the embodiments of the present disclosure.

In this way, the user 1102 can organize thoughts for the document 1112 in the mindmap 1610, and synchronize the editing operation of the user 1102 to the corresponding content in the corresponding content block 1310 of the document 1112, so that the adjustment of the thoughts of the user 1102 for the document 1112 in the mindmap 1610 is synchronized to other views of the document 1112. Therefore, the efficiency of editing the document 1112 by the user 1102 can be improved, and the user experience can be improved.

In yet another example, if it is determined that the editing operation deletes a node from the mindmap 1610, the electronic device 1110 may delete a corresponding content block from the document 1112. FIGS. 1KA and 1KB respectively show a schematic diagram of editing the mindmap 1610 according to some embodiments of the present disclosure. As shown in mindmap view 11100A of FIG. 1KA, the user 1102 has deleted the node 1620-5 in the mindmap 1610. In response to determining the deletion operation, the electronic device 1110 may correspondingly delete the content block 1310-11 corresponding to the node 1620-5, as shown in the document view 11100B of FIG. 1KB. Additionally, the electronic device 1110 may delete the content block 1310-12 associated with the content block 1310-11 accordingly. For purposes of illustration, in FIGS. 1KA and 1KB, the elements that are deleted are shown in a light color. In the example of FIGS. 1KA and 1KB, the node 1620-5 in FIG. 1KA may correspond to a deleted node, for example, and content block 1310-11 in FIG. 1KB may correspond to the content block of the deleted node, for example. It should be understood that the foregoing correspondence is merely illustrative, and does not constitute any limitation on the embodiments of the present disclosure.

In this way, the user 1102 can organize thoughts for the document 1112 in the mindmap 1610, and synchronize the editing operation of the user 1102 to the corresponding content in the corresponding content block 1310 of the document 1112, so that the adjustment of the thoughts of the user 1102 for the document 1112 in the mindmap 1610 is synchronized to other views of the document 1112. Therefore, the efficiency of editing the document 1112 by the user 1102 can be improved, and the user experience can be improved.

It will be understood that although the content blocks 1310 with respective heading levels in the document 1112 are schematically shown in order, in some cases, the level of these content blocks 1310 may be out-of-order. This will be described in further detail below with reference to FIGS. 1OA and 1OB. FIGS. 1OA and 1OB illustrate schematic diagrams of a document view 11200A and a mindmap view 11200B, respectively, of the document 1112 according to some embodiments of the present disclosure. For ease of illustration, the exemplary content in the document 1112 of FIGS. 1OA and 1OB is different from the content of document 1112 of FIGS. 1C-1KB. The document 1112 in FIG. 1OA includes six content blocks 11210-1 to 11210-6, where the level of the content block 11210-1 is a document title, the level of the content block 11210-2 is a fourth-level heading, the level of the content block 11210-3 is a third-level heading, the level of the content block 11210-4 is a third-level heading, the level of the content block 11210-5 is a first-level heading, and the level of the content block 11210-6 is a second-level heading. It can be seen that, in the example of FIG. 1OA, the levels of the content blocks are out of order, for example, none of a first-level heading to third-level heading is present before the fourth-level heading.

In the case shown in FIG. 1OA, the electronic device not only considers the level of the content block but also considers the position of the content block when determining the hierarchy in the mindmap. For example, the electronic device traverses each content block in the document 1112 from top to bottom. First, starting from the uppermost content block 11210-1, based on the level of the content block 11210-1 being the document title, the electronic device generates the node 11230-1 corresponding to the content block 11210-1 as the root node in the mindmap 11220. Subsequently, encountering content block 11210-2 that is located after content block 11210-1, the electronic device may compare the level of content block 11210-2 with the level of content block 11210-1. Since the level of the content block 11210-2 is a fourth-level heading, and the level of the content block 11210-1 is a document title, the level of the content block 11210-2 is lower than the level of the content block 11210-1. In response to determining that the level of the content block 11210-2 is lower than the level of the content block 11210-1, the electronic device may set the node 11230-2 corresponding to the content block 11210-2 as a child node of the node 11230-1 corresponding to the content block 11210-1, as shown in the mindmap 11220 in FIG. 1OB.

Subsequently, when the content block 11210-3 located after the content block 11210-2 is encountered in the traversal process, the electronic device may compare the levels of previous and subsequent content blocks 11210-3 and the content block 11210-2. Since the level of the content block 11210-3 is a third-level heading, and the level of the content block 11210-2 is a fourth-level heading, the level of the content block 11210-3 is higher than the level of the content block 11210-2. In response to determining that the level of content block 11210-3 is higher than the level of content block 11210-2, the electronic device may trace back to the parent node of node 11230-2 corresponding to content block 11210-2, i.e., node 11230-1. Since the level of the content block 11210-1 corresponding to the node 11230-1 is the document title, the level of the content block 11210-3 is lower than the level of the content block 11210-1. In response to determining that the level of the content block 11210-3 is lower than the level of the content block 11210-1, the electronic device may set the node 11230-3 corresponding to the content block 11210-3 as a child node of the node 11230-1 corresponding to the content block 11210-1.

As shown in FIGS. 1OA and 1OB, although content block 11210-2 is hierarchically lower than content block 11210-3, in mindmap 11220, nodes 11230-2 and 11230-3 corresponding to the two content blocks have the same level, i.e., are both child nodes of root node 11230-1. In this way, compared to the existing directory structure, the affiliation relationship between the headings can be reflected more directly, and unnecessary hierarchical jump in the mindmap 11220 is avoided, so that the user experience can be improved, and the efficiency of the user 1102 in organizing thoughts is improved.

Returning to FIG. 1OA, the electronic device continues to traverse, encountering the content block 11210-4 located after the content block 11210-3 during the traversal, and the electronic device may compare the level of the content block 11210-4 with the level of the content block 11210-3. Since the level of the content block 11210-4 is a third-level heading, and the level of the content block 11210-3 is also a third-level heading, the level of the content block 11210-4 is equal to the level of the content block 11210-3. In response to determining that the level of the content block 11210-4 is equal to the level of the content block 11210-3, the electronic device may set the node 11230-4 corresponding to the content block 11210-4 as a sibling node of the node 11230-3 corresponding to the content block 11210-3, that is, the node 11230-4 is also set as a child node of the node 11230-1. Similarly, the electronic device may determine that node 11230-5 corresponding to content block 11210-5 is a child node of node 11230-1 and node 1610-12 corresponding to content block 11210-6 is a child node of node 11230-5.

With the above rules, when the heading levels are out of order, the corresponding mindmap can be efficiently generated. Compared to the existing directory structure, the direct affiliation relationship of various headings can be reflected more directly, so that unnecessary level jump in the mindmap is avoided, the user experience can be improved, and the efficiency of the user 1102 in organizing thoughts is improved.

In some embodiments, the blank document 1112 may also be converted to a mindmap view. In a blank mindmap, a root node inserted by the user 1102 corresponds to a content block having a document title level, a first-level node inserted by the user 1102 corresponds to a content block having a first-level heading level, a second-level node inserted by the user 1102 corresponds to a content block having a second-level heading level, and so on.

It can be seen from the above description in conjunction with FIGS. 1A to 1OB that, in the method for document presentation according to embodiments of the present disclosure, with content in the document being managed and presented by means of a plurality of content blocks respectively having presentation attributes, switching of a plurality of different views of the document can be achieved at a finer granularity, so that requirements of the users for corresponding scenarios can be better satisfied. In this way, the conversion of the document among multiple document formats can be avoided, so that the users can switch the presentation mode of the document by triggering the corresponding views. Thus, the user experience for the document is improved and the application scenarios of the document are expanded.

Example implementations of the method according to the present disclosure have been described in detail above with reference to FIGS. 1A to 1OB, and implementations of corresponding apparatuses will be described below with reference to FIG. 1P.

FIG. 1P illustrates a block diagram of an example apparatus 11300 for document presentation according to some embodiments of the present disclosure. The apparatus 11300 may be used, for example, to implement the electronic device 1110 shown in FIG. 1A. The apparatus 11300 may include an original presenting module 11302. The original presentation module 11302 is configured to present a first view of a document, the document including at least one content block, the at least one content block having a presentation attribute. The apparatus 11300 may further include an adjusting module 11304 configured to adjust the presentation attribute of the at least one content block in response to receiving an indication of presenting the second view of the document. In addition, the apparatus 11300 may further include a target presentation module 11306 configured to present at least one content block in the second view based on the adjusted presentation attribute.

In some embodiments, the adjusting module 11304 includes: a type determining module configured to determine a type of the second view based on the indication; and an attribute adjusting module configured to adjust the presentation attribute based on the type of the second view.

In some embodiments, the attribute adjustment module includes a display adjustment module configured to, in response to determining that the type of the second view includes a demonstration type, adjust at least one of: a position of the at least one content block in the second view; a size of the at least one content block in the second view; display content of the at least one content block in the second view; or a combined layout pattern of the at least one content block.

In some embodiments, the apparatus 11300 further includes at least one of the following: a paging adjustment module configured to adjust paging of the second view in response to receiving an adjustment to a paging control element presented in the second view; a visibility adjustment module configured to adjust visibility of at least one content block in response to receiving an adjustment to a visibility control element presented in the second view; a comment adjustment module configured to adjust a comment for the at least one content block in response to receiving an adjustment to a comment control element presented in the second view; and a color adjustment module configured to adjust color for the at least one content block in response to receiving an adjustment to a color control element presented in the second view.

In some embodiments, the attribute adjustment module includes: a level determination module configured to determine a heading level of the at least one content block in the first view in response to determining that the type of the second view includes a mindmap type; and a mindmap presentation module configured to adjust the presentation attribute of the at least one content block based on the heading level, and display the at least one content block with the presentation attribute in the mindmap view.

Modules and/or units included in the apparatus 11300 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the units in apparatus 11300 may be implemented, at least in part, by one or more hardware logic components. By way of example, and not limitation, exemplary types of hardware logic components that may be used include field-programmable gate arrays (FPGAs), application-specific integrated circuits (ASICs), application-specific standards (ASSPs), system-on-a-chip (SOCs), complex programmable logic devices (CPLDs), and the like.

The modules and/or units shown in FIGS. 1P may be partially or fully implemented as hardware modules, software modules, firmware modules, or any combination thereof. In particular, in some embodiments, the processes, methods or processes described above may be implemented by hardware in a storage system or a host corresponding to the storage system or other computing device independent of the storage system.

As described above, document demonstration is spread throughout various aspects of people, such as life, work, and social networking, for example, conference reporting, enterprise promotion, product recommendation, and activity display. Documents to be presented often have some input or inserted content that can supplement the content of the document. During document demonstration, the input content usually needs to be presented. For example, input content in a document being presented, such as an inserted webpage link or an inserted document, may need to be presented. In one conventional presentation scheme for the input content, users click the input content, and in response to the user clicking, an additional application page corresponding to the input content is jumped to and opens the input content for presentation. For example, in response to user clicking on an inserted webpage link, a webpage browser is jumped to and opens the webpage and present content of the webpage.

This conventional input content presenting scheme may involve many jumps during document demonstration. This jump path presents a strong sense of the boundary for presentation, and the jump and switching back and forth can destroy the immersion experience of the viewer on the content. Therefore, it is desirable to avoid the jump in the document demonstration process to improve user experience. On the other hand, there may be a scenario that some input content is to be deeply read during presentation. How to solve the conflict between the transparent transmission of content deep reading and the typesetting aesthetics during demonstration is also a matter of concern.

According to the embodiments of the present disclosure, an improved document demonstration solution is provided. In this solution, a view of a content item input in a document is presented in a demonstration page of the document. After a trigger indication for the view of the input content item is detected, the input content item is presented in the demonstration page without jumping to an application page corresponding to the content item.

The solution can support presenting of an input content item in a demonstration page by detecting a trigger indication for a view of the content item. In this way, it is possible to avoid jumping to a page corresponding to the content item, other than the demonstration page, to display the content item. In this way, the user can directly view the content item by triggering the input view of the content item without jumping, thereby improving the user experience of document demonstration.

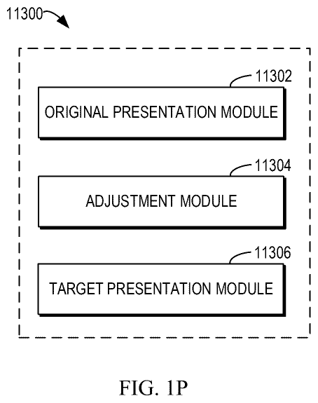

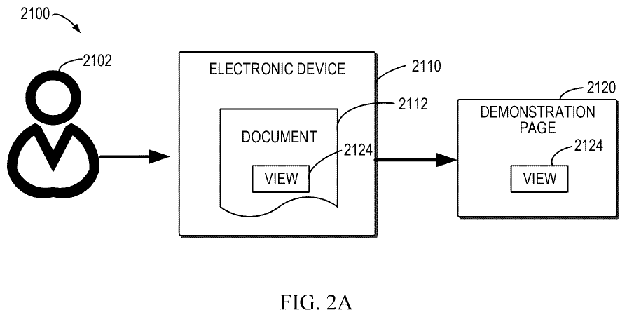

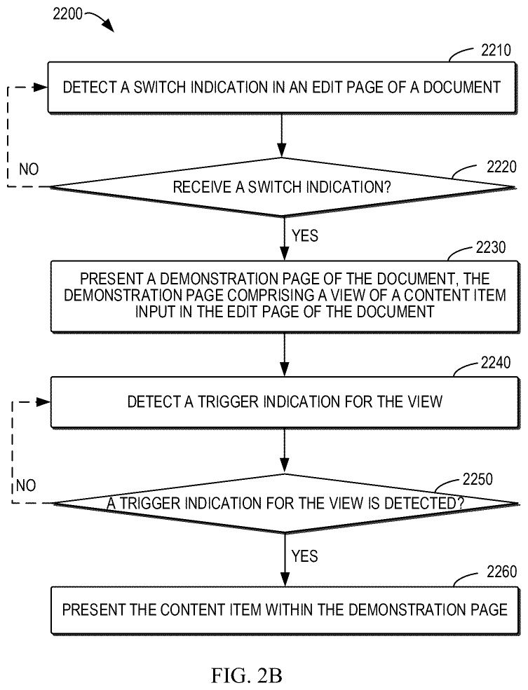

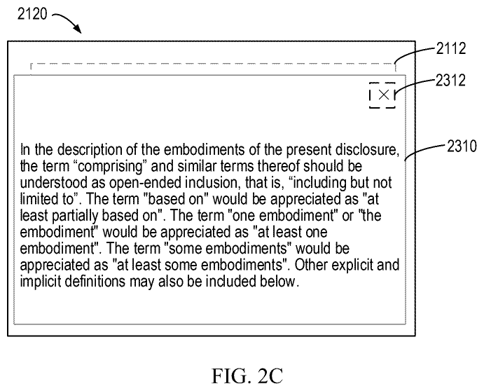

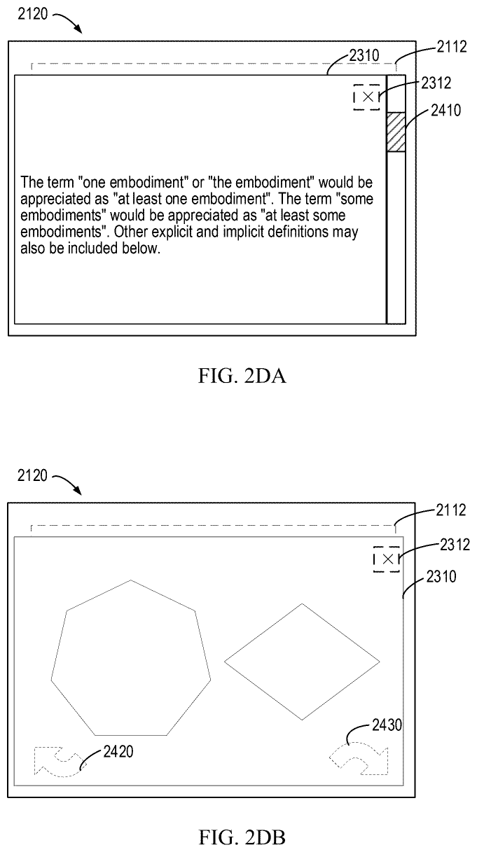

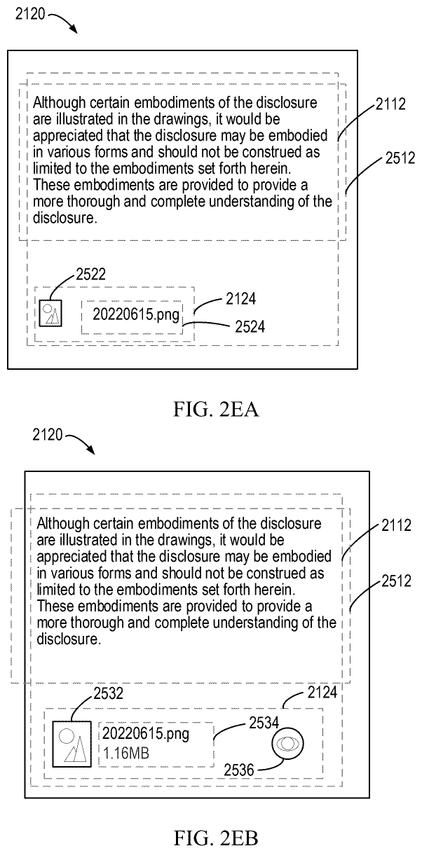

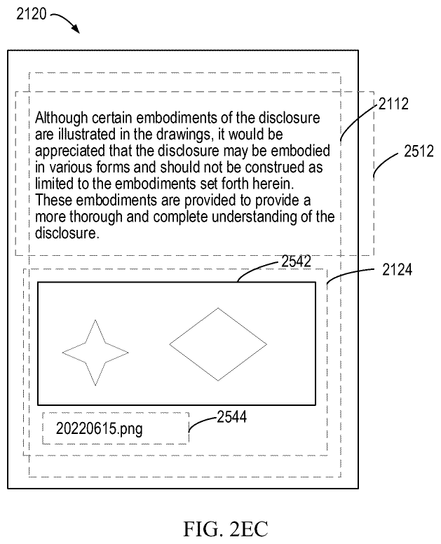

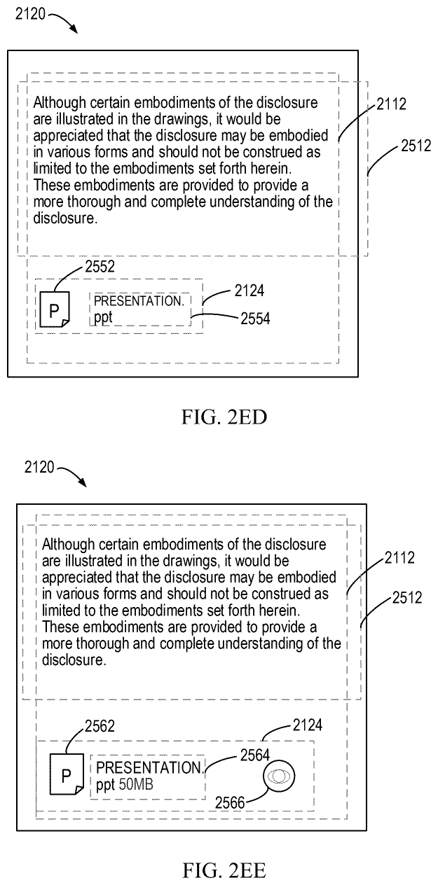

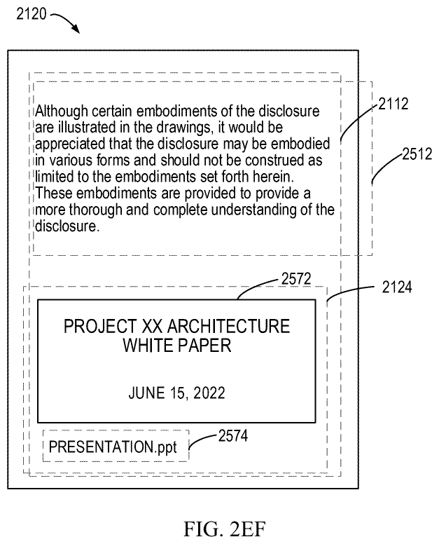

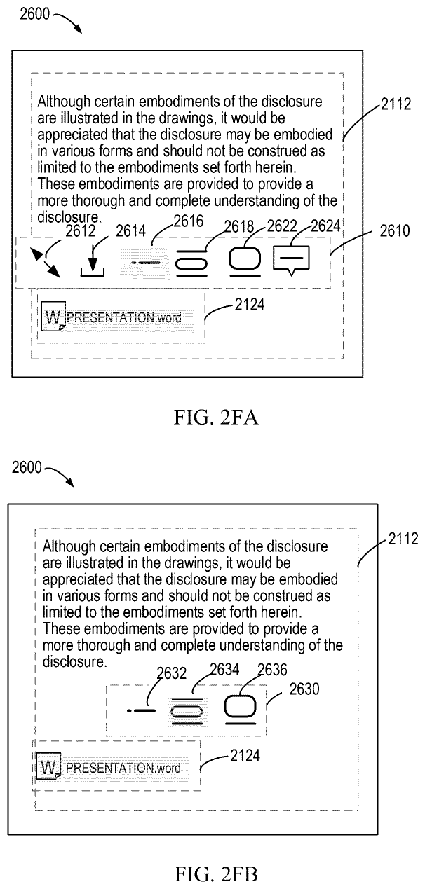

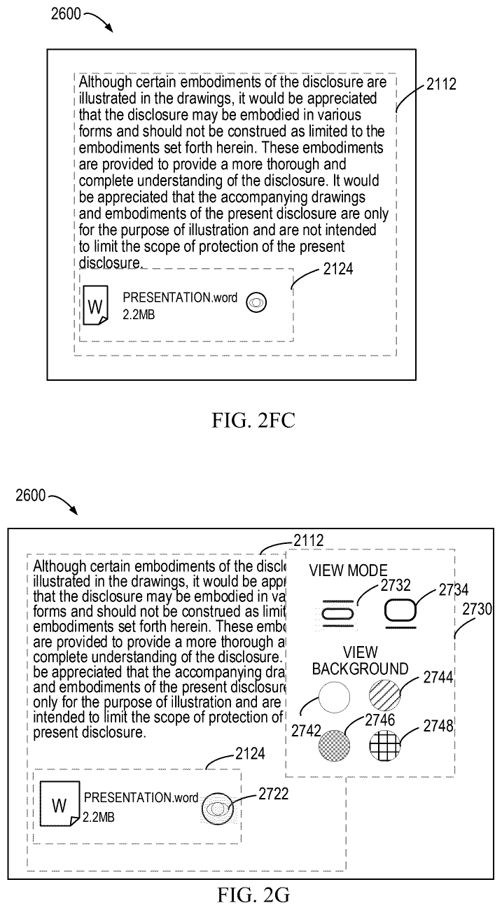

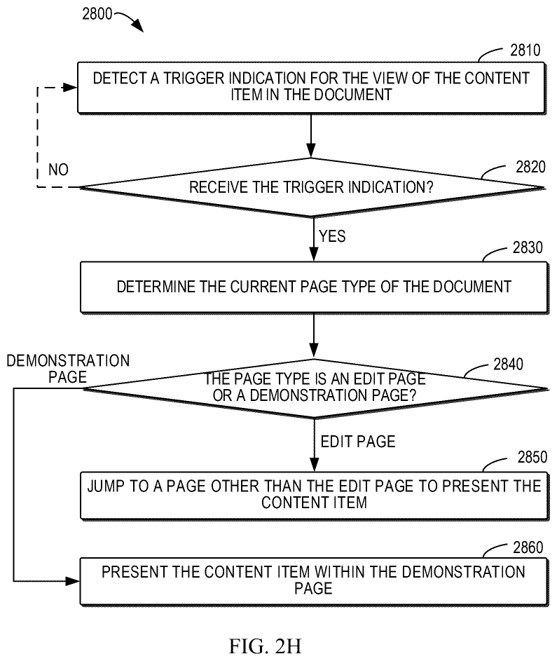

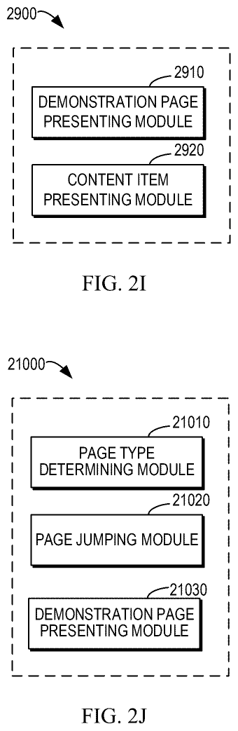

FIG. 2A illustrates a schematic diagram of an example environment 2100 in which embodiments of the present disclosure can be implemented. In this example environment 2100, an electronic device 2110 may present a document 2112 to present a demonstration page 2120 of the document 2112. Herein, the document 2112 may be any document format suitable for presentation, such as a word document, a ppt document, a pdf document, and the like.

A view 2124 (hereinafter, simply referred to as view 2124) of an input or inserted content item in the document 2112 and other optional content in the document 2112 is presented in the demonstration page 2120. The demonstration page 2120 may be provided by, for example, a document editing application or a document demonstration application in the electronic device 2110. The demonstration page 2120 may have a display area suitable for the display area size of the electronic device 2110, or have any other suitable predetermined or user-specified display area.

In some embodiments, a user 2102 may interact with electronic device 2110 to select or modify content presented in demonstration page 2120. For example, the user 2102 may input a trigger indication for the view 124 to cause presentation of content of an input or inserted content item associated with the view 2124 in demonstration page 2120.

Herein, the input content item may be an inserted file or an inserted file link. For example, the input content item may be a picture, a table, a word file, a demonstration deck, a multimedia file (e.g., audio or video), a file link (e.g., an http link or an ftp link), or the like. The input content item may be pre-stored in a storage apparatus of the electronic device 2110. Alternatively or additionally, the input content item may also be stored at a network position or in a cloud storage device. The embodiments of the present disclosure are not limited in this regard.

The electronic device 2110 may be any type of mobile terminal, fixed terminal, or portable terminal, including a mobile handset, desktop computer, laptop computer, notebook computer, netbook computer, tablet computer, media computer, multimedia tablet, personal communication systems (PCS) device, personal navigation device, personal digital assistant (PDA), audio/video player, digital camera/camcorder, positioning device, television receiver, radio broadcast receiver, e-book device, gaming device, or any combination of the foregoing, including accessories and peripherals of these devices, or any combination thereof. In some embodiments, the electronic device 2110 can also support any type of interface for a user (such as “wearable” circuitry, etc.).

It should be understood that the structure and function of the environment 2100 are described for exemplary purposes only and do not imply any limitation on the scope of the present disclosure.

FIG. 2B illustrates a flowchart of a process 2200 for document demonstration according to some embodiments of the present disclosure. The process 2200 may be implemented at the electronic device 2110. For ease of discussion, the process 2200 will be described with reference to the environment 2100 of FIG. 2A.

At block 2210, the electronic device 2110 detects a switch indication in an edit page of the document 2112. The edit page may be a page for the user 2102 to edit the document 2112. Several examples of edit pages will be described in detail below in conjunction with FIGS. 2FA to 2FC and 2G. In some embodiments, the switch indication may be, for example, a single mouse click, a double mouse click, a mouse frame selection, a mouse hover, a finger or stylus touch, a finger or stylus press, or the like of the user 2102 on a page switch control in the edit page. As an example, the user 2102 clicks the right mouse button in the edit page to present a menu of options. The menu of options may include a switch control. When the user 2102 selects the switch control, the electronic device 2110 may detect the switch indication. In some embodiments, the switch indication may also be voice control of the user 2102. The form of switch indication employed herein is not limited in this regard.

At block 2220, the electronic device 2110 determines whether a switch indication is received. If the electronic device 2110 does not receive the switch indication at block 2220, the electronic device 2110 continues to detect the switch indication at block 2210. For example, the electronic device 2110 may continuously detect the switch indication in the edit page of the document until the switch indication is detected. Alternatively, the electronic device 2110 may detect the switch indication at predetermined time intervals. In some embodiments, detection of the switch indication may also be stopped after a period of time. Furthermore, detection of the switch indication may also be initiated by, for example, a user indication.

Additionally or alternatively, in some embodiments, the electronic device 2110 may also detect a switch indication in the demonstration page of the document 2112 and switch to the edit page of the document 2112. With flexible switching between the edit page and the demonstration page of the document, different application scenarios of the document can be adapted. The users may perform different operations on the document by switching to different pages.

If it is determined at block 2220 that the switch indication is received, the electronic device 2110 presents the demonstration page 2120 of the document 2112 at block 2230. The demonstration page 2120 includes the view 2124 of the content item input in the document 2112. Further, the demonstration page 2120 may also include other content in the document 2112. For example, the electronic device 2110 may present demonstration page 2120 for presentation of the document 2112 in response to a demonstration indication of the user 2102 for the document 2112. In some embodiments, the view 2124 of the content item may have a variety of different forms. Different types of the view 2124 will be further described below in conjunction with FIGS. 2EA to 2EF.

At block 2240, the electronic device 2110 detects a trigger indication for the view 2124. The trigger indication may be, for example, a single mouse click, a double mouse click, a mouse box selection, a mouse hover, a finger or stylus touch, a finger or stylus press, or the like of the user 2102 on the view 2124. The form of the trigger indication employed herein is not limited in this regard.

At block 2250, the electronic device 2110 determines whether a trigger indication for the view 2124 is detected. If the electronic device 2110 does not detect any trigger indication for the view 2124 at block 2250, the electronic device 2110 continues to detect the trigger indication for the view 2124 at block 2240. For example, the electronic device 2110 may continuously detect the trigger indication for the view 2124 until the trigger indication is detected. Alternatively, the electronic device 2110 may detect the trigger indication for the view 2124 at predetermined time intervals until the trigger indication is detected. In some embodiments, detection of the trigger indication for the view 2124 may also be stopped after a period of time. Further, detection of the trigger indication for the view 2124 may also be initiated by, for example, a user indication.

If the electronic device detects the trigger indication for the view 2124 at block 2250, the electronic device 2110 presents the content item within demonstration page 2120 at block 2260. For example, the electronic device 2110 may avoid jumping to a page corresponding to the content item that is other than the demonstration page 2120.

In some embodiments, the electronic device 2110 may present the content item in a browsing window of the demonstration page 2120. For example, the browsing window may include a pop-up window. In some embodiments, the electronic device 2110 may invoke an application framework of the document 2112. The electronic device 2110 may construct a browsing window in the demonstration page 2120 of the document 2112 and present the content item in the browsing window. For example, in an example where the input content is a webpage, the electronic device 2110 may construct a browsing window at the client to present the content item. Alternatively or additionally, in some embodiments, the electronic device 2110 may invoke a page framework carrying the demonstration page 2120 of the document 2112. The electronic device 2110 may construct a browsing window in the demonstration page 2120 of the document 2112 and present the content item in the browsing window. For example, in an example where the input content is a webpage, the electronic device 2110 may present the content item by constructing a browsing window through the webpage.

With the content item being presented in the demonstration page 2120 without jumping to a page (such as a web browser or a video player) that is other than the demonstration page 2120 and corresponds to the content item, jumping during the document demonstration can be avoided, thereby improving the user experience.

FIG. 2C illustrates a schematic diagram of an example of presenting a content item in a browsing window according to some embodiments of the present disclosure. In the example of FIG. 2C, the browsing window 2310 is a pop-up window. The content of the input or inserted content item corresponding to the view 2124 is presented in the browsing window 2310. The browsing window is at least partially overlaid over the demonstration page 2120. The demonstration page 2120 presents the view 2124 and optional other content (not shown) in the document 2112. For purposes of explanation, specific text is presented in the drawings, but such text does not constitute any limitation on the embodiments of the present disclosure.

In some embodiments, the electronic device 2110 may further detect a closing indication for the browsing window 2310. For example, the electronic device 2110 may detect a trigger indication for a close control 2312. If a trigger indication for the close control 2312 is detected, it indicates that a close indication for the browsing window 2310 is detected. In this case, the electronic device 2110 closes the browsing window 2310. In addition, the electronic device 2110 will resume presentation of the demonstration page 2120, such as the demonstration page 2120 presented in FIGS. 2EA to 2EF below.

It should be understood that the size, shape, and position of the close control 2312 shown in FIG. 2C are merely exemplary and not limiting. The close control 2312 may have other shapes and sizes, and may be elsewhere in the browsing window 2310. Additionally or alternatively, the close control 2312 may be concealable, which may change from a hidden state to a visible state when the user 2102, for example, moves a mouse to a position of the close control 2312.

It should be understood that in some embodiments, the browsing window 2310 may be translucent. For example, the electronic device 2110 may receive a user indication of modifying the transparency of the browsing window 2310. Although the browsing window 2310 is a pop-up window in the example of FIG. 2C, in other examples, the browsing window may also be other forms of windows, such as an expandable and contracted window, or a window in a fixed position in the demonstration page 2120, or the like. For example, in examples where view 2124 occupies a larger area of demonstration page 2120, the browsing window may be in demonstration page 2120 where the view 2124 is located. In this example, an input content item associated with the view 2124 may be presented at the position of view 2124.

In some embodiments, the user 2102 may also interact with the electronic device 2110 to perform operations such as page turning and scrolling browsing on the content presented in the browsing window 2310. To better understand some embodiments of the present disclosure, further discussion will be made below with reference to a user interface diagram.

FIG. 2DA illustrates a schematic diagram of an interaction example for a demonstration page according to embodiments of the present disclosure. In the example of FIG. 2DA, the browsing window 2310 includes a scrollbar control 2410. The electronic device 2110 is configured to scroll to present the content item in response to detecting a scroll operation for the scrollbar control 2410. For example, if the scrollbar control 2410 is scrolled up, the content presented in the browsing window 2310 will scroll up until scrolling of the scrollbar control 2410 is stopped or reaches the uppermost position. Conversely, if scrollbar control 2410 is scrolled down, the content presented in the browsing window 2310 will scroll down until scrolling of the scrollbar control 2410 is stopped or reaches the lowermost position.

The scrollbar control 2410 shown in FIG. 2DA is merely exemplary and not limiting. In some embodiments, the scrollbar control 2410 may have other shapes, sizes, or positions. Such embodiments of FIG. 2DA utilizing the scrollbar control are suitable for input content items of such as long document type. In this way, the content to be presented in the browsing window of the content item can be quickly and conveniently positioned.

Alternatively or additionally, in some embodiments, the electronic device 2110 may further remove the presentation of a first content page of the content item from the browsing window 2310 and present a second content page of the content item in the browsing window 2310 in response to detecting a page turning indication with the first content page of the content item being presented in the browsing window 2310. For example, the second content page may be a content page before the first content page or a content page after the first content page.

FIG. 2DB shows a schematic diagram of a page turning interaction example for a demonstration page according to embodiments of the present disclosure. As shown, a page up control 2420 and a page down control 2430 are shown in the browsing window 2310. If the electronic device 2110 detects that the page up control 2420 is triggered, the electronic device 2110 removes the current content page from the browsing window 2310 and presents the previous content page (if any) of the current content page. If the electronic device 2110 detects that the page down control 2430 is triggered, the electronic device 2110 removes the current content page from the browsing window 2310 and presents the next content page (if any) of the current content page.

It should be understood that, in some embodiments, the page up control 2420 and the page down control 2430 may be hidden controls not shown. When the user 2102 clicks or touches the lower left corner position of the browsing window 2310, the page up control 2420 is triggered. Similarly, when the user 2102 clicks or touches the lower right corner position of the browsing window 2310, the page down control 2430 is triggered. It should be understood that the up and down page turning controls may also be arranged at other positions in the browsing window 2310, and may have other sizes and shapes. Such embodiments of FIGS. 2CB that can page the content item for presentation are suitable for input or inserted content items such as documents of the type of demonstration deck, for example, paginated displays. In this way, the content to be presented in the browsing window of the content item can be quickly and conveniently positioned.

It should be understood that the pages shown in FIGS. 2DA and 2 DB and the pages in other figures to be described below are merely examples, and there may actually be various page designs. Individual graphical elements in the page may have different arrangements and different visual representations, one or more of which may be omitted or replaced, and one or more other elements may also be present. The embodiments of the present disclosure are not limited in this regard.

Several interaction examples of the demonstration page 2120 are shown above by taking scrolling browsing and page turning browsing as an example. In some embodiments, there may also be more interaction examples of the demonstration page 2120. For example, in some embodiments, the input content item may include playable multimedia content, such as an audio file, video file, or the like. The electronic device 2110 may play multimedia content in the demonstration page 2120. For example, the electronic device 2110 may play multimedia content at a position of such as a pop-up window or a view occupying a large area. In a process of playing the multimedia content, the electronic device 2110 may control the played multimedia content in response to an interaction instruction of the user 2102, for example, playing positioning, acceleration, and deceleration of the multimedia content.

Through the various interaction processes of the demonstration page 2120 described above, content items input or inserted in the document 2112 may be opened and interacted during the demonstration process. In this way, the user experience of the document demonstration can be further improved.

It should be understood that the demonstration page 2120 of the document 2112 is a page for presenting content items of the document 2112. In some embodiments, in the demonstration page 2120 of the document 2112, the electronic device 2110 may receive a presentation instruction for content input in an edit page of the document. Additionally or alternatively, the electronic device 2110 may also reject receiving an editing instruction for the content input in the edit page. In this way, the content input in the edit page in the document can be prevented from being incorrectly edited or modified by the user in the demonstration page.

Several examples of presenting a content item associated with the view 2124 by triggering the view 2124 and performing various interactions on the presented content item during presentation are described above with reference to FIGS. 2C to 2DB. Additionally or alternatively, in some embodiments, the view 2124 may be of a variety of different types, and the user 2102 may select a view of the content item as desired. For example, in the edit page of document 2112, the user 2102 may select the type of view 2124. The electronic device 2110 may detect the type of view selected by the user 2102 and input the type of view 2124 in the document 2112.

FIGS. 2EA to 2EF show schematic diagrams of examples of the demonstration page 2120 for document demonstration, in which the view 2124 may have different forms, according to some embodiments of the present disclosure. For example, the demonstration page 2120 presents the view 2124 as well as portions of content in document 2112. For example, the presented content of the document 2112 includes a section of text 2512 and the view 2124. The section of text 2512 may be content in the document 2112 itself, rather than an input content item. For illustrative purposes, a specific piece of text is presented in the figure, but such text does not constitute any limitation on the embodiments of the present disclosure. It should be understood that although only one section of text 2512 and one view 2124 are shown in the examples of FIGS. 2EA to 2EF for illustrative purposes, this is merely exemplary and not limiting. More or fewer words may be presented in the demonstration page 2120, or more or fewer views may be presented.

In some embodiments, although not shown, controls such as a scrollbar control and/or a page turning control may also be provided in the demonstration page 2120 for navigating and positioning the content of the presented document 2112. In addition, a close control may also be provided in the demonstration page 2120 for closing the current demonstration page 2120.

In the example of FIG. 2EA to FIG. 2EC, the input content item of the document 2112 is a picture named “20220603.png”. In FIG. 2EA, the view 2124 belongs to a first view presenting first information associated with a content item and the first view occupies a first area in document 2112. That is, the first view occupies the first area in the demonstration page 2120. The first information includes a filename 2524 of the content item. Alternatively or additionally, the first information may further include a category diagram 2522 of a file category of the content item. The category diagram 2522 indicates that the content item belongs to a category of picture.

In FIG. 2EB, the view 2124 belongs to a second view that presents second information associated with the content item. This second view occupies a second area in document 2112. That is, the second view occupies a second area in the demonstration page 2120. The second area may be greater than the first area occupied by the first view. The second information includes a filename 2534 of the content item and auxiliary information of the content item, such as a file size. Alternatively or additionally, the second information may further include a category diagram 2532 of the file category of the content item. In addition, the second information may further include a second view editing indicator 2536. The user 2102 may edit the second view by triggering the second view editing indicator 2536. The editing process for the second view will be described in detail below with reference to FIG. 2G.

In FIG. 2EC, the view 2124 belongs to a third view that presents third information associated with the content item. This third view occupies a third area in document 2112. That is, the third view occupies a third area in the demonstration page 2120. The third area may be greater than the second area occupied by the second view. For example, the third information may include a thumbnail or preview 2542 of the content item, or include the content item itself. Alternatively or additionally, the third information may further include a filename 2544 of the input content item. In some embodiments, a third view editing indicator (not shown) may also be included in the third view.

Similarly, in the example of FIGS. 2ED to 2EF, the input content item of document 2112 is a demonstration deck named “Presentation.ppt”.

In FIG. 2ED, the view 2124 belongs to a first view presenting first information associated with a content item and the first view occupies a first area in document 2112. The first information includes a filename 2554 of the content item, i.e., “Presentation.ppt”. Alternatively or additionally, the first information may further include a category diagram 2552 of a file category of the content item. The category diagram 2552 indicates that the content item belongs to a category of demonstration deck (i.e., ppt).

In FIG. 2EE, view 2124 belongs to a second view that presents second information associated with the content item. This second view occupies a second area in document 2112. The second area may be greater than the first area occupied by the first view. The second information includes a filename 2564 of the content item and auxiliary information of the content item, such as a file size. Alternatively or additionally, the second information may further include a category diagram 2562 of the file category of the content item. In addition, the second information may further include a second view editing indicator 2566. The user 2102 may edit the second view by triggering the second view editing indicator 2566. The editing process for the second view will be described in detail below with reference to FIG. 2G.

In FIG. 2EF, the view 2124 belongs to a third view that presents third information associated with the content item. This third view occupies a third area in document 2112. The third area may be greater than the second area occupied by the second view. For example, the third information may include home page content 2572 of the content item. Alternatively or additionally, the third information may further include a filename 2574 of the input content item. In some embodiments, the third view may further include an optional third view editing indicator.

As previously described, in some embodiments, the content item associated with view 2124 may be presented in the demonstration page 2120 where the view 2124 is located. For example, in the example where the view 2124 is the third view, the browsing window for the content item may be at the position in demonstration page 2120 where the third view is located. In this example, the input or inserted content item associated with view 2124 may be presented at the position of the third view. For example, the multimedia content may be played at the position of the third view.

Several examples of the demonstration page 2120 of the document 2112 and the various views 2124 of the input content items are described above with reference to FIGS. 2EA to 2EF taking input content items of picture type and demonstration deck type as examples. It should be understood that these examples of demonstration pages 2120 and views 2124 are merely exemplary and not limiting. The demonstration page 2120 may have a different shape than that shown in FIGS. 2EA to 2EF. For example, the demonstration page 2120 may be square or circular, etc. The demonstration page 2120 may also have different sizes, such as 13 inches, 14 inches, 3.5 inches, etc. View 2124 may belong to the first view, the second view, the third view, or any other suitable view type described in detail above. In addition to the information listed above, more or less information may be shown in the various views. The scope of the present disclosure is not limited in this regard.

The various different views 2124 described above may be edited and switched by the user. FIG. 2FA illustrates a schematic diagram of an interaction example for editing the view 2124 of a content item according to embodiments of the present disclosure. For example, in an edit page 2600 of the document 2112, when the user 2102 selects the input content item, an edit toolbar 2610 may be displayed, for example, in the form of a floating toolbar. Each icon in the edit toolbar 2610 corresponds to a different editing operation. For example, icon 2612 represents a zoom operation, icon 2614 represents a store operation, icon 2616 represents that view 2124 being a first view is to be added, icon 2618 represents that view 2124 being a second view is to be added, icon 2622 represents that the view 2124 being a third view is to be added, icon 2624 represents an operation to add an annotation, and so on. In the example of FIG. 2DA, icon 2616 is selected as shown in shading, i.e., the view 2124 being the first view is to be added.

Additionally or alternatively, in the editing mode of the document 2112 or in the edit page 2600 of the document 2112, the electronic device 2110 may detect a view switch indication for the content item. The view switch indication is used to indicate switching of the view 2124 to a further view. In response to detecting the view switch indication, the electronic device 2110 may switch the view 2124 to a further view in the document 2112. FIG. 2FB illustrates a schematic diagram of another interaction example for editing the view 2124 of a content item according to embodiments of the present disclosure. In the edit page 2600 of the document 2112, when the user 2102 selects the view 2124 of the input content item, a switch toolbar 2630 of the view 2124 may be displayed, for example, in the form of a floating toolbar. Each icon in the switch toolbar 2630 corresponds to a different view type. Icon 2632 represents switching the view 2124 to a first view, icon 2634 represents switching the view 2124 to a second view, and icon 2636 represents switching the view 2124 to a third view. In the example of FIG. 2FB, icon 2634 is selected as shown in shading. In this example, the electronic device 2110 is to switch the view 2124 to the second view.

FIG. 2FC illustrates a schematic diagram of an interaction example for editing the view 2124 of the content item according to embodiments of the present disclosure. In response to detecting the view switch indication of switching the view 2124 to the second view (i.e., icon 2634 is selected) in FIG. 2FB, the electronic device 2110 switches the view 2124 to the view 2124 in FIG. 2FC. The view 2124 in FIG. 2FC occupies a larger area than that in FIG. 2FB and presents more information.

In some embodiments, the electronic device 2110 may detect a trigger for the view 2124 of the content item in the edit page 2600 of the document 2112. If the electronic device 2110 detects a trigger on the view 2124 of the content item in the edit page 2600, the electronic device 2110 may jump to a page other than the edit page 2600 to display the content item. For example, the electronic device 2110 may jump to demonstration page 2120 to display the content item.

Additionally or alternatively, in some embodiments, a switch indication control is further provided in the edit page 2600. As described above, the user 2102 may switch from the edit page 2600 to the demonstration page 2120 by triggering the switch indication control.

It should be understood that the pages shown in FIGS. 2FA to 2FC and the pages in other figures to be described below are merely examples, and various page designs may actually exist. Individual graphical elements in the page may have different arrangements and different visual representations, one or more of which may be omitted or replaced, and one or more other elements may also be present. The embodiments of the present disclosure are not limited in this regard.

In some embodiments, in the edit page 2600 of the document 2112, the electronic device 2110 may further edit the view 2124, for example, edit the layout of the view 2124. For example, in the edit page 2600 of document 2112, the electronic device 2110 may detect a view editing indication for the content item indicating a modification to a layout of the view 2124. In turn, the electronic device 2110 may modify the layout of the view 2124 based on the view editing indication.

FIG. 2G illustrates a schematic diagram of yet another interaction example for editing a view of a content item according to some embodiments of the present disclosure. For example, in the edit page 2600 of document 2112, a second view editing window 2730 may be displayed in demonstration page 2120 if the electronic device 2110 detects a trigger indication for a second view editing indicator 2722 in the view 2124. The second view editing window 2730 may include a view mode selection icon (also referred to as a card mode selection icon) and a view background selection icon (also referred to as a card background selection icon). When the icon 2732 in the view mode selection icons is selected, the view 2124 is kept unchanged as the second view. Conversely, if icon 2734 in the view mode selection icons is selected, the view 2124 may be switched to the third view.

In some embodiments, a view background selection icon may be used to select the background of view 2124. For example, when icon 2742 is selected, the background of view 2124 is white. If icon 2744, icon 2746, or icon 2748 is selected, the background of view 2124 is adjusted to the pattern displayed by the respective icon. It should be understood that the view background selection icons described above are merely exemplary, and more icons may be used to represent different background colors, background patterns, and the like of the view 2124. The layout of view 2124 may be modified to any suitable layout and form. The scope of the present disclosure is not limited in this regard.

The above shows editing the second view by triggering the second view editing indicator 2722 by taking view 2124 being the second view as an example. It should be understood that the third view may also be edited in a similar manner.

In the above manner, the users can select and edit the view of the input content item. In this way, the users may select different display manners of the view of the content item according to requirements. Areas of views can be visually distinguished and adapt to different typesetting layouts and repeated reading scenes. For example, for important input content, a third view with a larger area may be used. For less important input content, a first view or a second view with a smaller area may be used. In this way, the users can have more choices for view style and layout based on content priority when typesetting the document.

Example processes for document demonstration according to some embodiments of the present disclosure are described above in conjunction with FIGS. 2B to 2G. FIG. 2H illustrates a flowchart of another process 2800 for document demonstration according to some embodiments of the present disclosure. The process 2800 may be implemented at electronic device 2110. For ease of discussion, the process 2800 will be described with reference to the environment 2100 of FIG. 2A.

At block 2810, the electronic device 2110 detects a trigger indication for the view 2124 of the content item in the document 2112. The trigger indication may be, for example, a single mouse click, a double mouse click, a mouse box selection, a mouse hover, a finger or stylus touch, a finger or stylus press, or the like of the user 2102 on the view 2124. The trigger indication may also be another manner such as a voice trigger indication. The form of the trigger indication employed herein is not limited in this regard.

At block 2820, the electronic device 2110 determines whether a trigger indication is received or detected. In some embodiments, if the electronic device 2110 does not receive the trigger indication at block 2820, the electronic device 2110 may continue to detect the trigger indication at block 2810. If the electronic device 2110 receives the trigger indication at block 2820, the electronic device 2110 determines the current page type of the document 2112 at block 2830.

At block 2840, the electronic device 2110 determines whether the current page type of the document 2112 is an edit page or a demonstration page. For example, the edit page may be edit page 2600 or another suitable edit page. The demonstration page may be demonstration page 2120 or other suitable demonstration page.

If, at block 2840, the electronic device 2110 determines that the page type is the edit page 2600, the electronic device 2110 jumps to a page other than the edit page 2600 to present the content item at block 2850. For example, electronic device 2110 may jump to demonstration page 2120 or other suitable page to present the content item.

If, at block 2840, the electronic device 2110 determines that the page type is the demonstration page 2120, the electronic device 2110 presents the content item within the demonstration page 2120 at block 2860. For example, electronic device 2110 may present the content item within demonstration page 2120 without jumping to a page that is other than demonstration page 2120 and corresponds to the content item. As another example, electronic device 2110 may present the content item in a browsing window of demonstration page 2120. For example, the browsing window may include a pop-up window.

In some embodiments, the electronic device 2110 may invoke the application framework of the document 2112. The electronic device 2110 may construct a browsing window in the demonstration page 2120 of the document 2112 and present the content item in the browsing window. Alternatively or additionally, in some embodiments, the electronic device 2110 may invoke a page framework carrying the demonstration page 2120 of the document 2112.

With the content item being presented in the demonstration page 2120 without jumping to a page (such as a web browser or a video player) that corresponds to the content item, jumping during the document demonstration can be avoided, thereby improving the user experience.

Various examples of the electronic device 2110 presenting content items within the demonstration page 2120 and various examples of interactions in the demonstration page 2120 have been described in detail above in connection with FIGS. 2C and 2EA to 2EF. The above examples may all be incorporated into the process 2800. Details are not described herein again.

In some embodiments, in the example of presenting the edit page 2600 of the document 2112, the electronic device 2110 may further receive a switch indication in the edit page 2600 of the document 2112. The electronic device 2110 may present the demonstration page 2120 of the document 2112 in response to the switch indication. The demonstration page 2120 includes the view 2124 of the content item that is input in the edit page 2600 of the document 2112. In some embodiments, if electronic device 2110 detects a trigger indication for the view, electronic device 2110 may present the content item within demonstration page 2120. The above process may be similar to blocks 2210 to 2230 in the process 2200. Details are not described herein again. It should be understood that, in this case, the electronic device 2110 may further perform the process in blocks 2240 to 2260 in the process 2200 and any other additional processes. Examples of these processes may be similar to several examples of FIG. 2B described above in connection with the figures, and are not described in detail herein.

Additionally or alternatively, in the edit page 2600 of the document 2112, the electronic device 2110 may also detect a view switch indication for the content item. The view switch indication is used to indicate switching of the view to a further view. If the electronic device 2110 detects the view switch indication, the electronic device 2110 may switch the view to the further view in the document. The foregoing view switching process is similar to the process described above with reference to FIG. 2FA to FIG. 2FC, and details are not described herein again.

Additionally or alternatively, in the edit page 2600 of the document 2112, the electronic device 2110 may also detect a view editing indication for the content item. The view editing indication is used to indicate a modification to the layout of the view. If the electronic device 2110 detects the view editing indication, the electronic device 2110 may modify the layout of the view based on the view editing indication. The foregoing view layout modification process is similar to the process described above with reference to FIG. 2G, and details are not described herein again.

In some embodiments, in the edit page 2600, the electronic device 2110 may receive an editing indication for content in the document 2112. The electronic device 2110 may edit the content according to the editing instruction. Additionally or alternatively, in some embodiments, in the demonstration page 2120, the electronic device 2120 may receive a presentation instruction for content input in the edit page 2600. In addition, the electronic device 2120 may reject receiving the editing instruction for the content.

In this way, different pages can be set for the document to perform different operations. For example, by only editing the content of the document in the edit page and not editing the content of the document in the demonstration page, it is possible to avoid modifying the content of the document due to erroneous operation of the user in the document demonstration process. For another example, with the content of the document being presented in the demonstration page, the content can be prevented from being displayed by jumping to a page other than the demonstration page and corresponding to the content. In this way, page jumping in the document content demonstration process can be avoided, thereby improving the user experience of document demonstration.

Several examples of example processes of document demonstration according to some embodiments of the present disclosure are described above in conjunction with FIGS. 2B and 2H. It should be understood that the steps in the foregoing processes may be implemented in any manner in combination with each other. The order of the steps in the above process may be changed. Steps in the foregoing process may be omitted, or additional steps may be added.

FIG. 2I shows a schematic structural block diagram of an apparatus 2900 for document demonstration according to some embodiments of the present disclosure. The apparatus 2900 may be implemented as or included in the electronic device 2110. The various modules/components in the apparatus 2900 may be implemented by hardware, software, firmware, or any combination thereof.

As shown, the apparatus 2900 includes a demonstration page presenting module 2910 configured to present the demonstration page 2120 of the document 2112 in response to receiving a switch indication in an edit page of the document 2112. The demonstration page 2120 includes the view 2124 of the content item input in the document 2112. The apparatus 2900 further includes a content item presenting module 2920 configured to present the content item within the demonstration page 2120 in response to detecting the trigger indication for the view 2124. For example, there may be no need to jump to a page that is other than the demonstration page and corresponds to the content item.

In some embodiments, the content item presenting module 2920 includes a browsing window module configured to invoke an application framework of the document 2112, construct a browsing window in the demonstration page 2120 of the document 2112, and present the content item in the browsing window. Alternatively or additionally, the browsing window module is further configured to invoke a page framework carrying the demonstration page of the document 2112, construct a browsing window in the demonstration page 2120 of the document 2112, and present the content item in the browsing window.

In some embodiments, the apparatus 2900 further includes a browsing window closing module configured to close the browsing window in response to detecting a closing instruction for the browsing window.

In some embodiments, the browsing window module is configured to remove presentation of the first content page from the browsing window in response to detecting a page turning indication with the first content page of the content item being presented in the browsing window; and present a second content page of the content item in the browsing window.

Alternatively or additionally, in some embodiments, the browsing window module further includes a scrollbar control. In this example, the browsing window module is further configured to scroll to present the content item in response to detecting a scroll operation for the scrollbar control.

In some embodiments, the view of the inserted content item belongs to one of: a first view presenting first information associated with the content item, the first view occupying a first area in the document 2112; a second view presenting second information associated with the content item, the second view occupying a second area in the document 2112 that exceeds the first area; a third view presenting third information associated with the content item, the third view occupying a third area in the document 2112 that exceeds the second area.

In some embodiments, the view 2124 includes a third view, and content item presenting module 2920 is configured to present the content item at a position of the third view in demonstration page 2120.

In some embodiments, the inserted content items include playable multimedia content, such as audio or video, and the like. In such embodiments, the content item presenting module 2920 is configured to play the multimedia content.

In some embodiments, the apparatus 2900 further includes a view switch indication detection module configured to detect a view switch indication for the content item in the edit page of the document 2112. The view switch indication is used to indicate switching of the view 2124 to a further view. The apparatus 2900 further includes a view switching module configured to switch the view to a further view in the document 2112 in response to detecting the view switch indication.

In some embodiments, the apparatus 2900 further includes a view editing indication detection module configured to detect a view editing indication for the content item in an edit page of the document 2112. This view editing indication is used to indicate a modification to the layout of view 2124. The apparatus 2900 further includes a view layout modification module configured to modify the layout of the view 2124 based on the view editing indication.

In some embodiments, the apparatus 2900 further includes an instruction receiving module configured to receive, in the demonstration page 2120 of the document 2112, a presentation instruction for editing the content input in the page, and reject receiving the editing instruction for the content.

In some embodiments, the apparatus 2900 further includes a page jumping module configured to jump to a page other than the edit page to display the content item in response to a trigger for the view of the content item in the edit page of the document 2112.

FIG. 2J shows a schematic structural block diagram of an apparatus 21000 for document demonstration according to some embodiments of the present disclosure. The apparatus 21000 may be implemented as or included in the electronic device 2110. The various modules/components in the apparatus 21000 may be implemented by hardware, software, firmware, or any combination thereof.

As shown in the figure, the apparatus 21000 includes a page type determining module 21010 configured to determine a current page type of the document 2112 in response to receiving a trigger indication for the view 2124 of a content item in the document 2112. The apparatus 21000 further includes a page jumping module 21020 configured to, in response to the page type being an edit page, jump to a page other than the edit page to present the content item. The apparatus 21000 further includes a demonstration page presenting module 21030 configured to present a content item within the demonstration page 2120 in response to the page type being the demonstration page 2120.

In some embodiments, the apparatus 21000 further includes a switching module configured to present the demonstration page 2120 of the document 2112 in response to receiving a switch indication in the edit page of the document 2112. The demonstration page 2120 may include the view 2124 of the content item input in an edit page of the document 2112.

In some embodiments, the apparatus 21000 may further include a content item presenting module configured to present the content item within the demonstration page 2120 in response to detecting the trigger indication for the view 2124. In some embodiments, the content item presenting module is configured to invoke an application framework of the document 2112, construct a browsing window in the demonstration page 2120 of the document 2112, and present the content item in the browsing window. Alternatively or additionally, the content item presenting module may be configured to invoke a page framework carrying the demonstration page 2120 of the document 2112, construct a browsing window in the demonstration page 2120 of the document 2112, and present the content item in the browsing window.

In some embodiments, the apparatus 21000 further includes a browsing window closing module configured to close the browsing window in response to detecting a closing indication for the browsing window. In some embodiments, the browsing window module is configured to remove presentation of the first content page from the browsing window in response to detecting a page turning indication with the first content page of the content item being presented in the browsing window; and present a second content page of the content item in the browsing window. Additionally or additionally, in some embodiments, the browsing window module further includes a scrollbar control. In this example, the browsing window module is further configured to scroll to present the content item in response to detecting a scroll operation for the scrollbar control.

In some embodiments, the view 2124 belongs to one of: a first view presenting first information associated with the content item, the first view occupying a first area in document 2112; a second view presenting second information associated with the content item, the second view occupying a second area in document 2112 that exceeds the first area; a third view presenting third information associated with the content item, the third view occupying a third area in document 2112 that exceeds the second area. In some embodiments, the view 2124 may include a third view, and the content item presenting module is configured to present the content item at a position of the third view in the demonstration page 2120. In some embodiments, the inserted content item includes playable multimedia content, such as an audio or a video, and the like. In such embodiments, the content item presenting module is configured to play the multimedia content.

In some embodiments, the apparatus 21000 further includes a view switch indication detection module configured to detect a view switch indication for the content item in the edit page of the document 2112. The view switch indication is used to indicate switching of the view 2124 to a further view. The apparatus 21000 further includes a view switching module configured to switch the view to a further view in the document 2112 in response to detecting the view switch indication.

In some embodiments, the apparatus 21000 further includes a view editing indication detection module configured to detect a view editing indication for the content item in an edit page of the document 2112. This view editing indication is used to indicate a modification to the layout of view 2124. The apparatus 21000 further includes a view layout modification module configured to modify the layout of the view 2124 based on the view editing indication.

In some embodiments, the apparatus 21000 further includes an instruction receiving module configured to receive, in the demonstration page 2120 of the document 2112, a presentation instruction for editing the content input in the page, and reject receiving the editing instruction for the content.

In some embodiments, the apparatus 21000 further includes a page jumping module configured to jump to a page other than the edit page to display the content item in response to a trigger for the view of the content item in the edit page of the document 2112.

Generally, demonstrators may demonstrate documents to viewers through a meeting interface in an online meeting, or perhaps through a demonstration device in a live meeting. In this conventional document demonstration manner, the viewers can only passively view the content of the document that is controlled and presented by the demonstrators during demonstration. In or after the demonstration, the viewers cannot perform interaction with the document. It is desirable to provide more flexible interaction with the demonstrated documents.

According to embodiments of the present disclosure, a solution of document interaction is provided to support interaction during the document demonstration. According to this solution, when a document is demonstrated, access path information of the document is presented, so that a further terminal device can access the document based on the access path information. After accessing the document, the further terminal device presents a demonstration view of the document in a demonstration mode. According to the solution, the flexible access and interaction capability of the users and the demonstrated document in the demonstration mode is enhanced, and the user experience is improved.

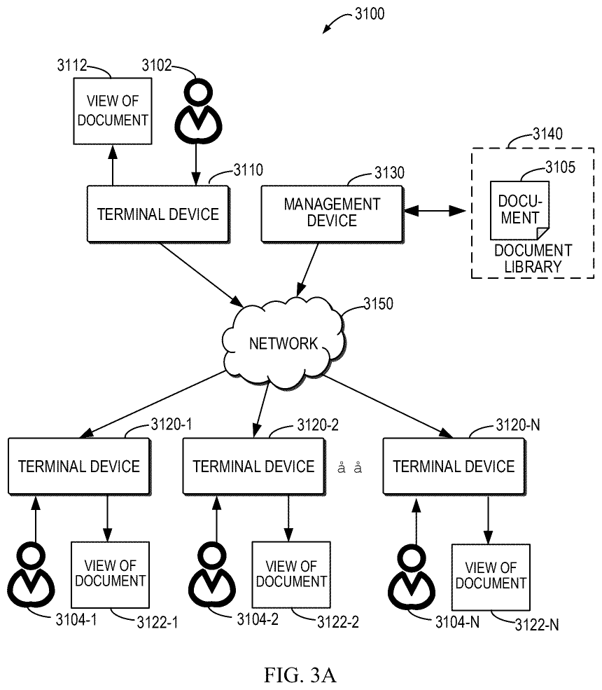

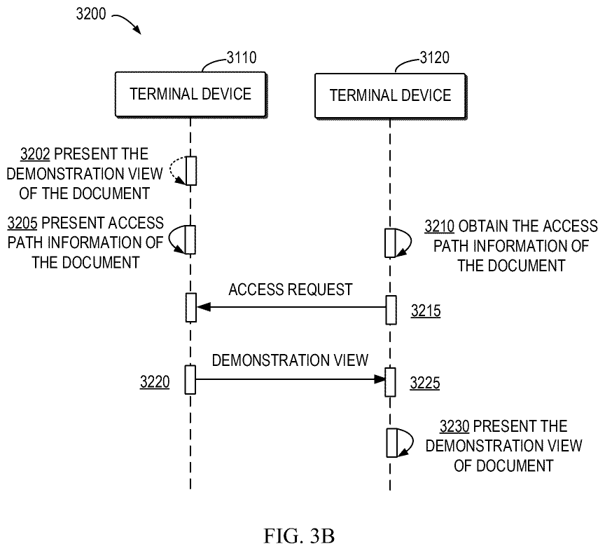

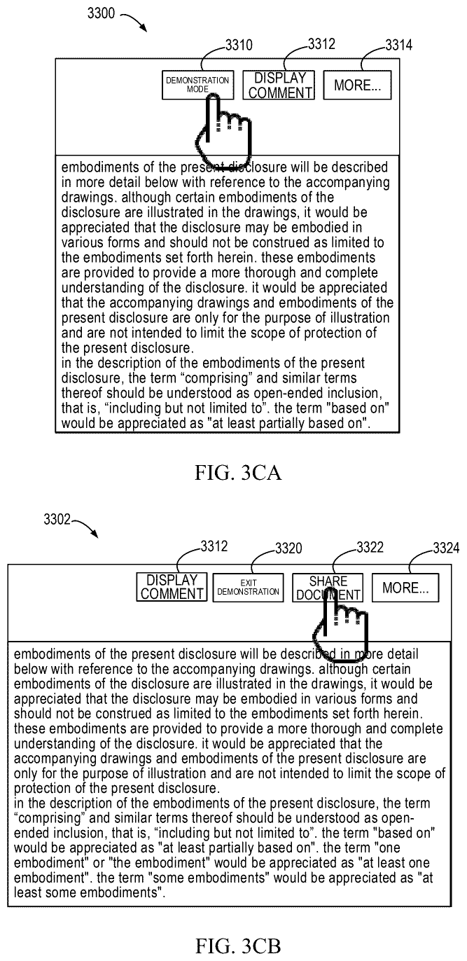

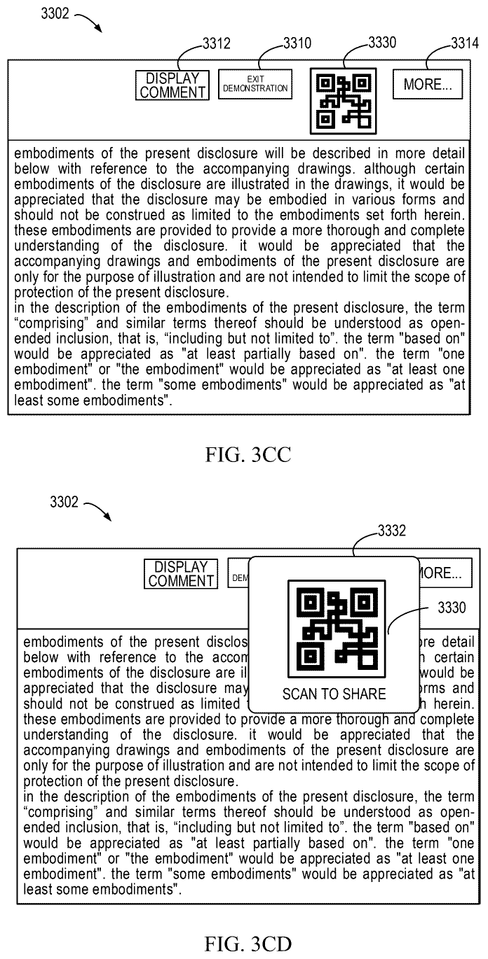

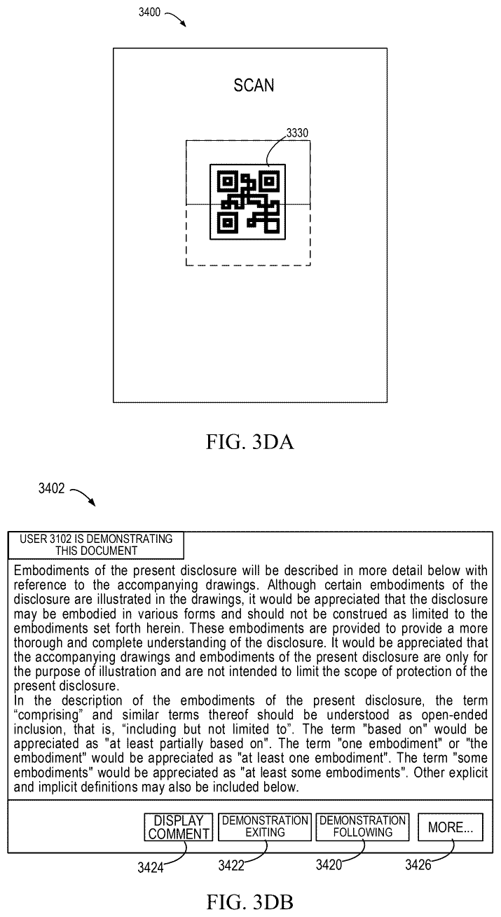

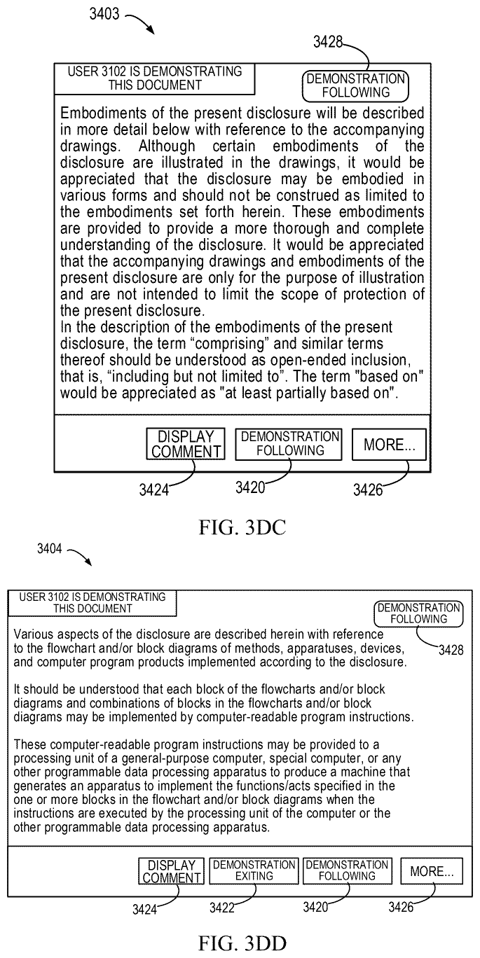

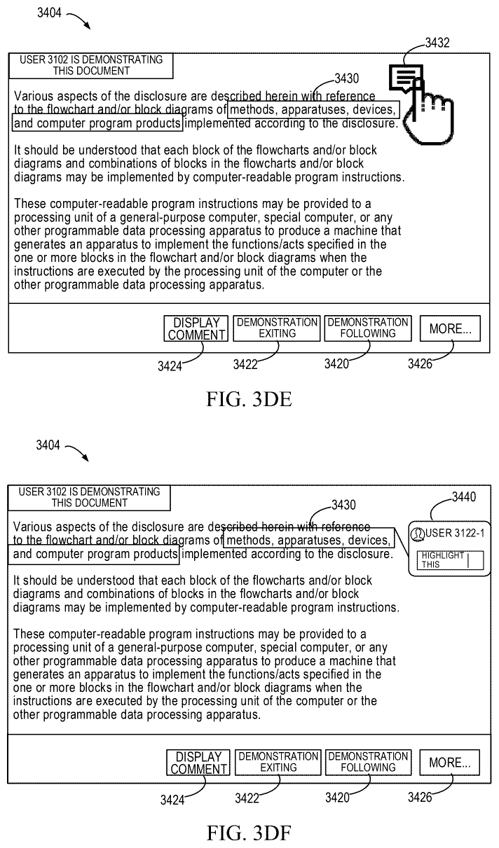

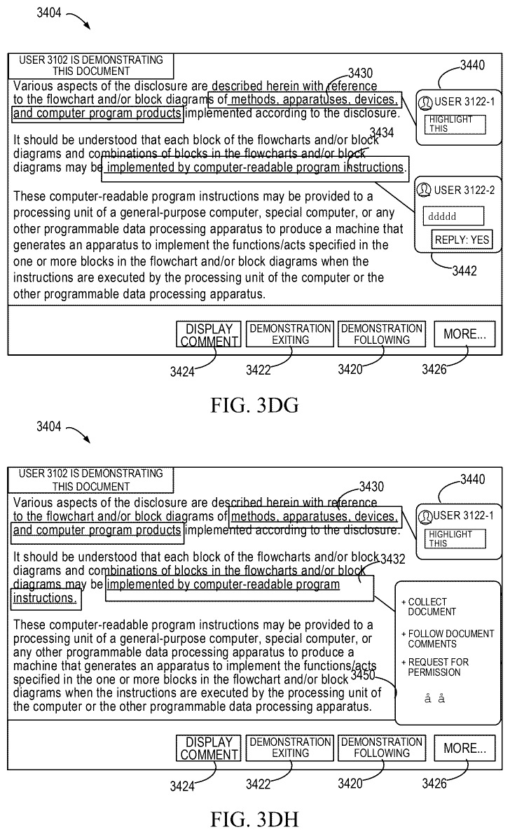

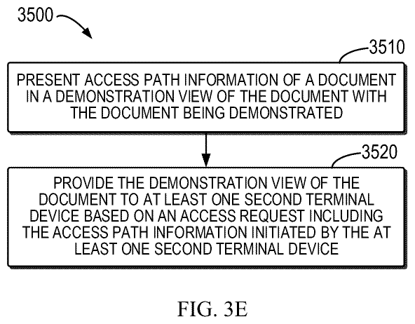

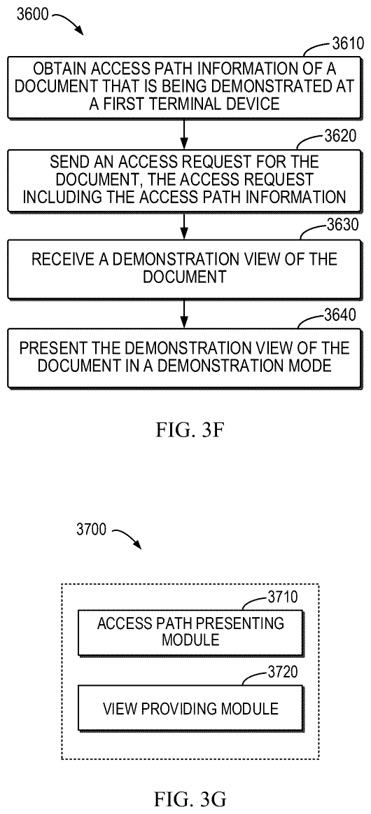

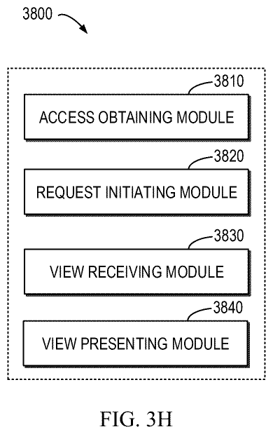

FIG. 3A illustrates a schematic diagram of an example environment 3100 in which embodiments of the present disclosure can be implemented. In this example environment 3100, the terminal device 3110 is a device for document demonstration. For example, a user 3102 may present a view 3112 of a document 3105 by operating the terminal device 3110.

The document 3105 may be of any suitable document format for demonstration, such as a text document (e.g., a word document), a demonstration document (e.g., a PPT document), a PDF document, etc. In the example of FIG. 3A, the document 3105 may be an online document, for example, may be stored in an online document library 3140. A management device 3130 may be used to manage and maintain online documents. The terminal device 3110 may have management rights to the document 3105, including various rights such as access, editing, co-authoring, and sharing. For example, the terminal device 3110 is installed with a corresponding application, and a login user (for example, the user 3102) of the application may be assigned with management rights to the document 3105. The terminal device 3110 may communicate with the management device 3130 and the document library 3140 through the network 3150.

In the environment 3100, there are also terminal devices 3120-1, 3120-1, . . . 3120-N (collectively referred to as terminal devices 3120 or individually referred to as terminal device 3120 for ease of discussion, where N is an integer greater than or equal to 1). These terminal devices 3120 may be operated by users 3104-1, 3104-2, . . . 3104-N, respectively (collectively referred to as users 3104 or individually referred to as user 3104 for ease of discussion). The terminal device 3120 may alternatively communicate with the terminal device 3110 and/or the management device 3130 by using the network 3150.

In embodiments of the present disclosure, the terminal device 3120 can access the document 3105 with the permission of the terminal device 3110. For example, terminal devices 3120-1, 3120-2, . . . 3120-N may present views 3122-1, 3122-2, . . . 3122-N of document 3105, respectively (collectively referred to as views 3122 or individually referred to as view 3122 for ease of discussion). In some embodiments, the terminal device 3120 may also be installed with a corresponding application, and a login user (for example, the user 3104) of the application may have interaction permission for the document 3105 when allowed.

In some example scenarios, the user 3102 may operate the terminal device 3110 in a live meeting to demonstrate the document 3105, or may demonstrate the document 3105 in an online meeting with one or more users 3104.

In this specification, for distinguishing purposes, the terminal device 3110 is sometimes referred to as a “first terminal device”, and the terminal device 3120 is referred to as a “second terminal device”. It should be understood that although the terminal device 3110 is shown in FIG. 3A as being used to present the document 3105, any terminal device may be used to implement document demonstration according to application requirements.

In FIG. 3A, the terminal device 3110 or 3120 may be any type of mobile terminal, fixed terminal or portable terminal, including a mobile handset, desktop computer, laptop computer, notebook computer, netbook computer, tablet computer, media computer, multimedia tablet, personal communication system (PCS) device, personal navigation device, personal digital assistant (PDA), audio/video player, digital camera/camcorder, positioning device, television receiver, radio broadcast receiver, electronic book device, gaming device, or any combination thereof, including accessories and peripherals of these devices, or any combination thereof. In some embodiments, the terminal device 3110 can also support any type of interface for a user (such as a “wearable” circuit). The management device 3130 may be any type of computing system/server capable of providing computing capabilities, including but not limited to a mainframe, an edge computing node, a computing device in a cloud environment, and the like.

It should be understood that the architecture of the environment 3100 and the functionality of the devices therein are described for exemplary purposes only and do not imply any limitation on the scope of the present disclosure. For example, the terminal device 3110 may not communicate with the remote management device 3130.

Some example embodiments of the present disclosure will be described below with continued reference to the accompanying drawings.

FIG. 3B illustrates a flowchart of a signaling flow 3200 for document interaction according to some embodiments of the present disclosure. The signaling flow 3200 is implemented at the terminal device 3110 and terminal device 3120. For ease of discussion, the signaling flow 3200 will be described with reference to the environment 3100 of FIG. 3A, with the assumption that the terminal device 3110 is the device for document demonstration and the terminal device 3120 is the device accessing the demonstrated document. In FIG. 3B, although only a single terminal device 3120 is shown, it may be understood that a plurality of terminal devices 3120 may perform similar signaling interaction with the terminal device 3110.

In signaling flow 3200, the terminal device 3110 presents (3205) access path information of the document 3105 in a demonstration view of the document with the document 3105 being presented. In some embodiments, the terminal device 3110 may present (3202) the demonstration view 3112 of the document 3105 in the demonstration mode of the document 3105, and determine whether to present the access path information in the demonstration view 3112.

The demonstration view of the document refers to an organization or layout of at least part of the content of the document in the demonstration mode. A page view of the document refers to an organization or layout of at least part of the content of the document in a non-demonstration mode. In some embodiments, operations such as content editing and setting may be performed on the document in the page view. Page views are sometimes referred to as normal views or non-demonstration views.

In embodiments of the present disclosure, in order to enable other users to more conveniently obtain flexible reading and interaction capabilities of the document 3105 while the document 3105 is being presented, access path information of the document 3105 is presented in the demonstration view 3112 of the document 3105.

The document 3105 may be accessed through the access path information. The document 3105 may be an online document and have a corresponding access path. The access path information may be in any suitable form, for example, may be a QR code, an access link, and other information that can be used to access a document.

In some embodiments, the terminal device 3110 may determine to present the access path information of the document 3105 based on a user request. Specifically, the terminal device 3110 may detect a demonstrating and sharing indication for the document 3105, which indicates sharing of the document 3105 during demonstration. If such an indication is detected, the terminal device 3110 will present the access path information for document 3105 when document 3105 is being demonstrated. In some embodiments, the demonstrating and sharing indication may be triggered, e.g., by user 3102, before the document 3105 enters the demonstration mode. Additionally or alternatively, the demonstrating and sharing indication may also be triggered when the document 3105 is in the demonstration mode. In some embodiments, alternatively, the access path information of the document may be presented in the demonstration view of the document 3105 automatically or by default.

For better understanding, the following description will be given with reference to examples. FIGS. 3CA to 3CD illustrate example pages of the document 3105 presented at the terminal device 3110 according to some embodiments of the present disclosure. It should be understood that the pages in FIGS. 3CA to 3CD and other figures to be described below are merely example pages, and there may actually be various page designs. Individual elements in a page may have different arrangements and different visual representations, one or more of which may be omitted or replaced, and one or more other elements may also be present. The embodiments of the present disclosure are not limited in this regard.

FIG. 3CA shows a page view 3300 of the document 3105, where the document 3105 has not entered the demonstration mode. As an example, document content is presented in the page view 3300. In addition, some available functions may be presented, including a demonstration mode function 3310 for triggering entry into a demonstration mode; a comment displaying function 3312 for displaying some comment information of the document 3105, if any; and a “more” option 3314 for displaying more available functions, if any.

If the demonstration mode function 3310 is triggered, e.g., selected by the user, the terminal device 3110 may determine that the document 3105 enters the demonstration mode and present a demonstration view 3302 as shown in FIG. 3CB. The terminal device 3110 may control the demonstration progress of the document 3105 under the operation of the user 3102 to present content in different positions or regions of the document 3102. As an example, some functions that may be triggered in the demonstration mode may also be presented in the demonstration view 3302. As shown, a demonstration exiting function 3320 may be presented for a trigger of exiting the demonstration mode of the document 3105; a document sharing function 3322 may be presented for a trigger of the demonstrating and sharing indication; and a “more” option 3324 for displaying more available functions, if any, in the demonstration mode.

If the demonstration mode function 3310 is triggered, for example, selected by a user, the terminal device 3110 may detect the demonstrating and sharing indication. The triggering manner of the demonstration mode function 3310 may include, for example, an input device (for example, a mouse) click, a touch gesture, a mouse hovering at a position where the function is located, or the like. Access path information 3330 for the document 3102 is presented in the demonstration view 3302, as shown in FIG. 3CC. In the example of FIG. 3CC, the access path information 3300 is shown in the form of a QR code, although other forms of access path information may also be applicable. In some embodiments, it may be further allowed to enlarge the access path information based on the user selection for better presentation. As shown in FIG. 3CD, the enlarged access path information 3330 may be presented in a pop-up window 3332.

It should be understood that although the demonstrating and sharing indication is triggered in the demonstration mode as shown in FIG. 3CB, the users may also be allowed to configure before entry to the demonstration mode or automatically determine that the access path information of document is to be presented during demonstration.

Referring back to FIG. 3B, when the access path information of the document 3105 is presented by the terminal device 3110, the terminal device 3120 obtains (3210) the access path information of the document 3105. The terminal device 3120 can access the document 3105 based on the access path information. The terminal device 3120 performing access may be any device capable of obtaining the access path information of the document 3105.

Because the access path information is presented by the terminal device 3110, the terminal device 3120 may obtain the access path information in various manners. For example, the terminal device 3120 may scan a QR code or receive an access link based on an operation of the user 3104, and then access the document 3105. In some embodiments, the terminal device 3120 may access the online document 3105 through the management device 3130. For example, the terminal device 3120 may be installed with an application capable of accessing the online document 3105, and access the document 3105 through the application.

Specifically, the terminal device 3120 initiates (3215) an access request including the obtained access path information. The access request may be directly sent to the terminal device 3110, or may be sent to the management device 3130 of the document 3105, so that the terminal device 3120 obtains a capability of accessing the document 3105, depending on a specific management manner of the document 3105. Based on the access request initiated by terminal device 3120, terminal device 3110 provides (3220) the demonstration view of document 3105 to the terminal device 3120. The demonstration view of the document may be based on the demonstration progress of the document 3105 at the terminal device 3110. The demonstration view may be sent directly to the terminal device 3120 or sent to the terminal device 3120 via the management device 3130, depending on the specific management manner of the document 3105. The terminal device 3120 receives (3225) the demonstration view of document 3105 and presents (3230) the demonstration view of document 3105 in the demonstration mode.

After the demonstration view of the document 3105 is obtained, one or more interaction operations on the document 3105 may be performed at the terminal device 3120. The terminal device 3120 may perform corresponding processing based on the received interaction operation. In some embodiments, when the document 3105 is demonstrated, if the terminal device 3120 obtains the access path information and accesses the document 3105, the terminal device 3120 may be provided with various interaction capabilities supported by the document 3105 and/or allowed by a manager (e.g., the user 3102) of the document 3105. Such interaction capabilities may include, but are not limited to, demonstration following capability, free browsing capability, comment capability, comment browsing capability, special identifying capability for the document, and so on.

For better understanding, the following description will be given with reference to examples of the accompanying drawings. FIGS. 3DA to 3DH illustrate example pages presented at the terminal device 3120 according to some embodiments of the present disclosure. In FIG. 3DA, it is assumed that the terminal device 3120 scans the access path information 3330 in the form of a QR code to obtain the access to the document 3105.

Upon obtaining the access to document 3105, terminal device 3120 may present a demonstration view of document 3105, which may contain content corresponding to the content in the demonstration view of document 3105 being demonstrated at the terminal device 3110.

As shown in FIG. 3DB, after accessing the document 3105, the terminal device 3120 may present a demonstration view 3402 of the document 3105 in a demonstration mode. Initially, the demonstration view 3402 presented at the terminal device 3120 may be synchronized with the demonstration view 3302 presented at the terminal device 3110.

In some embodiments, in the demonstration mode, free browsing of the document 3105 is not supported at the terminal device 3120. That is, in the demonstration mode, the terminal device 3120 presents the demonstration view of the document 3105 according to the demonstration progress of the document 3105 at the terminal device 3110. The content presented at the terminal device 3120 varies with the presentation operation of a demonstrator (e.g., user 3102) at the terminal device 3110.

In some embodiments, at the terminal device 3120, users may be supported to exit the demonstration mode and switch to a further view, for example, a page view, by using some predetermined interaction indications. The demonstration exiting indication may include one or more indications. As an example, a specific control, for example a demonstration exiting control, a view switch control, or a page view launching control, may be provided and a trigger for the control may initiate the demonstration exiting indication so as to exit the demonstration mode. Additionally or alternatively, certain gesture operations, mouse operations, or other interaction operations may also be set for triggering the demonstration exiting indication. For example, if an up-and-down sliding gesture or an up-and-down sliding of the mouse is detected, it may be determined that the demonstration exiting indication is initiated and then the demonstration mode is exited.

In some embodiments, after exit of the demonstration mode, the document 3105 may be presented in a page view. Free browsing of the document 3105 by the user may be supported in the page view. Thus, the terminal device 3120 will detect the browsing progress of the document 3105 and present the page view of the document based on the detected browsing progress.

In some embodiments, after exiting the demonstration mode of the document 3105 at the terminal device 3120, the user may be allowed to continue to switch back to the demonstration mode. The terminal device 3120 may detect a demonstration following indication and enter the demonstration mode after detecting the indication. In the demonstration mode, the demonstration view of the document 3105 continues to be presented according to the current demonstration progress of the document 3105 at the terminal device 3110. The demonstration following indication may include one or more indications. As an example, a particular control, such as a demonstration following control, may be provided and a trigger for the control may initiate the demonstration following indication. In other examples, the demonstration following indication may also be initiated by a specific gesture operation or other operation.

The following description is continued with reference to the accompanying drawings. In some embodiments, some functions that may be triggered by the terminal device 3120 when accessing the document 3105 may also be included in the demonstration view of the document 3105 presented at the terminal device 3120. As shown in FIG. 3DB, a demonstration view 3402 may include a demonstration following control 3420 for synchronizing the demonstration progress to the demonstration progress at the terminal device 3110 to synchronize document content presented at the terminal device 3120 to the document content being presented at the terminal device 3110, and a demonstration exiting control 3422 for exiting the demonstration mode to allow users to freely browse content of document 3105 without the content being synchronized to the demonstration progress at the terminal device 3110. In addition, the demonstration view 3402 may further include a comment displaying control 3424 for displaying comment information existing in the document 3105 (if any); and a “more” option 3426 for displaying more available controls (if any). It should be understood that although multiple functions are shown in the figures, one or more of these functions may be omitted, or more other functions may be included.

In some embodiments, after the terminal device 3120 accesses the document 3105, the demonstration view presented at the terminal device 3120 may be first synchronized to the demonstration progress at the terminal device 3110 by default. That is, the content currently being demonstrated by the host or the sharer (e.g., the user 3102) is presented. If free browsing of the document 3105 is not supported in the demonstration mode but the user of the terminal device 3120 expects to browse other content of the document 3105, the user may interact with the document 3105 to trigger a demonstration exiting indication for the document 3105, such as triggering the demonstration exiting control 3422 of FIG. 3DB.

If demonstration exiting mode is detected, the demonstration mode may be exited and a page view of document 3105 is presented. In the page view, the terminal device 3120 may present the browse page of the document 3105 independent of the demonstration progress of the document 3105 at the terminal device 3110. For example, the terminal device 3120 may determine a browsing progress of the document 3105 based on browsing positioning of the user 3104 for the document 3105, such as browsing positioning indicated by a mouse or a trigger gesture, and determine content to be presented in the page view based on the browsing progress. For example, if a trigger for the demonstration exiting control 3422 is detected in FIG. 3DB, the page view 3403 shown in FIG. 3DC is presented, and the content of other parts of the document continues to be presented according to the user browsing operation.

If the user 3104 expects to continue following the demonstration progress of the document 3105, the user is also allowed to trigger an interaction operation corresponding to the demonstration following indication for the document 3105, such as a trigger for the demonstration following control 3420 in FIG. 3DC. If a demonstration following operation is detected, the document 3105 may enter the demonstration mode. The terminal device 3120 may present a demonstration view of document 3105 based on the current demonstration progress of document 3105 at the terminal device 3110. As such, the demonstration view presented at the terminal device 3120 is synchronized to the content being presented at the terminal device 3110. In some embodiments, the terminal device 3120 may receive demonstration positioning information for the document 3105 from the terminal device 3110 or from the management device 3130 to determine a position in the document 3105 that is being demonstrated.

Note that although a demonstration exiting control and a demonstration following control are shown, in other embodiments, the user may also be allowed to trigger the demonstration exiting indication or the demonstration following indication in other ways. For example, the user may be allowed to indicate browsing other content in the document 3105 than the demonstrated content by means of an input device or a swipe gesture. Alternatively, other icons may be set for indicating following the demonstration of the sharer. The embodiments of the present disclosure are not limited in this regard.

In some embodiments, in the demonstration mode, free browsing of the document 3105 by the user is also supported at the terminal device 3120. In this case, the browsing displays demonstration views corresponding to different browsing progress. Specifically, in the demonstration mode, the terminal device 3120 may detect a browsing progress of the document at the second terminal device, and present a demonstration view of the document based on the detected browsing progress. For example, based on the demonstration view 3402 of FIG. 3DB, if the user continues to browse (for example, based on a document browsing operation such as a scrolling mouse or a sliding gesture), the terminal device 3120 may present the demonstration view 3404 of FIG. 3DD based on the detected browsing progress. Content in the demonstration view 3404 may and may not be different from content being demonstrated at the terminal device 3110. In this way, flexible control of the content to be demonstrated at the terminal device 3120 may be supported.

In some embodiments, when browsing freely in the demonstration mode, the user may also be allowed to reposition to the demonstration progress of the document 3105 at the terminal device 3110. The current demonstration progress may be positioned to based on initiating of a demonstration positioning indication. The demonstration positioning indication may include one or more indications. If a demonstration positioning indication is detected, terminal device 3120 may present a demonstration view of the document according to the demonstration progress of document 3105 at the terminal device 3110. As an example, a particular control, such as a demonstration following control, may be provided and a trigger for the control may initiate the demonstration positioning indication. As shown in FIG. 3DD, a demonstration following control 3428 may be provided in the demonstration view 3404, and a current demonstration progress of the document 3105 at the terminal device 3110 may be positioned to based on a trigger for the demonstration following control 3428. In other examples, the demonstration positioning indication may also be initiated by a specific gesture operation or other operation.

In some embodiments, if the demonstration mode is exited and a page view of the document 3105 is presented, in the page view, free browsing of the document by the user may be supported, and tracking and positioning of demonstration progress may also be supported. For example, while presenting the page view, the current demonstration progress may be positioned to based on initiating of the presentation position indication. If a demonstration positioning indication is detected, the terminal device 3120 may present a page view of the document 3110 according to the demonstration progress of document 3105 at the terminal device 3110.

For example, in the document view 3403 of FIG. 3DC, the demonstration following control 3428 may also be provided for positioning the document to the demonstration progress of the document 3105 at the terminal device 3110. After the corresponding demonstration progress is positioned, the document content at the corresponding progress is presented in a document view.

In some embodiments, during interaction with the document 3105, a comment function of the terminal device 3120 accessing the document 3105 on the document 3105 is specifically supported to receive comment information input by a user for one or more segments of the document 3105.

Specifically, if the received interaction operation includes comment information for one or more segments of the document 3105, the terminal device 3120 provides 3225 the comment information to the terminal device 3110.

In some embodiments, the terminal device 3120 may send the received comment information to the management device 3130, and the management device 3130 synchronizes the comment information to the terminal device 3110. In some embodiments, the terminal device 3120 may directly send the received comment information to the terminal device 3110.

In some embodiments, the user may be allowed to comment on a segment of any size in the document 3105. Such segment may include, for example, a single word, a single term, multiple words/terms, a paragraph, a picture, a table, or the like. In some embodiments, the terminal device 3120 may receive a user selection of a segment in the document 3105, and provide an input box for inputting a comment in response to detecting a comment indication. In some embodiments, the comment information may include new comment content for a segment of the document 3105, or may include feedback or a reply to a comment existing in the document 3105. In some embodiments, comment information may be allowed to be entered in a demonstration view and/or a page view of the document 3105.

The comment interaction on the document 3105 at the terminal device 3120 will be described below with reference to the examples of FIGS. 3DE to 3DG. For discussion purposes only, comment interactions are discussed in connection with examples of demonstration views. In some embodiments, similar comment interactions may be provided in the page view.

As shown in FIG. 3DE, the terminal device 3120 may detect a user selection of the segment 3430 in the browse page 3404 and present the comment control 3432 accordingly. If the user 3104 triggers the comment control 3432, the terminal device 3120 may present the comment box 3440 shown in FIG. 3DF in the browse page 3404, where the user 3104 may input comment information.

In some examples, if the document 3105 further includes other comment information, the terminal device 3120 may further present the comment information in response to a trigger of the user 3104. For example, as shown in FIG. 3DG, if the comment displaying control 3424 is triggered, the terminal device 3120 may present a previously input comment box 3440 along with a further comment box 3442. The comment box 3442 includes comment information for the segment 3434 in the browse page 3404. In some embodiments, the terminal device 3120 may further detect a reply of the user 3112 to the comment information, for example, a reply in the comment box 3442.

The terminal device 3120 may detect comment information input by the user, including a new comment or a reply to a comment, and provide the comment information to the terminal device 3110, so that comments on the document 3105 are synchronized between devices.

Compared to traditional demonstration, in the embodiments of the present disclosure, capabilities of rich interactions for the document are supported in the demonstration mode of the document, so that users can browse and interact with the document as needed.

In some embodiments, at the terminal device 3110 side, after obtaining the comment information, the terminal device 3110 associates the comment information with one or more corresponding segments of the document 3105. In this way, a demonstrator (for example, the user 3102) of the document can have an opportunity to know whether the viewer (for example, the user 3104) has any question or opinion on the demonstrated document, thereby improving the interaction experience.

In some embodiments, the terminal device 3110 may obtain comment information of the user 3104 on one or more segments of the document 3105 from the management device 3130, or may obtain such comment information directly from the terminal device 3120. In some embodiments, if multiple terminal devices 3120 comment on the document 3105, the terminal device 3110 may also obtain comment information provided by the multiple terminal devices 3120. In some embodiments, the terminal device 3120 may also obtain comment information of other terminal devices 3120 on the document 3105. Such comment information synchronization may be coordinated, for example, by the management device 3130 or the terminal device 3110.

In some embodiments, in order to avoid disturbing a demonstrator, such as the user 3102, if the terminal device 3110 receives the comment information while the document 3105 is being demonstrated, presentation of a hint about the comment information may be deferred. For example, a notification that new comment information arrives or presentation of the comment information itself is deferred.

In some embodiments, comment information received during demonstration of the document 3105 may also be presented according to the needs of the demonstrator. For example, the terminal device 3110 may detect a presentation permission indication for comment information. If such a presentation permission indication is detected, the terminal device 3110 may present the received comment information in the demonstration view of the document. For example, if the user 3102 expects to maintain interaction with the viewer during the demonstration, or expects to centrally reply to the viewer's comments after demonstrating the content of the document, the user 3102 may trigger an presentation permission indication for the comment information before the document 3105 enters the demonstration mode or during the demonstration. In some embodiments, the presentation permission indication may indicate presentation of comment information received in the demonstration process of the document 3105, so that comment information unrelated to this demonstration can be prevented from being presented. It should be understood that the hint or presentation of the comment information may be specifically configured according to actual application requirements.

In some embodiments, if the terminal device 3110 determines that the comment information is allowed to be presented in the demonstration process of the document 3105, the terminal device 3110 may also send a presentation permission indication for the comment information to the terminal device 3120. In response to such an indication, the terminal device 3120 may also present comment information received at the local end or other terminal devices 3120 in the demonstration view of the document 3105. In some embodiments, the comment information may be presented at the terminal device 3110 and/or the terminal device 3120 in barrage style. In some embodiments, the comment information may be presented in a particular area of the page, similar to the examples shown in FIGS. 3DF and 3DG.

In some embodiments, at the terminal device 3110, comment information received while the document 3105 is presented may also be allowed to be specially marked, for example, marked as being obtained when the document 3105 is demonstrated. In this way, the user can conveniently distinguish the comment information collected in this demonstration from other comment information.

In some embodiments, at the terminal device 3120, during interaction between the user 3104 and the document 3105, the user 3104 may also be allowed to perform special identification on the document 3105 to mark the document as a state desired by the user. Specifically, if the terminal device 3120 receives the interaction operation corresponding to the special identification request for the document 3105, the terminal device 3120 may further mark the document 3104 as a state corresponding to the special identification request. The special identification request may, for example, request identification of the document 3105 as a favorite state, a like state, a follow state (e.g., following document comments), or any other allowable identification. As shown in FIG. 3DH, after the update option 3426 is triggered, the terminal device 3120 may present more functions allowed to be performed on the document 3105, including “favorite document”, “follow document comment”, and the like.

By specifically identifying the document, the user 3104 may also continue to obtain information about the document 3105 after the demonstration ends. In some embodiments, the terminal device 3120 may further automatically store an access record about the document 3105 to record at least the access path information of the document 3105. As such, the user 3104 may still be able to continue accessing document 3105 as needed after the demonstration ends.

In some embodiments, the storage of the identification or access record for the document 3105 may be based on an administrator of the document 3105, such as a permission configuration of the user 3102. For example, the user 3102 may configure whether to allow the terminal device accessing the document 3105 to favorite the document, follow comments of the document, subsequently access the document again, and so on when the document is demonstrated. In this way, the administrator of the document can more flexibly control various interaction permissions of the document.

FIG. 3E illustrates a flowchart of a process 3500 for document interaction according to some embodiments of the present disclosure. The process 3500 may be implemented at the terminal device 3110.

In block 3510, the terminal device 3110 presents access path information of the document in a demonstration view of the document with the document being demonstrated. At block 3520, the terminal device 3110 provides the demonstration view of the document to at least one second terminal device based on an access request including access path information initiated by the at least one second terminal device (e.g., the at least one terminal device 3120).

In some embodiments, the process 3500 further includes: obtaining comment information for at least one segment of the document from the at least one second terminal device; and associating the comment information to the at least one segment of the document.

In some embodiments, presenting the access path information of the document includes: detecting a demonstrating and sharing indication for the document; and presenting the access path information of the document in response to detecting the demonstrating and sharing indication.

In some embodiments, the process 3500 further includes: if the comment information is received with the document being demonstrated, deferring presenting a hint regarding the comment information.

In some embodiments, the process 3500 further includes: detecting an presentation permission indication for the comment information; and in response to detecting the presentation permission indication, presenting the comment information in the demonstration view of the document.

In some embodiments, the process 3500 further includes: providing a presentation permission indication to the at least one second terminal device, so that the comment information is presented at the at least one second terminal device.

In some embodiments, associating the comment information with the at least one segment of the document includes: if the comment information is received with the document being demonstrated, marking the comment information as indicating that the comment information was obtained while the document is being demonstrated.

FIG. 3F illustrates a flowchart of a process 3600 for document interaction according to some embodiments of the present disclosure. The process 3600 may be implemented at the terminal device 3120.

At block 3610, the terminal device 3120 obtains access path information of a document that is being demonstrated at a first terminal device (e.g., terminal device 3110). At block 3620, the terminal device 3120 sends an access request for the document, the access request including the access path information. At block 3630, the terminal device 3120 receives a demonstration view of the document. At block 3640, the terminal device 3120 presents the demonstration view of the document in a demonstration mode.

In some embodiments, presenting the demonstration view of the document includes: in the demonstration mode, presenting the demonstration view of the document according to a demonstration progress of the document at the first terminal device.

In some embodiments, the process 3600 further includes: exiting the demonstration mode if the demonstration exiting indication is detected; detecting a browsing progress of the document at the second terminal device; and presenting a page view of the document based on the detected browsing progress.

In some embodiments, the process 3600 further includes: entering the demonstration mode if a demonstration following indication is detected; and presenting a demonstration view of the document according to a demonstration progress of the document at the first terminal device.

In some embodiments, the process 3600 further includes: if a demonstration positioning indication is detected, presenting a page view of the document according to a demonstration progress of the document at the first terminal device.

In some embodiments, presenting the demonstration view of the document includes: in the demonstration mode, detecting a browsing progress of the document at the second terminal device; and presenting the demonstration view of the document based on the detected browsing progress.

In some embodiments, presenting the demonstration view of the document further includes: if the demonstration positioning indication is detected, presenting the demonstration view of the document according to a demonstration progress of the document at the first terminal device.

In some embodiments, the process 3600 further includes: receiving comment information for at least one document segment of the document; and providing the comment information to the first terminal device.

In some embodiments, the process 3600 further includes: if it is determined that the interaction operation corresponds to a free browsing indication for the document, presenting a browse page of the document independent of the demonstration progress of the document at the first terminal device; and if it is determined that the interaction operation corresponds to the demonstration following indication for the document, presenting a demonstration view of the document based on the demonstration progress of the document at the first terminal device.

In some embodiments, the process 3600 further includes: receiving a presentation permission indication for the comment information from the first terminal device; and presenting the comment information in the demonstration view of the document in response to the presentation permission indication.

In some embodiments, the process 3600 further includes: if it is determined that the interaction operation corresponds to a special identification request for the document, marking the document as a state corresponding to the special identification request.

In some embodiments, the process 3600 further includes: storing an access record about the document, the access record including at least the access path information of the document.

FIG. 3G illustrates a block diagram of a first apparatus 3700 for document interaction according to some embodiments of the present disclosure. The first apparatus 3700 may be implemented as or included in the terminal device 3110. The various modules/components in the first apparatus 3700 may be implemented by hardware, software, firmware, or any combination thereof.

As shown, the first apparatus 3700 includes an access path presenting module 3710 configured to present access path information of a document in a demonstration view of the document with the document being demonstrated. The first apparatus 3700 further includes a view providing module 3720 configured to send the demonstration view of the document to the at least one second apparatus based on an access request including the access path information initiated by the at least one second apparatus.

In some embodiments, the first apparatus 3700 further includes: a comment obtaining module configured to obtain comment information for at least one segment of the document from the at least one second apparatus; and a comment associating module configured to associate the comment information with the at least one segment of the document.

In some embodiments, the access path presenting module 3710 includes: a sharing indication detecting module configured to detect a demonstrating and sharing indication for the document; and a sharing indication-based presenting module configured to present the access path information of the document in response to detecting the demonstrating and sharing indication.

In some embodiments, the first apparatus 3700 further includes a hint deferring module configured to: defer presenting a hint about the comment information if the comment information is received with the document being demonstrated.

In some embodiments, the first apparatus 3700 further includes a presentation indication detecting module configured to: detect a presentation permission indication for the comment information; and a comment presenting module configured to present the comment information in the demonstration view of the document in response to detecting the presentation permission indication.

In some embodiments, the first apparatus 3700 further includes a presentation indication providing module configured to: provide a presentation permission indication to the at least one second apparatus, to cause the comment information to be presented at the at least one second apparatus.

In some embodiments, the comment association module includes: a comment marking module configured to, if comment information is received while the document is demonstrated, mark the comment information as indicating that the comment information is obtained with the document being demonstrated.

FIG. 3H illustrates a block diagram of a second apparatus 3800 for document interaction according to some embodiments of the present disclosure. The second apparatus 3800 may be implemented as or included in the terminal device 3120. Each module/component in the second apparatus 3800 may be implemented by hardware, software, firmware, or any combination thereof.

As shown in the figure, the second apparatus 3800 includes an access obtaining module 3810 configured to obtain access path information of a document, wherein the document is being demonstrated at the first apparatus. The second apparatus 3800 further includes a request initiating module 3820 configured to initiate an access request for the document, the access request including the access path information. The second apparatus 3800 further includes a view receiving module 3830 configured to receive a demonstration view of the document. The second apparatus 3800 further includes a view presenting module 3840 configured to present the demonstration view of the document in a demonstration mode.

In some embodiments, the view presenting module 3840 includes: a first presenting module based on the demonstration progress, configured to present a demonstration view of the document according to the demonstration progress of the document at the first apparatus in the demonstration mode.

In some embodiments, the second apparatus 3800 further includes: a demonstration exiting module configured to exit the demonstration mode if a demonstration exiting indication is detected; a browsing progress detecting module configured to detect a browsing progress of the document at the second apparatus; and a page view presenting module configured to present a page view of the document based on the detected browsing progress.

In some embodiments, the second apparatus 3800 further includes: a demonstration mode entering module configured to enter a demonstration mode if a demonstration following indication is detected; and a second presentation module based on demonstration progress, configured to present a demonstration view of the document according to the demonstration progress of the document at the first apparatus.

In some embodiments, the second apparatus 3800 further includes: a first presentation positioning module configured to present a page view of the document according to a demonstration progress of the document at the first apparatus if the demonstration positioning indication is detected.

In some embodiments, the view presenting module 3840 includes: a presentation browsing module configured to detect a browsing progress of the document at the second apparatus in a demonstration mode; and a presenting module based on the browsing progress configured to present a demonstration view of the document based on the detected browsing progress. In some embodiments, the view presenting module 3840 further includes: a first presentation positioning module configured to present a demonstration view of the document according to a demonstration progress of the document at the first apparatus if the demonstration positioning indication is detected.

In some embodiments, the second apparatus 3800 further includes: a comment receiving module configured to receive comment information for at least one document segment of the document; and a comment providing module configured to provide the comment information to the first apparatus.

In some embodiments, the second apparatus 3800 further includes a free browsing module configured to: if it is determined that the interaction operation corresponds to a free browsing indication for the document, present a browse page of the document independent of a demonstration progress of the document at the first apparatus; and a demonstration following module configured to: if it is determined that the interaction operation corresponds to a demonstration following indication for the document, present a demonstration view of the document based on the demonstration progress of the document at the first apparatus.

In some embodiments, the second apparatus 3800 further includes a presentation indication receiving module configured to: receive a presentation permission indication for the comment information from the first apparatus; and a comment presentation module configured to present the comment information in the demonstration view of the document in response to the presentation permission indication.

In some embodiments, the second apparatus 3800 further includes a document marking module configured to mark the document as a state corresponding to a special identification request if it is determined that the interaction operation corresponds to the special identification request for the document.

In some embodiments, the second apparatus 3800 further includes an access record storage module configured to store an access record about the document, the access record including at least the access path information of the document.

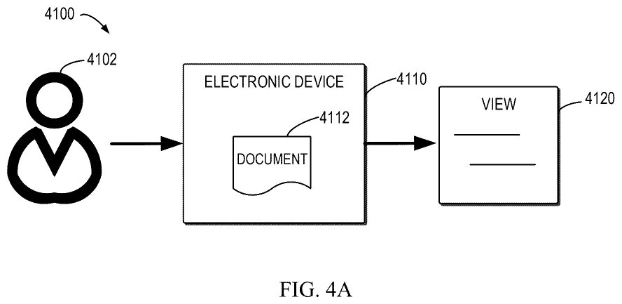

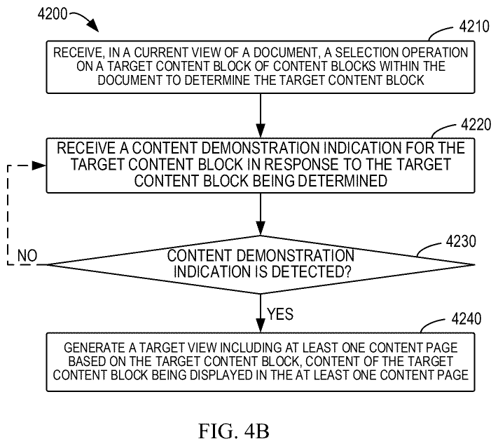

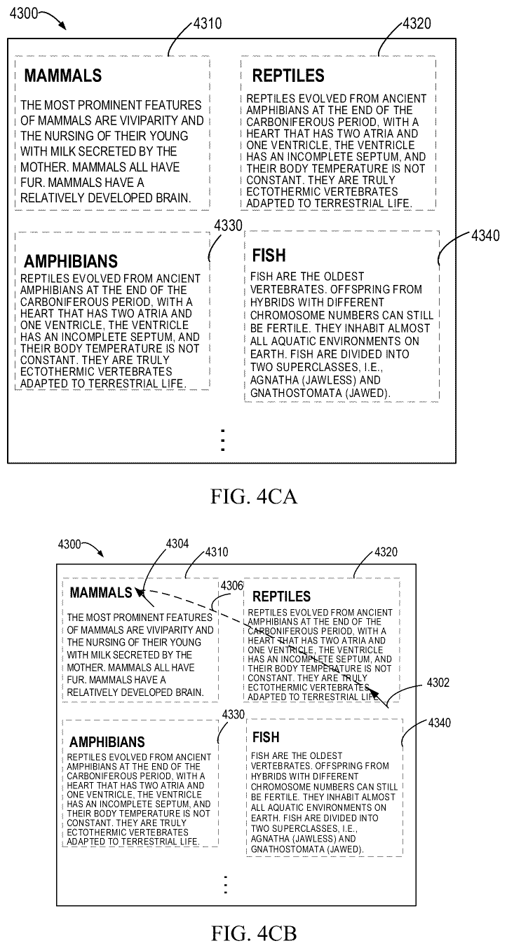

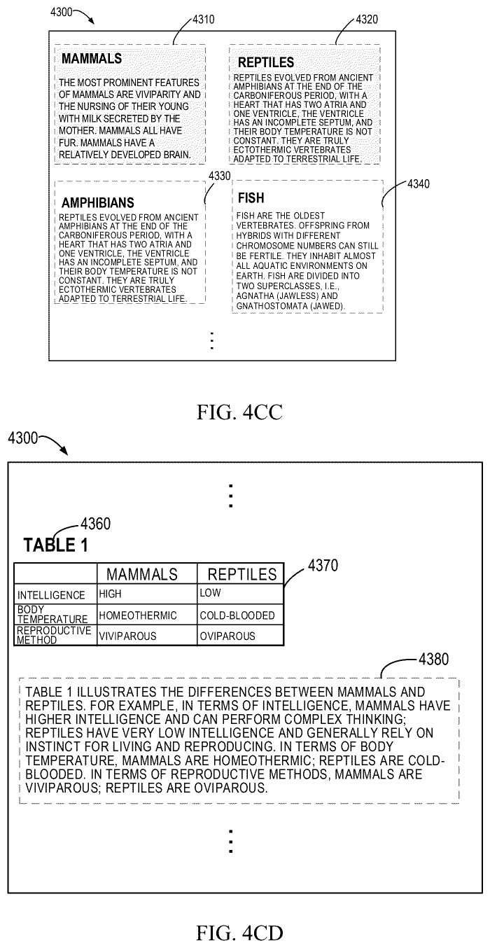

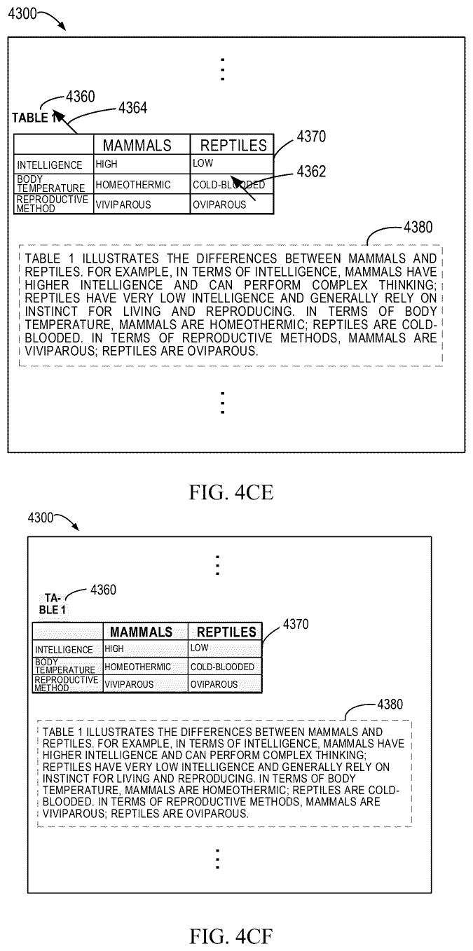

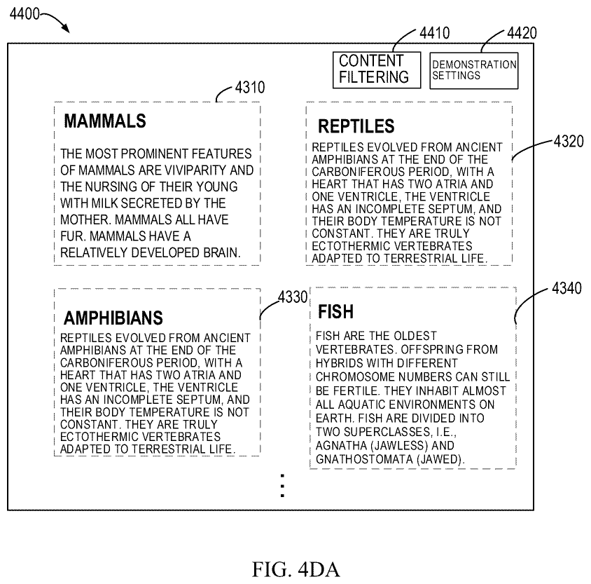

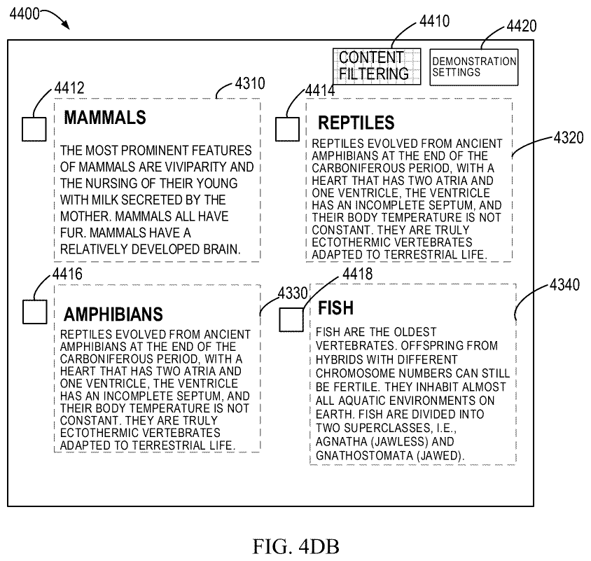

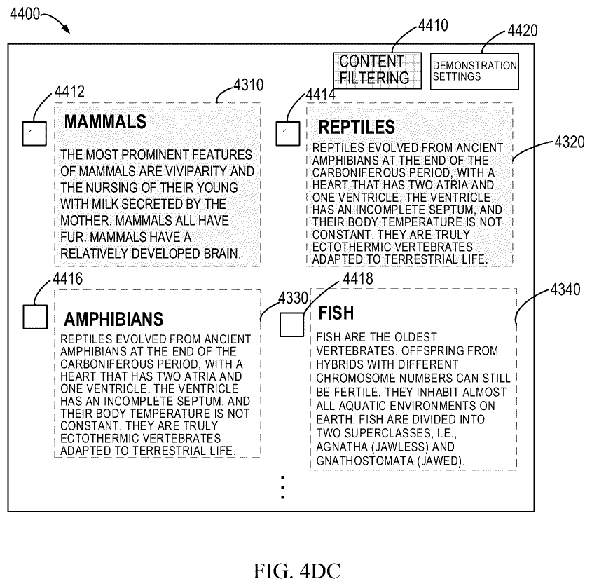

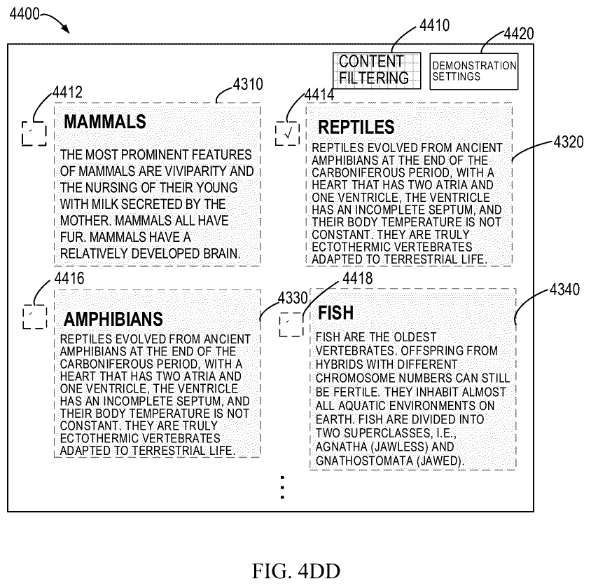

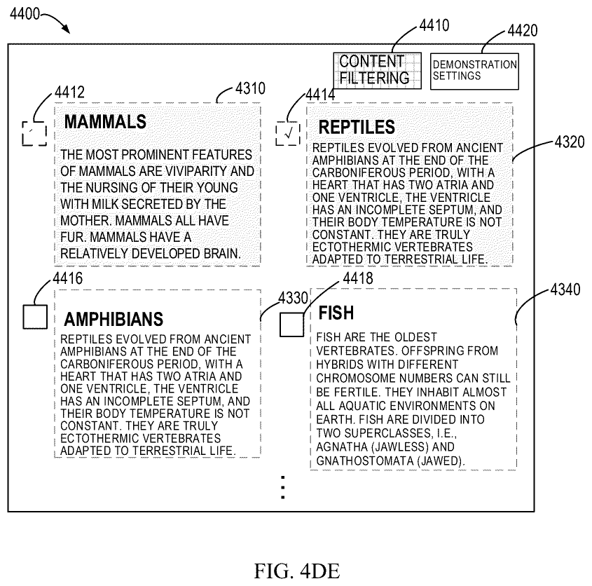

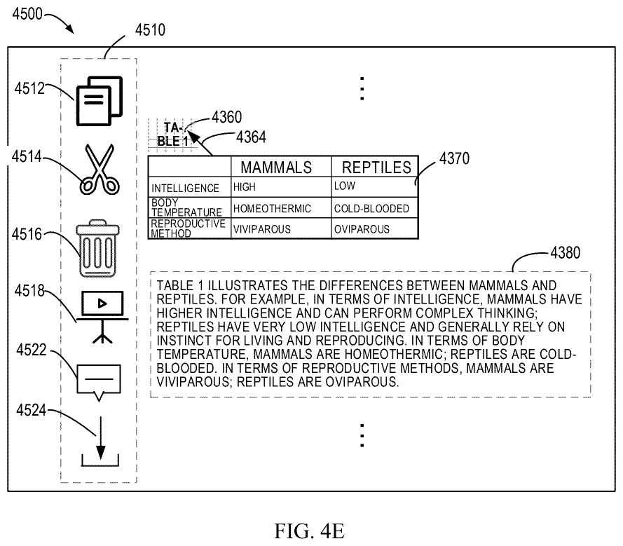

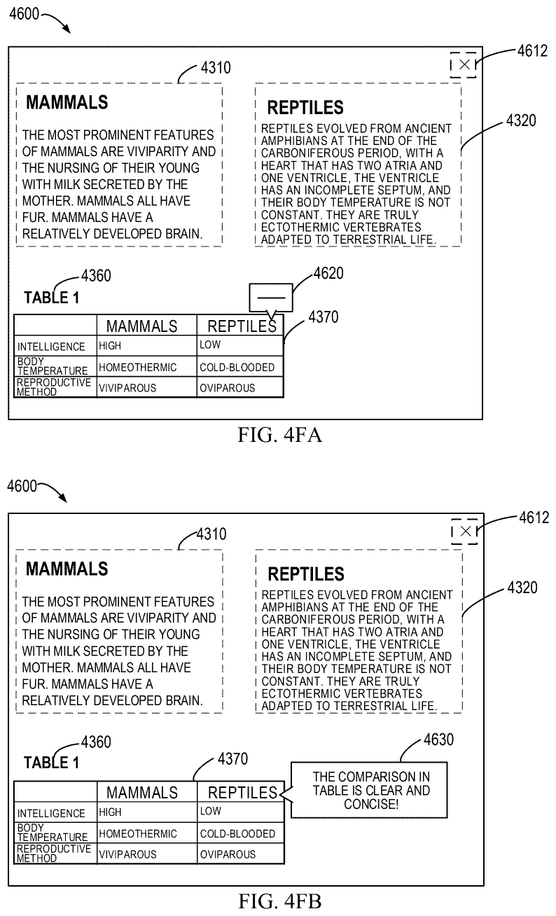

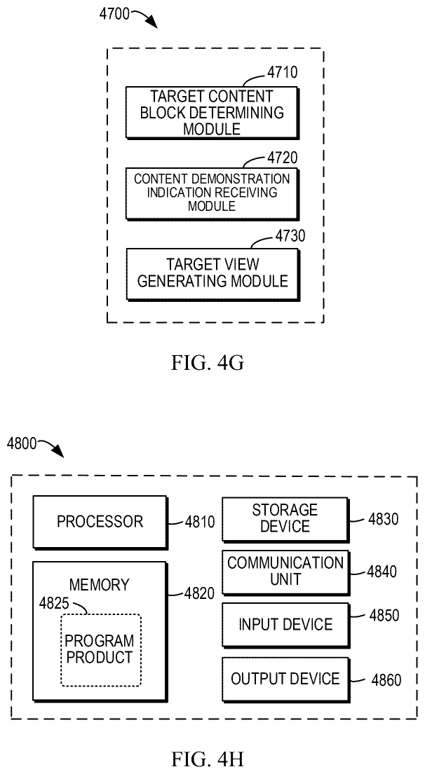

FIG. 4A illustrates a schematic diagram of an example environment 4100 in which embodiments of the present disclosure can be implemented. In this example environment 4100, an electronic device 4110 may display content of a document 4112. For example, the electronic device 4110 may present a view 4120 for the document 4112. The electronic device 4110 may present content in document 4112 in the view 4120. Herein, the document 4112 may be of any document format suitable for demonstration, such as a word document. The document 4112 may be stored in storage of the electronic device 4110, or may be stored in, for example, cloud storage in communication with the electronic device 4110.

In some embodiments, the view 4120 may be provided by, for example, a document editing application or a document demonstration application in the electronic device 4110. The view 4120 may have a display area suitable for the display area size of the electronic device 4110, or have any other suitable predetermined or user-specified display area. In some embodiments, the view 4120 may include a document view, such as an edit view of document 4112. Additionally or alternatively, view 4120 may also include a demonstration view for providing demonstration of document 4112.

In some embodiments, a user 4102 may interact with the electronic device 4110. For example, the user 4102 may perform various interaction operations on the view 4120 of the document 4112 by interacting with the electronic device 4110. Various interaction processes between the user 4102 and the electronic device 4110 will be described in detail below.

The electronic device 4110 may be any type of mobile terminal, fixed terminal, or portable terminal, including a mobile handset, desktop computer, laptop computer, notebook computer, netbook computer, tablet computer, media computer, multimedia tablet, personal communication systems (PCS) device, personal navigation device, personal digital assistant (PDA), audio/video player, digital camera/camcorder, positioning device, television receiver, radio broadcast receiver, electronic book device, gaming device, or any combination of the foregoing, including accessories and peripherals of these devices, or any combination thereof. In some embodiments, the electronic device 4110 can also support any type of interface for a user (such as “wearable” circuitry, etc.).

It should be understood that the structure and function of the environment 4100 are described for exemplary purposes only and do not imply any limitation on the scope of the present disclosure.

As described above, document demonstration is spread throughout various aspects of people, such as life, work, and social networking, for example, conference reporting, enterprise promotion, product recommendation, and activity display. In a document demonstration scenario, it is sometimes not desirable to present the entire content of the document, but to present only part of the content in the document. For example, a brief speech for entire content may be performed at a beginning stage of the document demonstration, and specific content is reported in detail later. For example, a quick report, i.e., an introduction of content that needs to be focused on in a meeting may be performed at the beginning of the meeting. These important contents are usually only partial contents of the document. In other words, in many scenarios, a brief speech needs to be performed on some content of the document, and then a detailed speech is performed on all content of the document.

One conventional solution for document demonstration is pure reporting, such as via a demonstration deck (i.e., PPT). A demonstration deck usually contains only content that needs to be focused on, and does not have more detailed document content. This document demonstration solution using the demonstration deck is only suitable for introducing the focused content, and cannot provide a speech or presentation of the specific content.

Another conventional solution for document demonstration is document-based pure reading. The document-based pure reading is difficult to provide a guiding demonstration of content that needs to be focused on. In addition, the pure document demonstration usually cannot highlight the key content of the demonstration, and the demonstration is usually tedious and unsatisfactory.

In conclusion, the current document demonstration solution cannot meet the requirements of not only presenting the key content of the document, but also providing a detailed speech of the specific content of the document. Therefore, it is desirable to propose a document demonstration solution that can enable the brief introduction and full presentation of documents, thereby improving user experience.

According to the embodiments of the present disclosure, an improved document content display solution is provided. In this solution, a part of content in the document can be selected in the current view of the document. For example, a target content block of content blocks in the document can be selected. After detecting a content demonstration indication for the selected part of content, that is, the target content block, a target view including at least one content page is generated based on the target content block. Content of the target content block is displayed in the at least one content page.

This solution can support selection of partial content (namely, a target content block) of the document and support a demonstration interface for presenting the selected partial content. In this way, the document may be demonstrated either partially or fully. In addition, the partial content of the document can be presented without being created as a separate demonstration deck. In this way, the scenarios of the document demonstration can be greatly broadened, thereby providing more diverse and flexible document demonstration.

FIG. 4B illustrates a flowchart of a process 4200 for displaying document content according to some embodiments of the present disclosure. The process 4200 may be implemented at the electronic device 4110. For ease of discussion, the process 4200 will be described with reference to the environment 4100 of FIG. 4A.

At block 4210, the electronic device 4110 receives a selection operation on a target content block of content blocks within the document 4112 in a current view of the document 4112 to determine the target content block. For example, the user 4102 may select the target content block in the document 4112 by using a mouse, a pointing device, a stylus, a finger, or the like. The embodiments of the present disclosure are not limited in this regard. The electronic device 4110 may determine the selection of the user 4102 for the target content block. These selected target content block will be presented during subsequent document content display. In this way, users can select the partial content of the document that is desired to be presented, thereby enabling the demonstration of the partial content of the document. The detailed process of demonstrating the content of the document part will be described in detail below.

In some embodiments, the document 4112 may be a document such as based on the DocX architecture. The document 4112 may include a plurality of content blocks. In other words, one or more content items may be carried within the architecture of the document 4112. A content block may be an entity in a document. The content block may also be the smallest editing unit of the document 4112. For example, a content block may be a section of text, a picture, a table, a section of code, a link, or the like. Document 4112 may be viewed as a collection of a plurality of content blocks, or as a container that includes a plurality of content blocks. A “content block” may also be referred to herein as a “block,” “content item,” or “content region.” In such an embodiment, the target content block may be selected based on a selection of a content block in the document 4112. It should be understood that in some embodiments, the document 4112 may also be based on other existing or future document architectures that can support selection of portions of the document content. The embodiments of the present disclosure are not limited in this regard.

In some embodiments, the electronic device 4110 may detect a selection of a target area in the document 4112. The target content block may include a content block located within the target area. For example, in an edit interface or a view interface of the document 4112, the user 4102 may select a target area in the document 4112 by means of a box selection of mouse or a finger touch. The electronic device 4110 may determine the target content block by detecting the selection of the target area.

Additionally or alternatively, the target content block may also be selected in other manners. For example, in some embodiments, the current view of the document 4112 may be a first view, such as a document page view. Herein, a view where an operation such as editing may be performed on the document 4112 is referred to as a “first view”. In an example in which the current view of the document 4112 is the first view, the electronic device 4110 may obtain a movement path of the current focus, and determine a content block on the movement path as the selected target content block. Additionally or alternatively, the electronic device 4110 may determine a content block corresponding to the position of the current focus, and determine the content block as the target content block according to a shortcut selection indication.

Additionally or alternatively, in examples where the current view of document 4112 is the first view, electronic device 4110 may also receive an indication of content filtering. If the electronic device 4110 receives the indication of content filtering, the electronic device 4110 may determine all content blocks in the current view, and generate a predetermined mark at an associated position of each content block. The electronic device 4110 may further receive an editing operation on the predetermined mark. The electronic device 4110 may further determine the target content block based on an editing operation on the predetermined mark.

For example, in some embodiments, the predetermined mark may have an initial state of being unselected. For example, the predetermined mark may be a selection box having an initial state of being unselected. In this case, the electronic device 4110 may receive a confirmation selection of the predetermined mark. Alternatively, in some embodiments, the predetermined mark may have an initial state of being selected. For example, the predetermined mark may be a selection box that has been selected. In this case, the electronic device 4110 may receive a deselection of the predetermined mark. The electronic device 4110 may determine the content block corresponding to the selected predetermined mark after the marking operation as the target content block.

In some embodiments, the current view of the document 4112 may be a second view. The second view may be generated based on the first view. Herein, a view generated based on the first view is referred to as a “second view”. For example, the second view may be a demonstration page view generated based on the document page view. Similar to the example in the first view, in an example where the current view of the document 4112 is the second view, the electronic device 4110 may receive an indication of content filtering. If the electronic device 4110 receives an indication of content filtering, the electronic device 4110 may determine all content blocks in the second view, and generate a predetermined mark at an associated position of each content block. The electronic device 4110 may further receive an editing operation on the predetermined mark. The electronic device 4110 may further determine the target content block based on an editing operation on the predetermined mark.

For example, in some embodiments, the predetermined mark may have an initial state of being unselected. For example, the predetermined mark may be a selection box having an initial state of being unselected. In this case, the electronic device 4110 may receive a confirmation selection of the predetermined mark. Alternatively, in some embodiments, the predetermined mark may have an initial state of being selected. For example, the predetermined mark may be a selection box that has been selected. In this case, the electronic device 4110 may receive a deselection of the predetermined mark. The electronic device 4110 may determine the content block corresponding to the selected predetermined mark after the marking operation as the target content block.

Additionally or alternatively, similar to the example in the first view, in an example in which the current view is the second view, the electronic device 4110 may obtain a movement path of the current focus, and determine a content block on the movement path as the selected target content block. Additionally or alternatively, the electronic device 4110 may determine a content block corresponding to the position of the current focus, and determine the content block as the target content block according to a shortcut selection indication.

Although the above describes an example in which the current view is the first view or the second view, the electronic device 4110 may determine the target content block in different manners such as using a movement path or a position of the current focus as well as using a predetermined mark. However, in some embodiments, a manner of determining the target content block by using only the movement path or the position of the current focus may be used in the first view. In the second view, the target content block may be determined by only using the predetermined mark. The manners of determining the target content block in different views may be predetermined, or may be flexibly selected or changed. The embodiments of the present disclosure are not limited in this regard.

Several examples of determining the target content block are described above in conjunction with FIG. 4B. More examples for determining the target content block will be described next in conjunction with FIGS. 4CA to 4CF.

FIGS. 4CA to 4CC illustrate schematic diagrams of examples of selecting a target content block of the document 4112 according to some embodiments of the present disclosure. It should be understood that the pages shown in FIG. 4CA and the pages in other figures described below are merely examples, and various page designs may actually exist. Individual graphical elements in the page may have different arrangements and different visual representations, one or more of which may be omitted or replaced, and one or more other elements may also be present. The embodiments of the present disclosure are not limited in this regard.

In FIG. 4CA, a plurality of content blocks of the document 4112 are presented in a current view 4300, such as a content block 4310, a content block 4320, a content block 4330, and a content block 4340. In some embodiments, the view 4300 may include a first view or a document page view. The view 4300 may be a view provided by the electronic device 4110, such as a document edit view, a document viewing view, and so forth. For purposes of explanation, only four content blocks in the document 4112 are presented in the view 4300. It should be understood that there may be fewer or more content blocks in the document 4112. Although in the example of FIG. 4CA, the content blocks of the document 4112 are all text blocks, in other embodiments, the content blocks may also be other content blocks, such as picture blocks, table blocks, and the like. In addition, although specific text is presented in the drawings, such text does not constitute any limitation on the embodiments of the present disclosure.

In FIG. 4CB, a selection of a portion of content blocks in the view 4300 in FIG. 4CA is shown. As described above, the electronic device 4110 may obtain the movement path of the current focus, and determine the content block on the movement path as the selected target content block. For example, a movement path 4306 (also referred to as a trajectory) between arrow 4302 and arrow 4304 may be the movement path of the current focus, for example, selected by the user 4102 using a mouse, finger, or similar interactive tool. The electronic device 4110 may detect the movement path 4306, and determine the content block 4310 and the content block 4320 located on the movement path 4306 as selected target content blocks.

Additionally or alternatively, the electronic device 4110 may further determine an area of a predetermined shape (for example, a rectangle) covering the movement path 4306 as the detected target area. In this example, the content block 4310 and content block 4320 are located at least partially within the detected target area, while the content block 4330 and content block 4340 are not located within the target area. In this case, the electronic device 4110 determines the content block 4310 and the content block 4320 as target content blocks selected by the user.

As shown in FIG. 4CC, the target content block selected by the user in FIG. 4CB, i.e., content block 4310 and content block 4320, is shown in view 4300 as content blocks having a background color.

In some embodiments, a scrollbar control (not shown) or a page turning control (not shown) may also be arranged in the view 4300 for positioning the content of the document 4112 presented in the view 4300. Additionally or alternatively, a close control (not shown) may also be arranged in the view 4300. The electronic device 4110 may detect a trigger indication for the close control and close the view 4300.

FIGS. 4CD to 4CF illustrate schematic diagrams of another example of selecting content of the document 4112 according to some embodiments of the present disclosure. In the example of FIGS. 4CD to 4CF, several content blocks following content block 4310 through content block 4340 in document 4112 are presented in the view 4300, such as content block 4360 including a table name “Table 1”, content block 4370 including a table, and content block 4380 including a piece of text. The view 4300 may be caused to present the content in FIG. 4CD by a scrollbar control or a page turning control. It should be understood that although specific text and table are presented in the figures, such text and table do not constitute any limitation on the embodiments of the present disclosure.

In FIG. 4CE, a selection of a portion of content blocks in the view 4300 in FIG. 4CD is shown. As described above, in some embodiments, the electronic device 4110 may determine a content block corresponding to the position of the current focus, and determine the content block as the target content block according to a shortcut selection indication. For example, when the current focus is located at the position shown by the arrow 4362, the content block 4360 may be determined as the target content block through a shortcut selection indication such as a mouse click or double click, or a finger touch or press. Similarly, when the current focus is at the position shown by arrow 4364, the content block 4370 may be determined as the target content block by any suitable shortcut selection indication.

As shown in FIG. 4CF, the target content blocks selected by the user in FIG. 4CE, i.e., the content block 4360 and the content block 4370, are shown in the view 4300 with the background color of gray.

In some embodiments, the electronic device 4110 may add the content block 4310 and the content block 4320 as the target content blocks in the examples of FIGS. 4CB to 4CC, and add the content block 4360 and the content block 4370 as the target content blocks in the examples of FIGS. 4CE to 4CF. That is, the target content block may include content block 4310, content block 4320, content block 4360, and content block 4370.

Several processes for determining the target content block by using the movement path or position of the current focus in the example in which the current view is the first view are described above in conjunction with FIGS. 4CA to 4CF. It should be understood that the foregoing example process may also be applied to an example in which the current view is the second view. In addition, in some embodiments, in an example in which the current view is the first view or the second view, the content filtering mode may also be used to determine the target content block.

Next, a schematic diagram of an interaction example of determining a target content block by using a content filtering mode according to embodiments of the present disclosure will be described with reference to FIG. 4DA to FIG. 4DE. In examples where the current view 4400 of the document 4112 is the second view, the electronic device 4110 may receive a content filtering indication. In the example of FIG. 4DA, a content filtering control 4410 is provided in the view 4400. The user 4102 may trigger the content filtering indication by, for example, clicking or touching the content filtering control 4410.

Additionally or alternatively, a demonstration settings control 4420 is also provided in the view 4400. The user 4102 may modify the presentation of the target content block by triggering the demonstration settings control 4420, such as modifying the size, the background of the view, or the like. By detecting the trigger for the demonstration settings control 4420, the electronic device 4110 may change the presentation form of the target content block according to the requirements of the user 4102, for example, perform multi-view switching. Through the settings of the view, the display scenarios of the document 4112 can be greatly expanded.

In some embodiments, if the electronic device 4110 receives a content filtering indication, the electronic device 4110 may determine all content blocks in the second view, and generate a predetermined mark at an associated position of each of the content block. For example, the predetermined mark may include a selection box. Taking the predetermined mark being a selection box as an example, if the content filtering control 4410 is selected (shown as having a shaded box line), the electronic device 4110 may detect the content filtering indication. In this case, the electronic device 4110 may present a plurality of selection boxes associated with a plurality of content blocks of document 4112 in view 4400. For example, a selection box 4412 is associated with content block 4310, a selection box 4414 is associated with content block 4320, a selection box 4416 is associated with content block 4330, and a selection box 4418 is associated with content block 4340 (as shown in FIGS. 4DB to 4DE).

In some embodiments, the electronic device 4110 may further receive an editing operation on the predetermined mark. The electronic device 4110 may further determine the target content block based on an editing operation on the predetermined mark. Taking the predetermined mark being a selection box as an example, the electronic device 4110 may determine the selected target content block based on the selected at least one selection box.

In some embodiments, the predetermined mark may have an initial state being unselected. For example, the predetermined mark may be a selection box having an initial state of being unselected. In this case, the electronic device 4110 may receive a confirmation selection of the predetermined mark. The electronic device 4110 may determine the content block corresponding to the selected predetermined mark after the marking operation as the target content block. For example, the user may change state(s) of one or more selection boxes to be selected as needed. In this case, the selection indication for the selection box may be a confirmation selection indication for the selection box. In such an example, the electronic device 4110 may determine at least one content block associated with the at least one selection box where the confirmation selection indication is detected as the selected target content block.

For example, as shown in FIG. 4DB, the plurality of selection boxes 4412, 4414, 4416, and 4418 each have an unselected state by default. The user 4102 may confirm selection of the one or more selection boxes as needed, and change state(s) of the one or more selection boxes to be selected. An example of a confirmation selection indication of the user 4102 for a selection box is shown in a view 4400 of FIG. 4DC. The selection box 4412 and the selection box 4414 in which the check mark “✓” is presented are selection boxes selected by the user 4102, i.e., selection boxes for which a confirmation selection indication is detected by the electronic device 4110. The electronic device 4110 may confirm that the content block 4310 associated with the selection box 4412 and the content block 4320 associated with the selection box 4414 are the selected target content blocks. In the example of FIG. 4DC, the selected content block is presented as having a background color of gray to indicate that it is selected.

Alternatively, in some embodiments, the predetermined mark may have an initial state of being selected. For example, the predetermined mark may be a selection box that has been selected. In this case, the electronic device 4110 may receive a deselection of the predetermined mark. In this case, the user may confirm the deselection of the one or more selection boxes as needed, and change state(s) of the one or more selection boxes to be unselected. In this case, the selection indication for the selection box may be a deselection indication for the selection box. The electronic device 4110 may determine a content block associated with a selection box, other than the at least one selection box for which the deselection indication is detected, among the plurality of selection boxes as the selected target content block.

For example, in some embodiments, different from the embodiment in FIG. 4DB, the plurality of selection boxes 4412, 4414, 4416, and 4418 presented in view 4400 of FIG. 4DD have an unselected state by default, i.e., the selection boxes are presented with check marks “✓”. In this example, each content block selected by default is also shown as having selected content in a background color of gray. The user 4102 may confirm deselection of the one or more selection boxes as needed, and change state(s) of the one or more selection boxes to be unselected. In this case, when the user 4102 triggers a selection indication for a selection box, the user 4102 may trigger a deselection indication for the selection box. For example, user 4102 may trigger a deselection indication for the selection box 4416 and selection box 4418.

An example of a deselection indication of the user 4102 for a selection box is shown in the view 4400 of FIG. 4DE. Compared to the respective selection boxes in FIG. 4DD, it can be seen that the selection box 4416 and the selection box 4418 have changed from the selected state to the unselected state. After detecting the deselection indication of the user 4102, the electronic device 4110 may determine content blocks associated with the selection box 4412 and selection box 4414 that were not deselected as the target content blocks selected by the user 4102. In other words, the electronic device 4110 may confirm that the content block 4310 associated with the selection box 4412 and the content block 4320 associated with the selection box 4414 are the selected target content blocks. In the example of FIG. 4DE, the content block that was not deselected is presented as having a background color of gray to indicate that it belongs to the selected target content block.

Several examples of determining the target content block according to the editing operation of the user on the predetermined mark are described above by using examples in which the selection box is used as the predetermined mark as an example. It should be understood that although in the examples of FIGS. 4DA to 4DE, the view 4400 is the second view, the view 4400 may also include the first view. The embodiments of the present disclosure are not limited in this regard.

Various manners of determining the target content block based on the current focus or the predetermined mark are described above. In the foregoing various manners and other possible manners, the user 4102 may flexibly select, in the first view or the second view, a target content block by using a box selection of mouse, a mouse click, a touchscreen control, a selection box filtering, or the like. These flexible ways of determining the target content block further improve the user experience.

Continued reference is made to FIG. 4B. At block 4220, the electronic device 4110 receives a content demonstration indication for the target content block in response to the target content block being determined.

For example, in some embodiments, the current view is the first view, such as the view 4300. In this view, a first control may be displayed at an associated position of any of determined target content blocks. The electronic device 4110 may receive a content demonstration indication for the target content block based on the first control. The user 4102 may trigger the first control, for example, by using a mouse click or a finger touch. The form of the trigger indication employed herein is not limited in this regard. The electronic device 4110 may detect various content demonstration indications.

Additionally or alternatively, in some embodiments, the current view is the second view, such as the view 4400. A second control may be displayed at a predetermined position in the page of the second view. The electronic device 4110 may receive the content demonstration indication of the target content block based on the second control. The user 4102 may trigger the second control, for example, by using a mouse click or a finger touch. The form of the trigger indication employed herein is not limited in this regard. The electronic device 4110 may detect various content demonstration indications.

At block 4230, the electronic device 4110 determines whether a content demonstration indication is detected. If the electronic device 4110 detects the content demonstration indication at block 4230, the electronic device 4110 generates a target view including at least one content page based on the target content block at block 4240. Content of the target content block is displayed in the at least one content page. Conversely, if no content demonstration indication is detected at block 4230, the electronic device 4110 may return to block 4220 to continue receiving a content demonstration indication for the target content block in response to the target content block being determined. For example, the electronic device 4110 may detect the content demonstration indication continuously or at predetermined time intervals with the target content block being determined.

Additionally or alternatively, in some embodiments, if no content demonstration indication is detected at block 4230, the electronic device 4110 may also return to block 4210 (not shown) to continue receiving a selection operation for the target content block of the content blocks within the document. Further, in some embodiments, block 4210 and block 4220 may be performed in parallel. That is, while continuing to detect the selection of the target content block, the electronic device 4110 may detect the content demonstration indication while some existing content blocks are selected.

In some embodiments, the electronic device 4110 may determine the number of content pages included in the target view based on at least one of the type, the content amount, or the content correlation degree of the target content block. The electronic device 4110 may display the target content block in the corresponding content page(s).

For example, the electronic device 4110 may determine the number of content pages included in the target view according to the content amount of the target content block and the size of the content page. For another example, the electronic device 4110 may lay out the target content amount in the content page(s) according to the type or content correlation degree of the target content block(s), and lay out content blocks of the same type or content blocks with associated content in the target content block(s) in the same content page. The electronic device 4110 may determine the number of content pages included in the target view according to the layout of the target content block(s).

In addition, in some embodiments, the size occupied by the target content block in the content page may also be set according to the type of the target content block. For example, if the target content block is a picture, a larger area may be occupied in the content page. For another example, if the target content block is a phrase, a smaller area may be occupied in the content page. The number of content pages included in the target view is determined according to sizes occupied by different target content blocks in the content pages.

Only several examples of determining the number of content pages are listed above, and it should be understood that other suitable methods may be used to determine the number of content pages. The embodiments of the present disclosure are not limited in this regard.

In some embodiments, the target content block in the current view may include an interaction identifier. For example, the interaction identifier may be configured for adding or displaying a comment. For example, the user may comment on a content block in the document 4112, such as a paragraph, a phrase, or a word. After the user adds a comment to the content block, the interaction identifier may be displayed at a position of the content block or a position beside the content block.

Additionally or alternatively, the interaction identifier may be hidden in the generated target view of the target content block. By hiding the interaction identifier, the demonstration interface can be simpler, and interference can be removed. In some embodiments, the interaction identifier may also be displayed in the target view of the generated target content block. For example, the user may choose to hide or display the interaction identifier. In this way, the interaction identifier may be displayed when the user performs the interaction operation accordingly, to enable the performance of the interaction operation.

In some embodiments, the electronic device 4110 may display interaction content in the corresponding content page of the target view in response to a trigger operation on the interaction identifier. For example, the electronic device 4110 may receive a trigger on the interaction identifier in the second view, and display comment content corresponding to the interaction identifier. In this way, the interaction identifier may still be displayed in the demonstration state of the document 4112, thereby providing an interaction operation.

Additionally or alternatively, the electronic device 4110 may further receive a content export indication for the target content block in response to the target content block being determined. For example, the content export indication may be received through a content export control. The content export control may be located anywhere in the first view or the second view. The user may trigger the content export control in any suitable manner. The scope of the present disclosure is not limited in this regard.

FIG. 4E illustrates a schematic diagram of an example of interacting with a selected target content block of the document 4112 according to embodiments of the present disclosure. In the example of FIG. 4E, in a view 4500, when a selection of a position indicated by arrow 4364 is detected, i.e., content block 4360 is selected (illustrated as a shaded box), the electronic device 4110 may detect further interaction with the selected target content block. The view 4500 may be the first view, or alternatively may be the second view. For example, the user 4102 may trigger presentation of a toolbar 4510 based on a mouse double click, mouse right click, finger press or the like at the position of arrow 4364. If the trigger is detected, the electronic device 4110 may present the toolbar 4510 in the view 4500. In some examples, the toolbar 4510 may be presented in the view 4500 by default or according to a configuration without user triggering.

In some embodiments, various interaction functions may be included in the toolbar 4510. For example, icon 4512 represents copying, i.e., copying the selected target content block or the currently selected content block 4360. As another example, icon 4514 represents cutting, which may be configured to cut the selected target content block or the currently selected content block 4360. As another example, icon 4516 represents deletion, which may be configured to delete the selected target content block or the currently selected content block 4360.

In some embodiments, a demonstration icon 4518 is included in the toolbar 4510. The user 4102 may indicate content demonstration by triggering the demonstration icon 4518. That is, if electronic device 4110 detects a trigger on demonstration icon 4518, an indication of content demonstration is detected. When an indication of the content demonstration is detected, the electronic device 4110 may present a demonstration page view for displaying the target content block. Examples of the demonstration page view will be described below in conjunction with FIGS. 4FA and 4FB.

Additionally or alternatively, a comment icon 4518 may be included in the toolbar 4510. Herein, the comment icon 4518 is also referred to as an interaction identifier. The user 4102 may add a comment to the selected target content block or the currently selected content block 4360 by triggering the comment icon 4518. Additionally, the user 4102 may view the comment previously added to the selected target content block or the currently selected content block 4360 by triggering the comment icon 4518.

Additionally or alternatively, an export icon 4524 may be included in the toolbar 4510. The user 4102 may trigger the export icon 4524 to indicate export of the target content block. If the electronic device 4110 detects a trigger on the export icon 4524, that is, detects an indication of content export, the electronic device 4110 may save the selected target content block in the document 4112 as a further document. In some embodiments, the export icon 4524 may not be included in the toolbar 4510. Upon detecting the indication of the content demonstration, the electronic device 4110 may automatically export the target content block as a further document. The further document may be stored in storage of the electronic device 4110 or in cloud storage in communication with the electronic device 4110.

By saving the selected target content block as the further document, the further document may be directly opened during subsequent demonstration of the document 4112 without being re-selected from the contents in the document 4112. In addition, the selected target content block is usually the key content in the document 4112, and the saved further document may be printed for viewing of the key content in the document 4112.

It should be understood that the size, shape, and position of the toolbar 4510 shown in FIG. 4E are merely exemplary and not limiting. The toolbar 4510 may include the same or different, more or fewer functionality controls as shown in FIG. 4E. Although in the example of FIG. 4E, the toolbar 4510 is displayed in response to detecting an interaction trigger on a certain content block, in other embodiments, the toolbar 4510 may be hidden, and the toolbar 4510 may change from a hidden state to a visible state when the user 4102 moves, for example, a mouse or a finger, to a predetermined position (for example, an upper left corner of the view 4500 or another suitable position) of the toolbar 4510. Further, when the toolbar 4510 is presented, it may be separate from individual content blocks, or at least partially overlaid over one or more content blocks. The embodiments of the present disclosure are not limited in this regard.

Examples of various interactions with the selected document content are described above in conjunction with FIG. 4E. Next, an example of a view 4600 for displaying document content according to some embodiments of the present disclosure will be described in conjunction with FIGS. 4FA and 4FB. The view 4600 in FIGS. 4FA and 4FB will be described in conjunction with the examples of FIGS. 4CA to 4CD.

As previously described, in the examples of FIGS. 4CB and 4CD, content block 4310, content block 4320, content block 4360, and content block 4370 are selected, respectively. If an indication of content demonstration is detected while the content blocks are selected, the electronic device 4110 will present the view 4600. The selected content block 4310, content block 4320, content block 4360, and content block 4370 are presented in the view 4600.

In some embodiments, the view 4600 may include a close control 4612. When the user 4102 triggers the close control 4612, for example, by using the mouse to click the close control 4612 or using the finger to press the close control, the electronic device 4110 may detect the trigger. In this case, the electronic device 4110 may close the view 4600 in response to the trigger for the close control 4612.

It should be understood that the size, shape, and position of the close control 4612 shown in FIGS. 4FA and 4FB are merely exemplary and not limiting. The close control 4612 may have other shapes, sizes, any other suitable positions in the view 4600. Additionally or alternatively, the close control 4612 may be concealable. The close control 4612 may change from a hidden state to a visible state when the user 4102, for example, moves a mouse to a position of the close control 4612.

Additionally or alternatively, in some embodiments, although not shown, a control such as a scrollbar control and/or a page turning control may also be provided in the view 4600 for navigating and positioning the presented target content block. For example, the target content block may be presented in a plurality of content pages. If the electronic device 4110 detects a trigger on the page turning control, the view 4600 may be switched from the currently presented content page to a further content page, for example, a next page or a previous page. For another example, if the electronic device 4110 detects a trigger on the scrollbar control, the content page presented by the view 4600 may be scrolled and presented.

In some embodiments, an interaction identifier 4620 may be presented in the view 4600. The interaction identifier 4620 may be configured to indicate that the user 4102 has added interaction content, such as a comment, to a content block 4370 next to it. The user 4102 may trigger the interaction identifier. The electronic device 4110 may display interaction content, such as the comment added by the user 4102, in a corresponding content page of the view 4600 in response to a trigger operation for the interaction identifier 4620.

For example, interaction content 4630 is shown in the view 4600 of FIG. 4FB. The interaction content 4630 is presented in response to the trigger for the interaction identifier 4620. It should be understood that the content of the illustrated interaction content 4630 is merely exemplary and not limiting. The interaction content 4630 may include any suitable text, expression, symbol, or the like.

Additionally or alternatively, the user 4102 may modify the previous interaction content and so on by triggering the interaction identifier 4620. For example, the user 4102 may reply to the interaction content. In this way, interaction such as interaction functions can be provided to the user even in the view in the demonstration state, thereby improving the user experience.

It should be understood that although only one content page is shown in the view 4600, in some embodiments, multiple content pages may be included in the view 4600. The number of content pages may be determined according to the target content block. The embodiments of the present disclosure are not limited in this regard.

It should be understood that the views or pages shown in FIGS. 4FA and 4FB, as well as the views or pages in other figures described herein, are merely examples, and that various interface designs may actually exist. Individual graphical elements in the view may have different arrangements and different visual representations, one or more of which may be omitted or replaced, and one or more other elements may also be present. The embodiments of the present disclosure are not limited in this regard.

According to the solution, the partial content of the document can be selected, and the demonstration page view for presenting the selected partial content is supported. In this way, the document may be demonstrated either partially or fully. In other words, documents may be used for both reporting and reading. In addition, interaction such as copying, saving, and adding comments may also be performed on the selected part of content. In this way, the scenarios of the document demonstration can be greatly broadened, thereby providing more diverse and flexible document demonstration.

FIG. 4G shows a schematic structural block diagram of an apparatus 4700 for document content displaying according to some embodiments of the present disclosure. The apparatus 4700 may be implemented as or included in the electronic device 4110. The various modules/components in the apparatus 4700 may be implemented by hardware, software, firmware, or any combination thereof.

As shown in the figure, the apparatus 4700 includes a target content block determining module 4710 configured to receive a selection operation on a target content block of content blocks in the document 4112 in a current view of the document 4112, to determine the target content block.

The apparatus 4700 further includes a content demonstration indication receiving module 4720 configured to receive a content demonstration indication for the target content block in response to the target content block being determined.

The apparatus 4700 further includes a target view generating module 4730 configured to generate a target view including at least one content page based on the target content block. Content of the target content block is displayed in the at least one content page.

In some embodiments, the current view of the document 4112 is a first view. In this case, the target content block determining module 4710 may include: a movement path obtaining module, configured to obtain a movement path of a current focus, and determine a content block on the movement path as the selected target content block; and/or a focus position determining module, configured to determine a content block corresponding to a position where the current focus is located, and determine the content block as the target content block according to a shortcut selection indication.

Additionally or alternatively, in some embodiments, the current view of the document 4112 is a second view. The second view is generated based on the first view. In this case, the target content block determining module 4710 may include: a content filtering module configured to determine all content blocks in the second view in response to receiving a content filtering indication, and generate a predetermined mark at an associated position of each of the content blocks; an editing operation receiving module configured to receive an editing operation on the predetermined mark; and a second target content block determining module configured to determine the target content block based on the editing operation on the predetermined mark.

In some embodiments, the predetermined mark may have an initial state of being unselected. The editing operation receiving module may be configured to receive a confirmation selection of the predetermined mark. Additionally or alternatively, the predetermined mark may have an initial state of being selected. The editing operation receiving module may be configured to receive a deselection of the predetermined mark. In some embodiments, the second target content block determining module is configured to determine a content block corresponding to the predetermined mark that is selected after the editing operation as the target content block.

In some embodiments, the current view of the document 4112 is the first view. In this case, the content demonstration indication receiving module 4720 includes a first control module configured to display a first control at an associated position of any of determined target contents block, and receive the content demonstration indication for the target content block based on the first control.

In some embodiments, the current view of the document 4112 is the second view generated based on the first view. In this case, the content demonstration indication receiving module 4720 includes a second control module configured to display a second control at a predetermined position in the page of the second view, and receive the content demonstration indication for the target content block based on the second control.

In some embodiments, the target view generating module 4730 includes: a content page number determining module configured to determine a number of content pages included in the target view according to at least one of a type, a content amount, and a content correlation degree of the target content block; and a content block display module configured to display the target content block in a corresponding content page.

In some embodiments, the content page number determining module is configured to determine the number of content pages included in the target view according to the content amount of the target content block and the size of the content page.

Additionally or alternatively, in some embodiments, the content page number determining module is configured to lay out target content blocks in content pages according to the type or the content correlation degree of the target content blocks, content blocks of the same type or content blocks having associated content in the target content blocks being laid out in a same one of the content pages; and determining the number of content pages comprised in the target view according to the laying out of the target content blocks.

In some embodiments, the apparatus 4700 further includes a content export indication receiving module configured to receive a content export indication for the target content block in response to the target content block being determined; and a saving module configured to save the target content block as a further document in response to detecting the content export indication.

In some embodiments, the target content block in the current view includes an interaction identifier. The target view generating module 4730 may be configured to hide the interaction identifier in the content corresponding to the target content block in the target view. Additionally or alternatively, in some embodiments, the target view generating module 4730 may be configured to display the interaction identifier in the content corresponding to the target content block in the target view. In some embodiments, the apparatus 4700 further includes an interaction content display module configured to display interaction content in a corresponding content page of the target view in response to a trigger operation on the interaction identifier.

In some embodiments, one or more content blocks may be carried within the framework of the document 4112, and the content block is a minimum editing unit of the document 4112.

FIG. 4H illustrates a block diagram illustrating an electronic device 4800 in which one or more embodiments of the present disclosure may be implemented. It should be understood that the electronic device 4800 shown in FIG. 4H is merely exemplary and should not constitute any limitation on the function and scope of the embodiments described herein. The electronic device 4800 shown in FIG. 4H may be used to implement the electronic device 1110 of FIG. 1A, the electronic device 2110 of FIG. 2A, the electronic device 3110 of FIG. 3A, and the electronic device 4110 of FIG. 4A.

As shown in FIG. 4H, the electronic device 4800 is in the form of a general-purpose electronic device. Components of the electronic device 4800 may include, but are not limited to, one or more processors or processing units 4810, a memory 4820, a storage device 4830, one or more communication units 4840, one or more input devices 4850, and one or more output devices 4860. The processing unit 4810 may be an actual or virtual processor capable of performing various processes according to a program stored in the memory 4820. In a multiprocessor system, a plurality of processing units execute computer-executable instructions in parallel to improve the parallel processing capability of the electronic device 4800.

The electronic device 4800 typically includes a variety of computer storage media. The media may be any available media that is accessible to electronic device 4800, including, but not limited to, volatile and non-volatile media, removable and non-removable media. The memory 4820 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 4830 may be a removable or non-removable medium, and may include a machine-readable medium, such as a flash drive, a magnetic disk, or any other medium, which may be capable of storing information and/or data (e.g., training data for training) and may be accessed within the electronic device 4800.

The electronic device 4800 may further include an additional removable/non-removable, volatile/non-volatile storage medium. Although not shown in FIG. 4H, a magnetic disk drive for reading from or writing to a removable, non-volatile magnetic disk (e.g., a “floppy disk”) and an optical disk drive for reading from or writing to a removable, non-volatile optical disk may be provided. In these cases, each drive may be connected to a bus (not shown) by one or more data media interfaces. The memory 4820 may include a computer program product 4825 having one or more program modules configured to perform various methods or acts of various embodiments of the present disclosure.

The communication unit 4840 communicates with other electronic devices through a communication medium. Additionally, the functionality of the components of the electronic device 4800 may be implemented in a single computing cluster or multiple computing machines capable of communicating over a communication connection. Thus, electronic device 4800 may operate in a networked environment using logical connections to one or more other servers, network personal computers (PCs), or another network node.

The input device 4850 may be one or more input devices, such as a mouse, keyboard, trackball, or the like. The output device 4860 may be one or more output devices, such as s display, speaker, printer, or the like. The electronic device 4800 may also communicate with one or more external devices (not shown) through the communication unit 4840 as needed. The external device such as a storage device, a display device, etc., communicates with one or more devices that enable a user to interact with the electronic device 4800, or with any device (e.g., a network card, a modem, etc.) that enables the electronic device 4800 to communicate with one or more other computing devices. The communication may be performed via an input/output (I/O) interface (not shown).

According to example implementations of the present disclosure, a computer-readable storage medium having computer-executable instructions stored thereon is provided. The computer-executable instructions are executed by a processor to implement the method described above. According to example implementations of the present disclosure, a computer program product tangibly stored on a non-transitory computer readable medium is further provided. The computer program product comprises computer executable instructions which are executed by a processor to implement the method described above.

Various aspects of the disclosure are described herein with reference to the flowchart and/or block diagrams of methods, apparatuses, devices, and computer program products implemented according to the disclosure. It should be understood that each block of the flowcharts and/or block diagrams and combinations of blocks in the flowcharts and/or block diagrams may be implemented by computer-readable program instructions.

These computer-readable program instructions may be provided to a processing unit of a general-purpose computer, special computer, or any other programmable data processing apparatus to produce a machine that generates an apparatus to implement the functions/acts specified in the one or more blocks in the flowchart and/or block diagrams when the instructions are executed by the processing unit of the computer or the other programmable data processing apparatus. These computer-readable program instructions may also be stored in a computer-readable storage medium that causes a computer, programmable data processing apparatus, and/or any other device to function in a particular manner, such that the computer-readable medium having instructions stored thereon includes an article of manufacture including instructions that implement various aspects of the functions/acts specified in the one or more blocks in the flowchart and/or block diagrams.

The computer-readable program instructions may be loaded onto a computer, any other programmable data processing apparatus, or any other device such that a series of operational steps are performed on the computer, other programmable data processing apparatus, or other device to produce a computer-implemented process. As such, the instructions that execute on the computer, other programmable data processing apparatus, or other device implement the functions/acts specified in the one or more blocks in the flowchart and/or block diagrams.

The flowchart and block diagrams in the drawings illustrate the architecture, functionality, and operations of possible implementations of systems, methods, and computer program products according to various implementations of the present disclosure. In this regard, each block in the flowchart or block diagram may represent a part of a module, a program segment or instructions, which contains one or more executable instructions for implementing the specified logic function(s). In some alternative implementations, the functions marked in the blocks may also occur in a different order from those marked in the drawings. For example, two consecutive blocks may be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by a combination of a dedicated hardware and computer instructions.

Various implementations of the present disclosure have been described above, and the above description is exemplary, not exhaustive, and is not limited to the disclosed implementations. Many modifications and alterations will be apparent to those of ordinary skill in the art without departing from the scope and spirit of the illustrated implementations. The selection of terms as used herein is intended to best explain the principles of various implementations, practical applications or improvements to technology in the market, or to enable those of ordinary skill in the art to understand various implementations disclosed herein.

1. A method for document presentation, comprising:
presenting a first view of a document, the document comprising at least one content block, the at least one content block having a presentation attribute;
in response to receiving an indication for presenting a second view of the document, adjusting the presentation attribute of the at least one content block; and
presenting the at least one content block in the second view based on the adjusted presentation attribute.

2. The method of claim 1, wherein adjusting the presentation attribute comprises:
determining a type of the second view based on the indication; and
adjusting the presentation attribute based on the type of the second view.

3. The method of claim 2, wherein adjusting the presentation attribute based on the type of the second view comprises: in response to determining that the type of the second view comprises a demonstration type, adjusting at least one of:
a position of the at least one content block in the second view,
a size of the at least one content block in the second view,
displayed content of the at least one content block in the second view, or
a combined layout pattern of the at least one content block.

4. The method of claim 3, further comprising:
assigning an icon to the at least one content block based on text content of the at least one content block; and
presenting the icon at a position associated with the at least one content block.

5. The method of claim 3, wherein adjusting the combined layout pattern of the at least one content block comprises:
in response to determining that the at least one content block comprises a content block of a first type and a content block of a second type, laying out the content block of the first type and the content block of the second type in combination, or
in response to determining that the at least one content block comprises a plurality of content blocks, laying out the plurality of content blocks in combination, the plurality of content blocks belonging to a same parent content block, or
in response to determining that the at least one content block comprises a plurality of content blocks of a same type, laying out the plurality of content blocks of the same type in combination, or
in response to determining that the at least one content block comprises a plurality of content blocks of a same type and content of the plurality of content blocks of the same type satisfies a predetermined condition, laying out the plurality of content blocks of the same type in combination.

6. The method of claim 1, further comprising at least one of:
in response to receiving an adjustment to a paging control element presented in the second view, adjusting paging of the second view;
in response to receiving an adjustment to a visibility control element presented in the second view, adjusting visibility of the at least one content block;
in response to receiving an adjustment to a comment control element presented in the second view, adjusting a comment for the at least one content block; or
in response to receiving an adjustment to a color control element presented in the second view, adjusting a color for the at least one content block.

7. The method of claim 2, wherein adjusting the presentation attribute based on the type of the second view comprises: in response to determining that the type of the second view comprises a mindmap type,
determining a heading level of the at least one content block in the first view; and
adjusting the presentation attribute of the at least one content block based on the heading level, to display the at least one content block with the presentation attribute in a mindmap view.

8. The method of claim 7, wherein displaying the at least one content block with the presentation attribute in the mindmap view comprises:
generating a node corresponding to the at least one content block in the mindmap view;
determining a hierarchy of the node in the mindmap view based on the heading level of the at least one content block; and
presenting the node in the mindmap view based on the hierarchy.

9. The method of claim 7, wherein the at least one content block comprises a first content block and a second content block, the mindmap view comprises a first node corresponding to the first content block and a second node corresponding to the second content block, the first content block is a first heading in the first view, and the second content block is a second heading in the first view; and
wherein a first level is a heading level of the first heading in the first view, and a second level is a heading level of the second heading in the first view.

10. The method of claim 9, further comprising:
in response to determining that the second content block is located after the first content block in the first view, comparing the second level with the first level;
in response to determining that the second level is lower than the first level, setting the second node as a child node of the first node;
in response to determining that the second level is equal to the first level, setting the second node as a sibling node of the first node; or
in response to determining that the second level is higher than the first level, setting a hierarchy of the second node based on a comparison between a parent node of the first node and the second node.

11. The method of claim 10, further comprising: in response to editing for a node in the mindmap view being detected, updating a content block corresponding to the node in the mindmap view accordingly.

12. The method of claim 11, wherein updating the content block corresponding to the node in the mindmap view accordingly comprises at least one of:
in response to determining that the editing adjusts a level of the first node in the mindmap view, adjusting the first level of the first content block in the mindmap view;
in response to determining that the editing adjusts content of the first node, adjusting content of the first content block;
in response to determining that the editing operation adjusts an order of the first node and the second node in the mindmap, adjusting an order of the first content block and the second content block in the mindmap view;
in response to determining that the editing inserts a third node into the mindmap view, inserting a third content block corresponding to the third node into the mindmap view; or
in response to determining that the editing deletes the first node from the mindmap view, deleting the first content block from the mindmap view.

13. The method of claim 1, wherein the first view is any one of a document view, a demonstration view, or a mindmap view, and the second view is another item different from the first view in the document view, the demonstration view, or the mindmap view.

14. (canceled)

15. An electronic device comprising:
at least one processing unit; and
at least one memory coupled to the at least one processing unit and storing instructions for execution by the at least one processing unit, the instructions, when executed by the at least one processing unit, causing the device to perform operations comprising:
presenting a first view of a document, the document comprising at least one content block, the at least one content block having a presentation attribute;
in response to receiving an indication for presenting a second view of the document, adjusting the presentation attribute of the at least one content block; and
presenting the at least one content block in the second view based on the adjusted presentation attribute.

16. A non-transitory computer-readable storage medium having a computer program stored thereon, the computer program being executable by a processor to implement a method comprising:
presenting a first view of a document, the document comprising at least one content block, the at least one content block having a presentation attribute;
in response to receiving an indication for presenting a second view of the document, adjusting the presentation attribute of the at least one content block; and
presenting the at least one content block in the second view based on the adjusted presentation attribute.

17-77. (Canceled)

78. The device of claim 15, wherein adjusting the presentation attribute comprises:
determining a type of the second view based on the indication; and
adjusting the presentation attribute based on the type of the second view.

79. The device of claim 78, wherein adjusting the presentation attribute based on the type of the second view comprises: in response to determining that the type of the second view comprises a demonstration type, adjusting at least one of:
a position of the at least one content block in the second view,
a size of the at least one content block in the second view,
displayed content of the at least one content block in the second view, or
a combined layout pattern of the at least one content block.

80. The device of claim 79, wherein the operations further comprise:
assigning an icon to the at least one content block based on text content of the at least one content block; and
presenting the icon at a position associated with the at least one content block.

81. The device of claim 79, wherein adjusting the combined layout pattern of the at least one content block comprises:
in response to determining that the at least one content block comprises a content block of a first type and a content block of a second type, laying out the content block of the first type and the content block of the second type in combination, or
in response to determining that the at least one content block comprises a plurality of content blocks, laying out the plurality of content blocks in combination, the plurality of content blocks belonging to a same parent content block, or
in response to determining that the at least one content block comprises a plurality of content blocks of a same type, laying out the plurality of content blocks of the same type in combination, or
in response to determining that the at least one content block comprises a plurality of content blocks of a same type and content of the plurality of content blocks of the same type satisfies a predetermined condition, laying out the plurality of content blocks of the same type in combination.

82. The device of claim 15, wherein the operations further comprise at least one of:
in response to receiving an adjustment to a paging control element presented in the second view, adjusting paging of the second view;
in response to receiving an adjustment to a visibility control element presented in the second view, adjusting visibility of the at least one content block;
in response to receiving an adjustment to a comment control element presented in the second view, adjusting a comment for the at least one content block; or
in response to receiving an adjustment to a color control element presented in the second view, adjusting a color for the at least one content block.
